SEQUENCE LISTING (71 sequences)

SEQ ID NO: 1 - protein, 5 aa, Escherichia coli
RVSGY

SEQ ID NO: 2 - protein, 5 aa, Escherichia coli
RVAGY

SEQ ID NO: 3 - protein, 8 aa, Escherichia coli
VRVSGYSA

SEQ ID NO: 4 - protein, 5 aa, Escherichia coli
TPDGR

SEQ ID NO: 5 - protein, 6 aa, Escherichia coli
TPDGRF

SEQ ID NO: 6 - protein, 6 aa, Escherichia coli
GPTAVL

SEQ ID NO: 7 - protein, 5 aa, Escherichia coli
GNDDD

SEQ ID NO: 8 - DNA, 6393 bp, Thauera aromatica
ccgcggctcagctaaaatatgcaaataaatatgctgcaacaggtcgctctgggcttgccagtcgtgcgtgttggtgcatgatgagtccttgccttgtcgaaggctattagactttggtttagctgcagcgcagcaaaaatagcgtagcgagaaaattcgatgcgatacctgtctttgcatccacctgaattcgtgctctctccagcacgttttctcatctgctacctcgagcgcatgattcttcagacctttgacggcatcttgcgctgtcccgcccgcttgcctgctcgcagctccaggtcgaggatccagctctccttgtacagcgcgggtgcggcttgctcgcctgaaagttgttcatccgcaggcgagtgcagttcgagtatcgacttgatcacgtttggtgtcttcaacccttgcgacactggcagtgccctccggatctatcaccgccttcacatgcaccggctcgcagggtcagcgctgccgcagctacgtacataacatgctcaactggtcagttgcattccatgggaatagcggcttgcacaaattatgagcagcctgcggcttctttcgacggggatacggcttccgcgacatgcatcactggcaatcggagaatgcgggatgggtaggcgtggcagccccgctcgcagggtcgtgcaaatgagcgccagaccggtgtatgtagtcaggtcaagccttgagggctgcttgacttcgaagcgctatgtttgattgggccaaggcaggagaggggcgattgtacaatttcgtcaacgtattacgaggttttctgcgcggcgctagcgcaagctcagggctaatatcaatgatggcaaaatcatgacatcgaacaacagttcagtatccgatatttctgcagtgctgcgggttcgcgatgtgactttgcgcgctgtggatgatcttcagacctatcgggaaaaattagcccgtgttgtgcttgatgggctttatgaatttgtagggcttctcgatgcaaaaggtaatactcttgaaataaatcaagctgcgctggatggcgcgggaacccgacttgaagacatccgcgacaagccgttctgggaggccaggtggtggcaggtttccagggaaacccaagaagagcagcgcaaacttatcgctcgcgcgagtgctggcgagtttgttcgatgcgatgttgaaatatatggtcgagcttccggagaagagacgattgttgttgattactcaattcttccgattcgagattgcaatggaaaagtggtgttcttgcttcctgaaggccggaatatcaccgataagaagctggcggaagcagagcttgcgcgaaagaatgaagagctgcagcatcttcttgagaagattcgtcagctggatgaggccaagaatgagttcttcgccaatctcagtcatgaattgcgtacgcctctttctctgattcttgggtccgtagaatcgctacttgccgattctggagactattctggagtgcaacgagtcgatctggatgtcatccagagaaatgccataaccttgctcaagtatgtgaacgaccttcttgatctagcaaaactgcaggcggagaagttgcagcttcactattcgcgtgtcgaccttgcagcggtgacacgaatgatttgcgcgcattttgaggctctggcagagtataaatgtctttcatatgtcattgacgctcctgcctttatggaggctgaagtcgatgtcgagaagtatgagcggatcgttctgaatctcttatccaatgcctttaagttctcgccggacggcgggcgcattcgctgttcgttgagtgcgactggtaccggaagaatcttgctcagtattcaggacagtggtcctggaattccagctgatcaacagagtgaaattttcggccggtttcggcaaggtggggatatcaagtcccggcagtttggcggtacgggcttgggtttgactattgtgaaggattttgtctgcctgcatgggggggttgtggtcgtttcagacgctccgggaggcggggctttatttcagatcgaattgcccaggaatgcgccttctggggtgtatgtaaatgcggttgcaaaggctggtgaattaagccctacatcttttgatatcagcgcatggggcctggaggggcggagtgaatggacaagcgccgagggagccagtgatcgtcctcggatcctgattgtcgaagataacgtcgatatgcgctgttttatagggagggtgctcattgacgagtatcagatcagtgttgccgctgatggtgagcaggcactggagcttattacctcatcccctccggatctggtcattacggatctgatgatgcccaaggtcagcggtcagcttctggtcaaagagatgcgctcgagaggggacctagccaatgttcctatactcgtgctttcggccaaggcggatgatgggttgagaataaaattgctggccgagtcggttcaagattatgttgtcaagccattctcggctacggagttgcgagcgcgagttcgaaatcttgttaccatgaagcgggcccgtgatgctttgcagagagcgctcgacagtcagagtgacgatttatcgcaattgactcggcagatcatcgacaatcgccaggagttgcagcgaagccatgatgctttgcaggaatctgagtcccgctggcgcgcagtctatgagaattctgctgcaggtattgtgttgacaaatttggacggcttgattttgtctgcgaatcaagcatttcaaaaaatggttggctatgccgaggatgagttgcgggtgattgaaatatcggatctcgtccccgaacatgatcgcgaaaaaatccggtcgcgcgtttcaaatctgatcagtggccgcgtcgacgactatcaagtgcaaaggcaatgccgacgaaaggacggccgaatgatgtgggcaaatgtgcgagcatcgctcatacctgggctggccaatcagtctccgatggttgtgagaatttttgatgacattaccgaaaagattcagactgaagctgaactggcaagagcaagggaaaagttgaccagagtcatgcgtgttaccgcaatgggagaattggcggcatcgattgctcatgagttgaatcaaccgcttgccgccattgttaccaatggtcatgcatcattacgctggcttggctccgagccttgtaatctattggaagccgtcgaagcagtgcgaagaatcatccatgatgctaatcgcgcgagtgaaataatcaaacggatccgtggctttcttcagcggggggaggggaggcgctcggcagtggatatttttcaggttgttgcggatgtggctgcgattgtcagcgatatggcgcgcagtcattgcattgatatgcgttatcaagcagtcggtcaattgtcgctagtgattgcggataaggtccagttgcaacaggttattctgaatttgtgcatcaatggcatagaatccattgttggcggaaactccgaacgaggcgaactttcaattaccgttacccagtccgataaaagattcttgaccgtcagcgtacatgattccggcccgggccttgcacctggcgaggcggaaaacgtgtttgatgcgttctatacgagcaaggtggaggggcttggcatggggctcgccatcagtcgctctatcattgaggcgcatggtgggcgccttgatgttctgtccccttccacggaggggggatgcacgttctgtttcacgttgcctacggaggagatggctagcccatgtgccccacaatagatgcatcgactgtttatctggtggacgacgatcgctccatgcgtgacgcaatttccagcttggttcgatcggtcggcctcaatgtggagacatttgcgtctgcaagtgagttcttggagcacgctcgttcggaagcatgtgcctgcttggttcttgatgttcggatgccacgcatgagcggttttgatcttcagcatgcgttaagcaaaaatggtgtcgatattccaatcatctttattaccggccatggtgatatccccatggcggttcgcgccatcaagtcgggtgccctagaatttcttccaaagccttttcgtgctgaagaactgctcgaagcaatcaacagggctctgaatatcgatcaggaggctcgggagtacaaggcggagctggataagatattgaagaaatatgaggggcttacagatcgagaaaaggaggtatttccccttattgcccagggcttgttgaacaagcagattgccggatatctcggaattactgaggtcaccataaaggttcatcgtcataatattacgagaaaaatgggggtccggacactggctaatctggtgcgactttacgagaagttaaagaatgctgggctgatcgaaaaaaagaacggaaatctatcgggatgaagagccgcgactggaacccttcaggctcttggcggccacgctgtaggaacgctatcgcctacctgcgaatgtctaaactcactgaaacggcatagagttcaaagcaagaacttagcaaaatggatttgcctaacagttgattgtagaaataattttttattgattaatgatcggttgattgttgctgcagtcctgggagggaaagccattcacaagcactacaatgactgctgctgcgcatcgcaaaatgtatcaagtcgccggtggacctcagtccaagcttgctcatgatgcgcccgcggtgagcttccacagtcttatggctgatgcccagcagcttggcgatttccttgctgctgttgccgcaaaccaccttgtcgagaatctccatttcgcgctgtgacagggcggcaagaagatcggcacgctcctgcttttcgcgctgcttattcgtcatctccttgctgaaggcaagggcggcgtttacagcatcaagcagatcctggttgcgatagggtttttggagaaagtcgaacgcgcctttctttaccgcttgagctcccatctgggcatcgccgtaggcggagagaaagatgatcggcagcttgaagcctctgtcacacagcgcttgttgcaactgtaggccgctgacattttgcattcgaacatccagaatcacacagccgtaggtgcatgaaatatcggcatcaagaaaatgctttgcggattcgtatgccttgacgtttagtgaaatcgagttgaggagccacgtcagtgagtccctgaccgacgcttcgtcgtcgacgacgaatacagttggggcgtttccagatttttcgatttgcatgaggtgctcctttgtgcggtgctatgacaaacgtacggtctatatggcatcgctaatctgaatatctcttacattggcaaggtaaactgaaacctcgatccgcatccttcggtcttcgaaaatgaaagttcgcccccatgtgattcgatgatcgagcggcagatcgtcaatcctattccaagtccgtctggcttggttgtgaaatagggtttaaagacgcgttttgctgttcggctttcgacgccggtcccatagtcttgtacaaacaccttcattgaccttccctctgcaatgatttcgctaccgatcagcagcacgcgagagtccggttccatttctgacatggcctcaatgccattcttgattagattgaataagacctgctggatctcgattttgcagagagggatgagtggagggtcgggcattaactgcagattcaccgtagcgttatgtcgatggatctcgaaacttagaaatgaaagagcgtcctggatgacgtcgttgatgttttccaatagcctttctggcttgtgtttgcagacgaaatccttgacacgccgcaggatctcacccgcttgatctagatgggtgattgctaacccgagtgagtgtgatatctcctcgactccgggcacatgttcaagccgtagccggcagccctggagatagttcacggcggaaaccaggggttggcccatctggtgtgcaagcgctgcggccattccggccatcgcgttgatgcgtccgagtcgagtgagttctgcgtgacggagcctttccaattcctctatccgcttgcggtaggtgatatctgcgaaggcggccacaactattttctcatccttgatctcgagcaaggatgagctgacgctgagccatcgcgtcttgtgattttcttcgtcgcacatgccgacttcgaggcttctgaccgaacttttctggaggtcgtgaatccgccaaggcaatcgctttttccagatatttgtcccgtcattgagaaagaaccgttgcggtaattgctgccaactcatgggcgtcccttcctgtgttcccatcagttcagaaaactggcagttttcctcgagaatcctgccgcggctatcagtaatcgat

SEQ ID NO: 9 - protein, 218 aa, Thauera aromatica
MCPTIDASTVYLVDDDRSMRDAISSLVRSVGLNVETFASASEFLEHARSEACACLVLDVRMPRMSGFDLQHALSKNGVDIPIIFITGHGDIPMAVRAIKSGALEFLPKPFRAEELLEAINRALNIDQEAREYKAELDKILKKYEGLTDREKEVFPLIAQGLLNKQIAGYLGITEVTIKVHRHNITRKMGVRTLANLVRLYEKLKNAGLIEKKNGNLSG

SEQ ID NO: 10 - protein, 227 aa, Bradyrhizobium japonicum
MTGRFDWRGQGGHTEASTKAIVFVVEDDISMRRSLTNLFRSVGLEVVAFGSAREMLQSTMPDVTSCLVLDVRLPGLSGLDYQTELARLNIHIPIIFITGHGDIPMTVRAMKGGAVDFLSKPFRDQELLDAVVAATERDRKRREAQRTVANLKSLFETLSPREQAVMKLVATGLMNKQVAAELGLAEITVKIYRGHVMKKMRARSLADLIRMSETLGISANHTEQTQV

SEQ ID NO: 11 - protein, 205 aa, Bradyrhizobium japonicum
MTTKGHIYVIDDDAAMRDSLNFLLDSAGFGVTLFDDAQAFLDALPGLSFGCVVSDVRMPGLDGIELLKRMKAQQSPFPILIMTGHGDVPLAVEAMKLGAVDFLEKPFEDDRLTAMIESAIRQAEPAAKSEAVAQDIAARVASLSPRERQVMEGLIAGLSNKLIAREYDISPRTIEVYRANVMTKMQANSLSELVRLAMRAGMLND

SEQ ID NO: 12 - protein, 211 aa, Azorhizobium caulinodans
MPESLPVHVIDDDDAVRESLAFLLESSGLAVTQHTSAAAFLDAGVPLDRGCIVTDVRMPGISGLELLKELNARGAHMAVIVMTGHGDVPLAVEAMKLGAADFLEKPFDDAAIIAAVRASLGRSAEQGRQEDARSEVGKRIAGLSQRERQVLECLVNGLANKTIAYDLGISPRTVEVYRANVMTKMKAASLPELVRMALLAGVAPADDATPT

SEQ ID NO: 13 - protein, 204 aa, Rizobium meliloti
MTDYTVHIVDDEEPVRKSLAFMLTMNGFAVKMHQSAEAFLAFAPDVRNGVLVTDLRMPDMSGVELLRNLGDLKINIPSIVITGHGDVPMAVEAMKAGAVDFIEKPFEDTVIIEAIERASEHLVAAEADVDDANDIRARLQTLSERERQVLSAVVAGLPNKSIAYDLDISPRTVEVHRANVMAKMKAKSLPHLVRMALAGGFGPS

SEQ ID NO: 14 - protein, 197 aa, Rhodobacter capsulatus
MSFTVHIVDDEESLRDSLGFLFASRGIATRTWAAGADLLAEWPLADCGCLILDVRMEGMSGPQLLDALQARPEGLVPPVIFLTGHADVPLAVQSLKAGAFDFVEKPFNDNHIVDIALSAIAAHEGRLAEAQAREAVAARRASLSAREAEVMALMLEGLMNKQIAERLGIAMRTVEVHRSRVLAKMGARNIADLARMT

SEQ ID NO: 15 - protein, 452 aa, Thauera aromatica
VLSAKADDGLRIKLLAESVQDYVVKPFSATELRARVRNLVTMKRARDALQRALDSQSDDLSQLTRQIIDNRQELQRSHDALQESESRWRAVYENSAAGIVLTNLDGLILSANQAFQKMVGYAEDELRVIEISDLVPEHDREKIRSRVSNLISGRVDDYQVQRQCRRKDGRMMWANVRASLIPGLANQSPMVVRIFDDITEKIQTEAELARAREKLTRVMRVTAMGELAASIAHELNQPLAAIVTNGHASLRWLGSEPCNLLEAVEAVRRIIHDANRASEIIKRIRGFLQRGEGRRSAVDIFQVVADVAAIVSDMARSHCIDMRYQAVGQLSLVIADKVQLQQVILNLCINGIESIVGGNSERGELSITVTQSDKRFLTVSVHDSGPGLAPGEAENVFDAFYTSKVEGLGMGLAISRSIIEAHGGRLDVLSPSTEGGCTFCFTLPTEEMASPC

SEQ ID NO: 16 - protein, 376 aa, Bradyrhizobium japonicum
RERLENTLVALRESEQRFRDYAETASDWLWETGPDHRVTHLSEHTSAAGILATGLTGLLRWDIACDMEEEPEKWRQHRATLQAHLPFRDLIYRTVNRMGSPIYVRTSGKPFFDGNGNFLGYRGVSTDITATIRADQAEQELRKAQAELAHVTRVTTLGEMTTSIAHEITQPLAAILSNADACLGWMARDVPNLAAARSSVEWIIEDAIRASEVIRSIRALAKKGEIEMVPLDINQVVRDVSALVTRELVSHQVTLRSELASALPRVLGDRIQLQQVIINLVMNGIEAMDAVTDRPRELLIQSSTDDLGYVQLSVTDCGVGIAENDADRVLDPFFTTKSSGLGMGLSICRSIVEVHGGRISVVQKNGPGATFQFALP

SEQ ID NO: 17 - protein, 399 aa, Bradyrhizobium japonicum
RARAGLIRDEAGTARHLSGIFLDIDEEKQVEGALRTRETHLRSILHTIPDAMIVIDGHGIIQLFSTAAERLFGWSELEAIGQNVNILMPEPDRSRHDSYISRYRTTSDPHIIGIGRIVTGKRRDGTTFPMHLSIGEMQSGGEPYFTGFVRDLTEHQQTQARLQELQSELVHVSRLSAMGEMASALAHELNQPLAAISNYMKGSRRLLAGSSDPNTPKVESALDRAAEQALRAGQIIRRLRDFVARGESEKRVESLSKLIEEAGALGLAGAREQNVQLRFSLDPGADLVLADRVQIQQVLVNLFRNALEAMAQSQRRELVVTNTPAADDMIEVEVSDTGSGFQDDVIPNLFQTFFTTKDTGMGVGLSISRSIIEAHGGRMWAESNASGGATFRFTLPAAD

SEQ ID NO: 18 - protein, 440 aa, Azorhizobium caulinodans
LVIVVLASSGGLFAGLAATAVSALGLALRGLLSGDTVVADWQSLGLLTIAGAGIAVLGERLRRTRLDAVARDRALLAREAHLSSILDTVPDAMIVIDERGIMQSFSITAERLFGYSPSEVIGRNVSMLMPNPHRDQHDLYLSRYLTTGERRIIGIGRVVTGERKDGATFPMELAVGEMHSVSGRFFTGFIRDLTERQNTEARLQELQAELVHISRLTALGEMASTLAHELNQPLSAIANYIKGSRRLLDDGDPKRIPMLQGALDKAAEQALRAGQIIRRLRDFVSRGETERRVESLSKLIEEASALALVGAKEHGIQVRYQIDTSCDLVLADKVQVQQVLLNLMRNALEAMMDASRRQLLVQTTPAEDDMVTVSVCDTGHGISDEMRAQLFTPFVTTKAQGMGVGLSISRTIIEAHGGRIWAEPNAGGGTIFRFTLRTVD

SEQ ID NO: 19 - protein, 385 aa, Rizobium meliloti
IVALGEVLEAARRAIDRTEDVVRARDAHLRSILDTVPDATVVSATDGTIVSFNAAAVRQFGYAEEEVIGQNLRILMPEPYRHEHDGYLQRYMATGEKRIIGIDRVVSGQRKDGSTFPMKLAVGEMRSGGERFFTGFIRDLTEREESAARLEQIQAELARLARLNEMGEMASTLAHELNQPLSAIANYSHGCTRLLRDMDDAVATRIREALEEVASQSLRAGQIIKHLREFVTKGETEKAPEDIRKLVEESAALALVGSREQGVRTVFEYLPGAEMVLVDRIQVQQVLINLMRNAIEAMRHVDRRELTIRTMPADPGEVAVVVEDTGGGIPEEVAGQLFKPFVTTKASGMGIGLSISKRIVEAHGGEMTVSKNEAGGATFRFTLPA

SEQ ID NO: 20 - protein, 387 aa, Rhodobacter capsulatus
VVLHRNALRRRMAEDRLRAEMAFRRAMEESLTVGMRAKDLSGRILYVNGAFCKLVGLAAEDLVGRAQPMPYWAPDFLEETLARQRQLIEGQPVPQAFETRFRRSDGSEIEVQVFEAPLIDAGGRHRGWMGSVIDITQAKQAARLARAQDESLARTGRLVTLGEMASTLAHELNQPLAAIASYAAGGLNLFDQPEPNLTMLRQAFEKMGAQARRAGLVIRRVQDFVKKRTPQLAALDLSEVLAEALSITAPVAREHRVKLASLIEGRIPGVQADRILIEQVLVNLIRNGVEAMAEGPRTGDDLTVRLARAGAAVTIEVMDRGPGISDAVAASLFDPFTSTKSEGMGMGLNICRSIVEMHHGSLSHGPRAGGGTVFTVTLPVPQEGAPA

SEQ ID NO: 21 - DNA, 3106 bp, Thauera aromatica
gaattcatcgtcggctaccacgccgaagatcccaacatgttcccgctgtatcccgaactgtcccacatggccgtgcaggactacctgcggagcgactactcgccgcagccggccgacgaggcggcggcgatcaatgaatactggaagccgcatagcctgcagagcaagtgtcagccctatttcgatccggcagacctcggccgcatgtatcaggtcagcagcatggaggcgccgtccttcgcttccggttacaacagcatcgtgccgccctacgaaaccgtcctggaagacgggctgctggcgcgcatcaagctcgccgaaaagcatatcgccgaagcccaggccgacatgtcgaccttcccctggaacggcacgaagggtctcgacaacatcgccaagatcgacaactggaaggcgatggtcatcgcctgcaaggcggtgatcagctgggcgcgccggcagggccggctgtgcaagatcgtcgcggaaaacttcgagaccgatccgaagcgccaggccgagctgctcgaaatcgccgacatctgtcagcgcattcccgccgagccctgcaagggcctcaaggacgcgatgcaggcgaaattctttaccttcctgatctgtcacgcgatcgagcgctacgcgagcggctacgcccagaaggaagacaccctgctgtggccgtactacaaggcctccgtcgtcgacaagaaattccagccgatgagccacatggatgcggtggaactcgtcgagatggaacgtttgaagatttccgagcatggcgccggcaagtcgcgcgcctaccgcgaaatcttcccggggtcgaacgatctgttcatcctcaccgtcggcggcaccaacgccaagggcgaggacgcctgcaacgacatgaccgacgccatcctcgaggcagccaagcggatccgcacggccgagccctccatcgtcttccgctattccaagaagaaccgcgagaagacgctgcgctgggttttcgagtgcatccgcgacggactcggctatccgtcgatcaagcacgacgagatcggcacggagcagatgaaggaatacgccaagttcagcctcaacggcaacggcgccaccgacgaggaagcccacaactgggtcaacgtgctgtgcatgtcgcccggcatccacggtcgccgcaagacgcaaaaaacccgttcggaaggtggcggctcaatcttcccggccaagctgctggaaatctcgctcaatgacggctacgactggtcgtacgccgacatgcaactcggcccgaagaccggtgatctctcgtcgctgaagtccttcgaggatgtttgggaggctttccgcaagcagtatcaatatgcgatcaacctctgtatcagcaccaaggacgtgtcgcgctacttcgagcagcgcttcctgcagatgcctttcgtgtccgcaatcgacgacggctgcatggaactcgggatggacgcctgcgccctgtccgagcagcccaatggctggcacaacccgatcacgacgatcgtcgcggcgaactccctcgtggccatcaagaaactggtattcgaggagaagaaatacaccctcgagcaactcagccaagcgttgaaggcgaactgggaaggtttcgaggaaatgcgcgtcgacttcaagcgggcgccgaagtggggcaacgacgatgattacgccgacggtatcatcacccgcttctacgaggaaatcatcggcggcgaaatgcgcaagatcaccaactactctggtggtccggtcatgccgactggtcaggctgtcggcctgtacatggaagtcggttcgcgcacgggccccacgccggacgggcgcttcgggggtgaagcggcagacgacggcggcatttctccctacatgggaaccgacaagaaggggccgacggcggtgttgcgctcggtgtccaaggtgcagaagaaccagaagggcaacctgctgaaccagcgcttgtcggtgccgatcatgcgctccaagcatggcttcgaaatctggaactcgtacatgaagacttggcacgatctgaatatcgatcatgttcagttcaatgtcgtcagcacggatgaaatgcgcgctgcgcagcgcgaacccgagaagcaccatgatcttatcgtgcgcgtttccggctacagcgctcggttcgtagacattccgacctatgggcagaacaccatcatcgcccgtcaggaacaggatttcagcgcatccgatctcgagttcctaaacgtcgaaatctaggacaagccactcaaggggggcagcatcccgtccccctttaccttacggttgcacgaaaaaacatggagggcagcaacatggaaacaggacagaatttgcaaaaccagccgcataccgaggtgggtacggcgaggccgtgccggagttgcaaatggcaaacccccgaccccaccgatccgcaccgtgggcaatgcaccgccaaccggcacgccatgggtggcgtctggaaacgctggcttagggacgttgaaaacacgacctgctccaggcacgaggaaggcaaactaagtttccgcgaccacgtctgaacaccggacagacgtggttcacctccagaccactgtagtgatagatcatgaaaacctactccagcgcaaatggcctgttcgtcccggaagtcgatccctactactatgtaagtacggaaaaccagagcttcctcgataaatttgcaaagatatcgaaaaagcatcccgtcaatgtactggtggtcggcaaacaaggctgcggcaagtcttccctagtgcggcaatacgccgccgtcaacaggctacccttggcgaccttccagatcggcatcctgtcggagccggggcaactgtttggtgaatacgcgctggagaacggggagacccgttacaagcagttcctcttcccccaggccatccagacacccaattgcgtcatccaccttgaagagatcaatcgccccgagcatccgaaggcgttgaacatgttgttctccattctctccgatgaccgtcaggtatggatggacgagctcggactgctgcaagtagcgcccggagtcgttttcttcgcaacgctcaacgaagggtccgaattc

SEQ ID NO: 22 - DNA, 557 bp, Thauera aromatica
  misc_feature (235)..(235): n is a, c, g, or t
atacggcgacgcagcgcatgcaattgatgcacttgctgcggtcgagcttaagcacctgcttgcgcccggtccatcaagaagctgcgatgcaccggttgggcagaccgttgcacaccgtccgcagctcacgcaacgatcacggttgtaatagtattccttgcccaccttttgggtttcagggttgtggcaccacggacatctcaatgggcaacccttcaagaacaccgtcgtccgnaatccaggaccgtcttgcaggctaaaacgctgtatttcggtgactaatggaattttcacgtcagccccagaatcgcatgttggaaacgtcatccgtccggtatcaatcggctcgctgtgcgagcattcatttcgaacgattacgcctccgcccaaatccggcggcggaggccgatccaccacgaccatagaagtgaatcttgtaagggttcattgaacttccgccctgctggcggcgtcaataagtgcgatcaccagtcggtgtggtgatttccctcatgtattcgtttgtcaccgcggctcagctaaaatatgcaaataaa

SEQ ID NO: 23 - protein, 740 aa, Thauera aromatica
MFPLYPELSHMAVQDYLRSDYSPQPADEAAAINEYWKPHSLQSKCQPYFDPADLGRMYQVSSMEAPSFASGYNSIVPPYETVLEDGLLARIKLAEKHIAEAQADMSTFPWNGTKGLDNIAKIDNWKAMVIACKAVISWARRQGRLCKIVAENFETDPKRQAELLEIADICQRIPAEPCKGLKDAMQAKFFTFLICHAIERYASGYAQKEDTLLWPYYKASVVDKKFQPMSHMDAVELVEMERLKISEHGAGKSRAYREIFPGSNDLFILTVGGTNAKGEDACNDMTDAILEAAKRIRTAEPSIVFRYSKKNREKTLRWVFECIRDGLGYPSIKHDEIGTEQMKEYAKFSLNGNGATDEEAHNWVNVLCMSPGIHGRRKTQKTRSEGGGSIFPAKLLEISLNDGYDWSYADMQLGPKTGDLSSLKSFEDVWEAFRKQYQYAINLCISTKDVSRYFEQRFLQMPFVSAIDDGCMELGMDACALSEQPNGWHNPITTIVAANSLVAIKKLVFEEKKYTLEQLSQALKANWEGFEEMRVDFKRAPKWGNDDDYADGIITRFYEEIIGGEMRKITNYSGGPVMPTGQAVGLYMEVGSRTGPTPDGRFGGEAADDGGISPYMGTDKKGPTAVLRSVSKVQKNQKGNLLNQRLSVPIMRSKHGFEIWNSYMKTWHDLNIDHVQFNVVSTDEMRAAQREPEKHHDLIVRVSGYSARFVDIPTYGQNTIIARQEQDFSASDLEFLNVEI

SEQ ID NO: 24 - protein, 765 aa, Escherichia coli
MTNRISRLKTALFANTREISLERALLYTASHRQTEGEPVILRRAKATAYILEHVEISIRDEELIAGNRTVKPRAGIMSPEMDPYWLLKELDQFPTRPQDRFAISEEDKRIYREELFPYWEKRSMKDFINGQMTDEVKAATNTQIFSINQTDKGQGHIIIDYPRLLNHGLGELVAQMQQHCQQQPENHFYQAALLLLEASQKHILRYAELAETMAANCTDAQRREELLTIAEISRHNAQHKPQTFWQACQLFWYMNIILQYESNASSLSLGRFDQYMLPFYQTSLTQGEDAAFLKELLESLWVKCNDIVLLRSTSSARYFAGFPTGYTALLGGLTENGRSAVNVLSFLCLDAYQSVQLPQPNLGVRTNALIDTPFLMKTAETIRFGTGIPQIFNDEVVVPAFLNRGVSLEDARDYSVVGCVELSIPGRTYGLHDIAMFNLLKVMEICLHENEGNAALTYEGLLEQIRAKISHYITLMVEGSNICDIGHRDWAPVPLLSSFISDCLEKGRDITDGGARYNFSGVQGIGIANLSDSLHALKGMVFEQQRLSFDELLSVLKANFATPEGEKVRARLINRFEKYGNDIDEVDNISAELLRHYCKEVEKYQNPRGGYFTPGSYTVSAHVPLGSVVGATPDGRFAGEQLADGGLSPMLGQDAQGPTAVLKSVSKLDNTLLSNGTLLNVKFTPATLEGEAGLRKLADFLRAFTQLKLQHIQFNVVNADTLREAQQRPQDYAGLVVRVAGYSAFFVELSKEIQDDIIRRTAHQL

SEQ ID NO: 25 - protein, 740 aa, Clostridium pasteurianum
MFKQWEGFQDGEWTNDVNVRDFIQKNYKEYTGDKSFLKGPTEKTKKVWDKAVSLILEELKKGILDVDTETISGINSFKPGYLDKDNEVIVGFQTDAPLKRITNPFGGIRMAEQSLKEYGFKISDEMHNIFTNYRKTHNQGVFDAYSEETRIARSAGVLTGLPDAYGRGRIIGDYRRVALYGIDFLIQEKKKDLSNLKGDMLDELIRLREEVSEQIRALDEIKKMALSYGVDISRPAVNAKEAAQFLYFGYLAGVKENNGAAMSLGRTSTFLDIYIERDLEQGLITEDEAQEVIDQFIIKLRLVRHLRTPEYNELFAGDPTWVTESIAGVGIDGRSLVTKNSFRYLHTLINLGSAPEPNMTVLWSENLPESFKKFCAEMSILTDSIQYENDDIMRPIYGDDYAIACCVSAMRVGKDMQFFGARCNLAKCLLLAINGGVDEKKGIKVVPDIEPITDEVLDYEKVKENYFKVLEYMAGLYVNTMNIIHFMHDKYAYEASQMALHDTKVGRLMAFGIAGFSVAADSLSAIRYAKVKPIRENGITVDFVKEGDFPKYGNDDDRVDSIAVEIVEKFSDELKKHPTYRNAKHTLSVLTITSNVMYGKKTGTTPDGRKVGEPLAPGANPMHGRDMEGALASLNSVAKVPYVCCEDGVSNTFSIVPDALGNDHDVRINNLVSIMGGYFGQGAHHLNVNVLNRETLIDAMNNPDKYPTLTIRVSGYAVNFNRLSKDHQKEVISRTFHEKL

SEQ ID NO: 26 - DNA, 147 bp, Artificial Sequence
  Synthetic
atgaccatgattacgccaagcttgcatgcatcggtaccgggccccccctcgaggtcgacggtatcgataagcttgatatcgaattcctgcagcccgggggatccactagttctagagcggccgccaccgcggtggagctcgaattca

SEQ ID NO: 27 - protein, 49 aa, Artificial Sequence
  Synthetic
MTMITPSLHASVPGPPSRSTVSISLISNSCSPGDPLVLERPPPRWSSNS

SEQ ID NO: 28 - protein, 864 aa, Thauera aromatica
MNDIVSAKVLEYKGKKLNFTPEDPAEETIPADELHEHLQKPSTARTKRLKERCRWKHASAGEFIEKSVTAGIERMRYLTEAHKASEGKPEAIRRALGLANVLNKSTLVLQEDEFIVGYHAEDPNMFPLYPELSHMAVQDYLRSDYSPQPADEAAAINEYWKPHSLQSKCQPYFDPADLGRMYQVSSMEAPSFASGYNSIVPPYETVLEDGLLARIKLAEKHIAEAQADMSTFPWNGTKGLDNIAKIDNWKAMVIACKAVISWARRQGRLCKIVAENFETDPKRQAELLEIADICQRIPAEPCKGLKDAMQAKFFTFLICHAIERYASGYAQKEDTLLWPYYKASVVDKKFQPMSHMDAVELVEMERLKISEHGAGKSRAYREIFPGSNDLFILTVGGTNAKGEDACNDMTDAILEAAKRIRTAEPSIVFRYSKKNREKTLRWVFECIRDGLGYPSIKHDEIGTEQMKEYAKFSLNGNGATDEEAHNWVNVLCMSPGIHGRRKTQKTRSEGGGSIFPAKLLEISLNDGYDWSYADMQLGPKTGDLSSLKSFEDVWEAFRKQYQYAINLCISTKDVSRYFEQRFLQMPFVSAIDDGCMELGMDACALSEQPNGWHNPITTIVAANSLVAIKKLVFEEKKYTLEQLSQALKANWEGFEEMRVDFKRAPKWGNDDDYADGIITRFYEEIIGGEMRKITNYSGGPVMPTGQAVGLYMEVGSRTGPTPDGRFGGEAADDGGISPYMGTDKKGPTAVLRSVSKVQKNQKGNLLNQRLSVPIMRSKHGFEIWNSYMKTWHDLNIDHVQFNVVSTDEMRAAQREPEKHHDLIVRVSGYSARFVDIPTYGQNTIIARQEQDFSASDLEFLNVEI

SEQ ID NO: 29 - protein, 810 aa, Escherichia coli
MTTLKLDTLSDRIKAHKNALVHIVKPPVCTERAQHYTEMYQQHLDKPIPVRRALALAHHLANRTIWIKHDELIIGNQASEVRAAPIFPEYTVSWIEKEIDDLADRPGAGFAVSEENKRVLHEVCPWWRGQTVQDRCYGMFTDEQKGLLATGIIKAEGNMTSGDAHLAVNFPLLLEKGLDGLREEVAERRSRINLTVLEDLHGEQFLKAIDIVLVAVSEHIERFAALAREMAATETRESRRDELLAMAENCDLIAHQPPQTFWQALQLCYFIQLILQIESNGHSVSFGRMDQYLYPYYRRDVELNQTLDREHAIEMLHSCWLKLLEVNKIRSGSHSKASAGSPLYQNVTIGGQNLVDGQPMDAVNPLSYAILESCGRLRSTQPNLSVRYHAGMSNDFLDACVQVIRCGFGMPAFNNDEIVIPEFIKLGIEPQDAYDYAAIGCIETAVGGKWGYRCTGMSFINFARVMLAALEGGHDATSGKVFLPQEKALSAGNFNNFDEVMDAWDTQIRYYTRKSIEIEYVVDTMLEENVHDILCSALVDDCIERAKSIKQGGAKYDWVSGLQVGIANLGNSLAAVKKLVFEQGAIGQQQLAAALADDFDGLTHEQLRQRLINGAPKYGNDDDTVDTLLARAYQTYIDELKQYHNPRYGRGPVGGNYYAGTSSISANVPFGAQTMATPDGRKAHTPLAEGASPASGTDHLGPTAVIGSVGKLPTAAILGGVLLNQKLNPATLENESDKQKLMILLRTFFEVHKGWHIQYNIVSRETLLDAKKHPDQYRDLVVRVAGYSAFFTALSPDAQDDIIARTEHML

SEQ ID NO: 30 - protein, 765 aa, Escherichia coli; identical to SEQ ID NO: 24

SEQ ID NO: 31 - protein, 760 aa, Escherichia coli
MSELNEKLATAWEGFTKGDWQNEVNVRDFIQKNYTPYEGDESFLAGATEATTTLWDKVMEGVKLENRTHAPVDFDTAVASTITSHDAGYINKQLEKIVGLQTEAPLKRALIPFGGIKMIEGSCKAYNRELDPMIKKIFTEYRKTHNQGVFDVYTPDILRCRKSGVLTGLPDAYGRGRIIGDYRRVALYGIDYLMKDKLAQFTSLQADLENGVNLEQTIRLREEIAEQHRALGQMKEMAAKYGYDISGPATNAQEAIQWTYFGYLAAVKSQNGAAMSFGRTSTFLDVYIERDLKAGKITEQEAQEMVDHLVMKLRMVRFLRTPEYDELFSGDPIWATESIGGMGLDGRTLVTKNSFRFLNTLYTMGPSPEPNMTILWSEKLPLNFKKFAAKVSIDTSSLQYENDDLMRPDFNNDDYAIACCVSPMIVGKQMQFFGARANLAKTMLYAINGGVDEKLKMQVGPKSEPIKGDVLNYDEVMERMDHFMDWLAKQYITALNIIHYMHDKYSYEASLMALHDRDVIRTMACGIAGLSVAADSLSAIKYAKVKPIRDEDGLAIDFEIEGEYPQFGNNDPRVDDLAVDLVERFMKKIQKLHTYRDAIPTQSVLTITSNVVYGKKTGNTPDGRRAGAPFGPGANPMHGRDQKGAVASLTSVAKLPFAYAKDGISYTFSIVPNALGKDDEVRKTNLAGLMDGYFHHEASIEGGQHLNVNVMNREMLLDAMENPEKYPQLTIRVSGYAVRFNSLTKEQQQDVITRTFTQSM

SEQ ID NO: 32 - DNA, 4928 bp, Thauera aromatica
tttatttgcatattttagctgagccgcggtgacaaacgaatacatgagggaaatcaccacaccgactggtgatcgcacttattgacgccgccagcagggcggaagttcaatgaacccttacaagattcacttctatggtcgtggtggatcggcctccgccgccggatttgggcggaggcgtaatcgttcgaaatgaatgctcgcacagcgagccgattgataccggacggatgacgtttccaacatgcgattctggggctgacgtgaaaattccattagtcaccgaaatacagcgttttagcctgcaagacggtcctggattccggacgacggtgttcttgaagggttgcccattgagatgtccgtggtgccacaaccctgaaacccaaaaggtgggcaaggaatactattacaaccgtgatcgttgcgtgagctgcggacggtgtgcaacggtctgcccaaccggtgcatcgcagcttcttgatggaccgggcgcaagccaggtgcttaagctcgaccgcagcaagtgcatcaattgcatgcgctgcgtcgccgtatgcctcaccggtagccgcgactctgtcgggatggaaatgacactcgacgagattttgcgcgaggtcttgtccgatgagcctttctaccgcaatagcgggggcggagtgacgatcagcggaggcgatcctctcttccaccctgcattcacattggaactagcgcgcaagatcaaggaacgcggcgtccatgtcgcgatcgagacttcctgcttcccaaaaaaatgggcgactatccagccgctacttaaactcgtcgatcttttcatcgtcgacctgaaatcgctgaatcggaaaaagcatgaggaaactgttggctggccactgcaacccatactcgacaatatcgagcatctcatacaagccaaggccaatatccgcatacacattcctgtaatccctggattcaacgactcaccaatggatttcgaggattacatcgcttacttgggtcgccatgccgcgcagctggatggcgtagacattctaaattatcacgtctatggagaaggcaagtaccgctccttgggccgggaaaatgaataccagtattttggcgtggaagagaacccacccgaaaaggtagtgccactcgcgaaaggtttgaaactcgccggcatcacgagcgtaacgatcggcgggttggtcgggatcacagcggacagacacaagagtagtcgcgacgctgggactgggtgtattgcataaatcaaaggagactcatccatgggaaccaccacatgcaagcagtgcgcaaacttctttcccgtccctaaagacgcggatgactacgaagccggtaaggcagactgcgtgcgggaaaaggaagacgaaaagggtaaatactggctctccaagcccatattcgagaacagcgcgcaatgtgaagcctttcaaacgaagcgctaaaactacagatcaaggagaccgccatgaacgacatcgtaagcgccaaggttctggaatataaaggaaagaagctcaatttcacgccggaagatccggctgaagagacaattccggccgacgagttgcacgagcatctgcaaaagccttcgacggcgaggaccaagcgcctgaaggagcgttgccgctggaaacacgcatctgccggcgaattcattgaaaagagcgtcacggccggcatcgagcgcatgcgctatctgaccgaagcacacaaggccagcgaaggcaaacccgaagccatccgtcgcgcgctgggcctggcgaacgtcctgaacaagtcgaccctggtgctccaggaggacgaattcatcgtcggctaccacgccgaagatcccaacatgttcccgctgtatcccgaactgtcccacatggccgtgcaggactacctgcggagcgactactcgccgcagccggccgacgaggcggcggcgatcaatgaatactggaagccgcatagcctgcagagcaagtgtcagccctatttcgatccggcagacctcggccgcatgtatcaggtcagcagcatggaggcgccgtccttcgcttccggttacaacagcatcgtgccgccctacgaaaccgtcctggaagacgggctgctggcgcgcatcaagctcgccgaaaagcatatcgccgaagcccaggccgacatgtcgaccttcccctggaacggcacgaagggtctcgacaacatcgccaagatcgacaactggaaggcgatggtcatcgcctgcaaggcggtgatcagctgggcgcgccggcagggccggctgtgcaagatcgtcgcggaaaacttcgagaccgatccgaagcgccaggccgagctgctcgaaatcgccgacatctgtcagcgcattcccgccgagccctgcaagggcctcaaggacgcgatgcaggcgaaattctttaccttcctgatctgtcacgcgatcgagcgctacgcgagcggctacgcccagaaggaagacaccctgctgtggccgtactacaaggcctccgtcgtcgacaagaaattccagccgatgagccacatggatgcggtggaactcgtcgagatggaacgtttgaagatttccgagcatggcgccggcaagtcgcgcgcctaccgcgaaatcttcccggggtcgaacgatctgttcatcctcaccgtcggcggcaccaacgccaagggcgaggacgcctgcaacgacatgaccgacgccatcctcgaggcagccaagcggatccgcacggccgagccctccatcgtcttccgctattccaagaagaaccgcgagaagacgctgcgctgggttttcgagtgcatccgcgacggactcggctatccgtcgatcaagcacgacgagatcggcacggagcagatgaaggaatacgccaagttcagcctcaacggcaacggcgccaccgacgaggaagcccacaactgggtcaacgtgctgtgcatgtcgcccggcatccacggtcgccgcaagacgcaaaaaacccgttcggaaggtggcggctcaatcttcccggccaagctgctggaaatctcgctcaatgacggctacgactggtcgtacgccgacatgcaactcggcccgaagaccggtgatctctcgtcgctgaagtccttcgaggatgtttgggaggctttccgcaagcagtatcaatatgcgatcaacctctgtatcagcaccaaggacgtgtcgcgctacttcgagcagcgcttcctgcagatgcctttcgtgtccgcaatcgacgacggctgcatggaactcgggatggacgcctgcgccctgtccgagcagcccaatggctggcacaacccgatcacgacgatcgtcgcggcgaactccctcgtggccatcaagaaactggtattcgaggagaagaaatacaccctcgagcaactcagccaagcgttgaaggcgaactgggaaggtttcgaggaaatgcgcgtcgacttcaagcgggcgccgaagtggggcaacgacgatgattacgccgacggtatcatcacccgcttctacgaggaaatcatcggcggcgaaatgcgcaagatcaccaactactctggtggtccggtcatgccgactggtcaggctgtcggcctgtacatggaagtcggttcgcgcacgggccccacgccggacgggcgcttcgggggtgaagcggcagacgacggcggcatttctccctacatgggaaccgacaagaaggggccgacggcggtgttgcgctcggtgtccaaggtgcagaagaaccagaagggcaacctgctgaaccagcgcttgtcggtgccgatcatgcgctccaagcatggcttcgaaatctggaactcgtacatgaagacttggcacgatctgaatatcgatcatgttcagttcaatgtcgtcagcacggatgaaatgcgcgctgcgcagcgcgaacccgagaagcaccatgatcttatcgtgcgcgtttccggctacagcgctcggttcgtagacattccgacctatgggcagaacaccatcatcgcccgtcaggaacaggatttcagcgcatccgatctcgagttcctaaacgtcgaaatctaggacaagccactcaaggggggcagcatcccgtccccctttaccttacggttgcacgaaaaaacatggagggcagcaacatggaaacaggacagaatttgcaaaaccagccgcataccgaggtgggtacggcgaggccgtgccggagttgcaaatggcaaacccccgaccccaccgatccgcaccgtgggcaatgcaccgccaaccggcacgccatgggtggcgtctggaaacgctggcttagggacgttgaaaacacgacctgctccaggcacgaggaaggcaaactaagtttccgcgaccacgtctgaacaccggacagacgtggttcacctccagaccactgtagtgatagatcatgaaaacctactccagcgcaaatggcctgttcgtcccggaagtcgatccctactactatgtaagtacggaaaaccagagcttcctcgataaatttgcaaagatatcgaaaaagcatcccgtcaatgtactggtggtcggcaaacaaggctgcggcaagtcttccctagtgcggcaatacgccgccgtcaacaggctacccttggcgaccttccagatcggcatcctgtcggagccggggcaactgtttggtgaatacgcgctggagaacggggagacccgttacaagcagttcctcttcccccaggccatccagacacccaattgcgtcatccaccttgaagagatcaatcgccccgagcatccgaaggcgttgaacatgttgttctccattctctccgatgaccgtcaggtatggatggacgagctcggactgctgcaagtagcgcccggagtcgttttcttcgcaacgctcaacgaagggtccgaattc

SEQ ID NO: 33 - protein, 375 aa, Thauera aromatica
MVVVDRPPPPDLGGGVIVRNECSHSEPIDTGRMTFPTCDSGADVKIPLVTEIQRFSLQDGPGFRTTVFLKGCPLRCPWCHNPETQKVGKEYYYNRDRCVSCGRCATVCPTGASQLLDGPGASQVLKLDRSKCINCMRCVAVCLTGSRDSVGMEMTLDEILREVLSDEPFYRNSGGGVTISGGDPLFHPAFTLELARKIKERGVHVAIETSCFPKKWATIQPLLKLVDLFIVDLKSLNRKKHEETVGWPLQPILDNIEHLIQAKANIRIHIPVIPGFNDSPMDFEDYIAYLGRHAAQLDGVDILNYHVYGEGKYRSLGRENEYQYFGVEENPPEKVVPLAKGLKLAGITSVTIGGLVGITADRHKSSRDAGTGCIA

SEQ ID NO: 34 - protein, 308 aa, Escherichia coli
MLERNREATMIFNIQRYSTHDGPGIRTVVFLKGCSLGCRWCQNPESRARTQDLLYDARLCLEGCELCAKAAPEVIERALNGLLIHREKLTPEHLTALTDCCPTQALTVCGEVKSVEEIMTTVLRDKPFYDRSGGGLTLSGGEPFMQPEMAMALLQASHEAGIHTAVETCLHVPWKYIAPSLPYIDLFLADLKHVADAPFKQWTDGNAARVLDNLKKLAAAGKKIIIRVPLIQGFNADETSVKAITDFAADELHVGEIHFLPYHTLGINKYHLLNLPYDAPEKPLDAPELLDFAQQYACQKGLTATLRG

SEQ ID NO: 35 - protein, 292 aa, Escherichia coli
MTSSAGQRISCNVVETRRDDVARIFNIQRYSLNDGEGIRTVVFFKGCPHLCPWCANPESISGKIQTVRREAKCLHCAKCLRDADECPSGAFERIGRDISLDALEREVMKDDIFFRTSGGGVTLSGGEVLMQAEFATRFLQRLRLWGVSCAIETAGDAPASKLLPLAKLCDEVLFDLKIMDATQARDVVKMNLPRVLENLRLLVSEGVNVIPRLPLIPGFTLSRENMQQALDVLIPLNIRQIHLLPFHQYGEPKYRLLGKTWSMKEVPAPSSADVATMREMAERAGLQVTVGG

SEQ ID NO: 36 - protein, 246 aa, Escherichia coli
MSVIGRIHSFESCGTVDGPGIRFITFFQGCLMRCLYCHNRDTWDTHGGKEVTVEDLMKEVVTYRHFMNASGGGVTASGGEAILQAEFVRDWFRACKKEGIHTCLDTNGFVRRYDPVIDELLEVTDLVMLDLKQMNDEIHQNLVGVSNHRTLEFAKYLANKNVKVWIRYVVVPGWSDDDDSAHRLGEFTRDMGNVEKIELLPYHELGKHKWVAMGEEYKLDGVKPPKKETMERVKGILEQYGHKVMF

SEQ ID NO: 37 - protein, 270 aa, Pseudomonas halodenitrificans
MTLSTVAAQSADQEIPYYDSVGNECAMFEHAYAQRLPLLLKGPTGCGKTRFVSHMAAKLGKPLFTVSCHDDLTAADLTGRYLLQGGETRWVDGPLTRAVREGGICYLDEVVEARKDVTVVLHPLTDDRRLLPLERTGELLEAPDDFMLVASYNPGYQHILKSLKPSTRQRFVAMTFDFPPPKVERDIVARESGLESERCAALVNLAASLRAMKGQDLEEGISTRLLVYCATLIQAGMPIRDAARATLVEPLSDDADVQEGLMEAVQATFG

SEQ ID NO: 38 - protein, 270 aa, Pseudomonas denitrificans
MNAHVKTQGNGAVDAPLLPAAGDEVAVFEAAAANDLPVLLKGPTGCGKTRFVAHMAARLGRPLYTVACHDDLSAADLIGRYLLKGGETVWTDGPLTRAVREGAICYLDEVVEARKDVTVVLHPLTDDRRILPIDRTGEEIEAAPGFMLVASYNPGYQNILKTLKPSTRQRFVAMEFDFPEPAREVEIVARESGLDRDRTLGLVRLAGKIRGLKGQDLEEGVSTRLVVYAASLTRRGMNLDRAIEAAMIEPLTDDAEVKRGLRDLAAAIFG

SEQ ID NO: 39 - protein, 275 aa, Pseudomonas stutzeri
MRYLPVNAIEIPTTAGTPDAPFYQPLGNEEQLFQQAWQHGMPVLIKGPTGCGKTRFVQHMAHRLNLPLYTVACHDDLSAADLVGRHLIGAQGTWWQDGPLTRAVREGGICYLDEVVEARQDTAVVLHPLADDRRELFIERTGEALKAPPGFMLVVSYNPGYQNLLKGMKPSTRQRFVAMRFDYPPTAEEERIVANEAQVDAALAAQVVKLGQALRRLEQHDLEEVASTRLLIFTARMIRSGMTPRQACLACLAEPLSDDPQTVAALMDVVYVHFG

SEQ ID NO: 40 - protein, 262 aa, Rhodobacter sphaeroides
MNAILRDATVPFYKPVGNECELFEAASANGLPLLKGATGCGKTRNVEHMAARMGRKLHTVACHTLSAADLIGRFLLKGGATEWVDGPLTRAVREGAICYLDEVVEARKDVTVVLHPLTDNRRTLMIDRTGEELVAPPGFMLVASYNPGYQNILKRLKPSTRQRFLSISFTFPDPVTETAVVRESGLSEARVAPLVRLAGHVRALSGMDLEEGVSTRLLVYAASLMAGGMTVEQALEAAVIEPLTDEPDVAQALRDLIATVYG

SEQ ID NO: 41 - DNA, 25 bp, Artificial Sequence
  Synthetic
gtgcgcgtttccgcctacagcgctc

SEQ ID NO: 42 - DNA, 25 bp, Artificial Sequence
  Synthetic
gagcgctgtaggcggaaacgcgcac

SEQ ID NO: 43 - DNA, 1018 bp, Thauera aromatica
ccatgggtggcgtctggaaacgctggcttagggacgttgaaaacacgacctgctccaggcacgaggaaggcaaactaagtttccgcgaccacgtctgaacaccggacagacgtggttcacctccagaccactgtagtgatagatcatgaaaacctactccagcgcaaatggcctgttcgtcccggaagtcgatccctactactatgtaagtacggaaaaccagagcttcctcgataaatttgcaaagatatcgaaaaagcatcccgtcaatgtactggtggtcggcaaacaaggctgcggcaagtcttccctagtgcggcaatacgccgccgtcaacaggctacccttggcgaccttccagatcggcatcctgtcggagccggggcaactgtttggtgaatacgcgctggagaacggggagacccgttacaagcagttcctcttcccccaggccatccagacacccaattgcgtcatccaccttgaagagatcaatcgccccgagcatccgaaggcgttgaacatgttgttctccattctctccgatgaccgtcaggtatggatggacgagctcggactgctgcaagtagcgcccggagtcgttttcttcgcaacgctcaacgaagggtccgaattcgtcggtaccgagttactcgacccggccctgcgcgaccgtttttatgtcactaccatggatttcctgccgaatgaagtggaagtcgaggtgctggaaaagaagaccggcgtgaaaaatgagcaggcgagggaaatcatcgcggtagcaaacagcatccgcgccaatgccgacctcggcatcgatgtttccacacgcaagatcctgatgctcggcgagatgattgccgccggcggaacgttgcgcgaagccatcgtgacgagtctccaaaccgacaagaagacgcttgaatcggttttgctgtccctgcacgtcaatctggggaaggtggaaaaaagcaagacagaatacgtccaatacatcgccgcctaaggtcttccatgg

SEQ ID NO: 44 - protein, 286 aa, Thauera aromatica
MKTYSSANGLFVPEVDPYYYVSTENQSFLDKFAKISKKHPVNVLVVGKQGCGKSSLVRQYAAVNRLPLATFQIGILSEPGQLFGEYALENGETRYKQFLFPQAIQTPNCVIHLEEINRPEHPKALNMLFSILSDDRQVWMDELGLLQVAPGVVFFATLNEGSEFVGTELLDPALRDRFYVTTMDFLPNEVEVEVLEKKTGVKNEQAREIIAVANSIRANADLGIDVSTRKILMLGEMIAAGGTLREAIVTSLQTDKKTLESVLLSLHVNLGKVEKSKTEYVQYIAA

SEQ ID NO: 45 - DNA, 2037 bp, Thauera aromatica
ccatggccaagaaccacgacaccacacttcggctgatgagcagcgctggagacgtcaagcgtttcgtcattcccggcgaggagggctattccgatttctggcgtcgagacaagtcgccgatcgaatccgtcgagttggtgaagctattggtcgccattcgtaaactctcgactttcatcggacgcaacgtcggcgaaatcgtctggtccggaatggaactcgacaatgcgatcgccctcgatccaacgccaataatgggcacgtatccggtgccggcgggaaagacggatctgatggtcggcatcatggttcaggaggcatacaagcgcatcgagtggtccgaacgcctgcgcgagatgctcaggctgcgcgtccagccgccgacgcagtatgaatacaagttcgacatgttcttcaccgtctgcgagtccgtctacgtcgacagtttggccaacaagagcgtgctcggctactacgccgaggcggcgcgtgactggcgtatcgtcaagacgctgaagagtctgatcaagccgcccaccctttccgagatgctgcacctgtggtggcgcttggctgccgaccgcaatcccgagctctacaagcagggctacagcgacctcaccctcggcggcttggtcatgcggggtagtctggaccagtactacagcaagccgttgcagaccatgaacagcatcgtgccggccttgcgccacgactgccctgaactctcgagcgtcagcgatcgctgtgacttccgcctcgatctctatgagaagctatggcgcgaggtgctcaaacacatccgcttctggcccggcgaccgcagcgatcggttcatgatgccggacatgggcgatgacgaagaattggcccgggaagaggcggagcaagcagccgtcaaggccaccatcgtcaattacgccaacctgatcgaggcggcgctgccgcagaagaaccgggacttcaccgatcagatcaagggcaacgtcgcaaacctcgagaacgtcgcccgggtcgagggcaacgacatcgtgatgatggcccgcaaccgtgtcgatcgccacctcttgcacaagctggagcaagtggtaaggaacgccaccgaccgccggagcgttttcaaccgcgggctgagttcagggaagattcatagtcggcggctttaccgcgcccacacgaccggcgccgtgttccaacaaaagaaacacgaattcgacatgcgaaagaatgtcgtgctgctcgtggacgcgaccgggtcgatggcggatccgacacaatgggaccaagccgaaatgatctaccagacgctgttcacggcgattctggagtatacgaacaacgcgcgactattcgcctacaacgaagtcaggaacgcctgccgcatcaccgagatctatcgtggtggccgcatgctcacagtgctgccgcacggaaggacagcttccggtgaggccatcatcgccacggcgctaaatacccgtacaccgggaaagaaaactctgctggtccatatcaccgacggcgcctcaaactgggggtgcggcgtcgcagatgccatcaagtactgcaaaggtaacggcatcagcctgctcaccttgggcatcagctgcagtctgtccgccaaacaatcgctacgcgacgaatacggcagtctcgtgaagtttgtcgacaagactgagcaattgcccaagttgtttggcgagttgatcatcagcgaaatgcgtgaatcaaggacagcacagaagtgagcacgtccttactcgaccacgtgctggaagccgaatggcagatgttcgtccgcgtccggagtgcacggcacgccccctgtcagagtgctcccaacaacttcaagacgatccgttccagcctgttcgagacgtggtcgcaaccaatgctcgcttcctatcttgccgacctggaagcagctgatgcggttggccgaaacctgctcgtggagaagtatgctcgcatggacaacttgattccaccgctatcaaacaacccgttgatcggcatcatcgtcaccatcgaaagcaa

SEQ ID NO: 46 - protein, 581 aa, Thauera aromatica
MAKNHDTTLRLMSSAGDVKRFVIPGEEGYSDFWRRDKSPIESVELVKLLVAIRKLSTFIGRNVGEIVWSGMELDNAIALDPTPIMGTYPVPAGKTDLMVGIMVQEAYKRIEWSERLREMLRLRVQPPTQYEYKFDMFFTVCESVYVDSLANKSVLGYYAEAARDWRIVKTLKSLIKPPTLSEMLHLWWRLAADRNPELYKQGYSDLTLGGLVMRGSLDQYYSKPLQTMNSIVPALRHDCPELSSVSDRCDFRLDLYEKLWREVLKHIRFWPGDRSDRFMMPDMGDDEELAREEAEQAAVKATIVNYANLIEAALPQKNRDFTDQIKGNVANLENVARVEGNDIVMMARNRVDRHLLHKLEQVVRNATDRRSVFNRGLSSGKIHSRRLYRAHTTGAVFQQKKHEFDMRKNVVLLVDATGSMADPTQWDQAEMIYQTLFTAILEYTNNARLFAYNEVRNACRITEIYRGGRMLTVLPHGRTASGEAIIATALNTRTPGKKTLLVHITDGASNWGCGVADAIKYCKGNGISLLTLGISCSLSAKQSLRDEYGSLVKFVDKTEQLPKLFGELIISEMRESRTAQK

SEQ ID NO: 47 - DNA, 183 bp, Thauera aromatica
atgggaaccaccacatgcaagcagtgcgcaaacttctttcccgtccctaaagacgcggatgactacgaagccggtaaggcagactgcgtgcgggaaaaggaagacgaaaagggtaaatactggctctccaagcccatattcgagaacagcgcgcaatgtgaagcctttcaaacgaagcgctaa

SEQ ID NO: 48 - protein, 60 aa, Thauera aromatica
MGTTTCKQCANFFPVPKDADDYEAGKADCVREKEDEKGKYWLSKPIFENSAQCEAFQTKR

SEQ ID NO: 49 - DNA, 246 bp, Thauera aromatica
atggagggcagcaacatggaaacaggacagaatttgcaaaaccagccgcataccgaggtgggtacggcgaggccgtgccggagttgcaaatggcaaacccccgaccccaccgatccgcaccgtgggcaatgcaccgccaaccggcacgccatgggtggcgtctggaaacgctggcttagggacgttgaaaacacgacctgctccaggcacgaggaaggcaaactaagtttccgcgaccacgtctga

SEQ ID NO: 50 - protein, 81 aa, Thauera aromatica
MEGSNMETGQNLQNQPHTEVGTARPCRSCKWQTPDPTDPHRGQCTANRHAMGGVWKRWLRDVENTTCSRHEEGKLSFRDHV

SEQ ID NO: 51 - DNA, 20 bp, Artificial Sequence
  Synthetic
ctgcttgcatgtggtggttc

SEQ ID NO: 52 - DNA, 21 bp, Artificial Sequence
  Synthetic
gatccaccacgaccatagaag

SEQ ID NO: 53 - DNA, 29 bp, Artificial Sequence
  Synthetic
caacgtgctggccatgtcgcccggcatcc

SEQ ID NO: 54 - DNA, 29 bp, Artificial Sequence
  Synthetic
ggatgccgggcgacatgcccagcacgttg

SEQ ID NO: 55 - protein, 979 aa, Thauera aromatica
MTSNNSSVSDISAVLRVRDVTLRAVDDLQTYREKLARVVLDGLYEFVGLLDAKGNTLEINQAALDGAGTRLEDIRDKPFWEARWWQVSRETQEEQRKLIARASAGEFVRCDVEIYGRASGEETIVVDYSILPIRDCNGKVVFLLPEGRNITDKKLAEAELARKNEELQHLLEKIRQLDEAKNEFFANLSHELRTPLSLILGSVESLLADSGDYSGVQRVDLDVIQRNAITLLKYVNDLLDLAKLQAEKLQLHYSRVDLAAVTRMICAHFEALAEYKCLSYVIDAPAFMEAEVDVEKYERIVLNLLSNAFKFSPDGGRIRCSLSATGTGRILLSIQDSGPGIPADQQSEIFGRFRQGGDIKSRQFGGTGLGLTIVKDFVCLHGGVVVVSDAPGGGALFQIELPRNAPSGVYVNAVAKAGELSPTSFDISAWGLEGRSEWTSAEGASDRPRILIVEDNVDMRCFIGRVLIDEYQISVAADGEQALELITSSPPDLVITDLMMPKVSGQLLVKEMRSRGDLANVPILVLSAKADDGLRIKLLAESVQDYVVKPFSATELRARVRNLVTMKRARDALQRALDSQSDDLSQLTRQIIDNRQELQRSHDALQESESRWRAVYENSAAGIVLTNLDGLILSANQAFQKMVGYAEDELRVIEISDLVPEHDREKIRSRVSNLISGRVDDYQVQRQCRRKDGRMMWANVRASLIPGLANQSPMVVRIFDDITEKIQTEAELARAREKLTRVMRVTAMGELAASIAHELNQPLAAIVTNGHASLRWLGSEPCNLLEAVEAVRRIIHDANRASEIIKRIRGFLQRGEGRRSAVDIFQVVADVAAIVSDMARSHCIDMRYQAVGQLSLVIADKVQLQQVILNLCINGIESIVGGNSERGELSITVTQSDKRFLTVSVHDSGPGLAPGEAENVFDAFYTSKVEGLGMGLAISRSIIEAHGGRLDVLSPSTEGGCTFCFTLPTEEMASPCAPQ

SEQ ID NO: 56 - protein, 218 aa, Thauera aromatica; identical to SEQ ID NO: 9

SEQ ID NO: 57 - DNA, 13 bp, Artificial Sequence
  Synthetic
acgtggttgtgcg

SEQ ID NO: 58 - DNA, 13 bp, Artificial Sequence
  Synthetic
ccagccctagtgt

SEQ ID NO: 59 - DNA, 26 bp, Artificial Sequence
  Synthetic
tctagagtggttcccatggatgagtc

SEQ ID NO: 60 - DNA, 21 bp, Artificial Sequence
  Synthetic
gtgaagcctttcaaacgaagc

SEQ ID NO: 61 - DNA, 23 bp, Artificial Sequence
  Synthetic
tagacttacgatgtcgttcatgg

SEQ ID NO: 62 - DNA, 25 bp, Artificial Sequence
  Synthetic
gcatgcttacgatgtcgttcatggc

SEQ ID NO: 63 - DNA, 21 bp, Artificial Sequence
  Synthetic
gaatactggaagccgcatagc

SEQ ID NO: 64 - DNA, 20 bp, Artificial Sequence
  Synthetic
ccatgttgctgccctccatg

SEQ ID NO: 65 - DNA, 23 bp, Artificial Sequence
  Synthetic
tctagaacaccggacagacgtgg

SEQ ID NO: 66 - DNA, 19 bp, Artificial Sequence
  Synthetic
gagttgcacgagcatctgc

SEQ ID NO: 67 - DNA, 20 bp, Artificial Sequence
  Synthetic
cagactgcgtgcgggaaaag

SEQ ID NO: 68 - DNA, 20 bp, Artificial Sequence
  Synthetic
gcagatgcgtgtttccagcg

SEQ ID NO: 69 - DNA, 20 bp, Artificial Sequence
  Synthetic
gtttgccatttgcaactccg

SEQ ID NO: 70 - DNA, 20 bp, Artificial Sequence
  Synthetic
ctcgccgggaatgacgaaac

SEQ ID NO: 71 - DNA, 19 bp, Artificial Sequence
  Synthetic
ctcttcccccaggccatcc

(19) United States
(12) Patent Application Publication
(10) Pub. No.: US 2004/0038382 A1
(43) Pub. Date: Feb. 26, 2004

(54) Compositions and methods for bioremediation

(75) Inventor: Peter W. Coschigano, The Plains, OH (US)

Correspondence Address: MEDLEN & CARROLL, LLP, Suite 350, 101 Howard Street, San Francisco, CA, 94105, US

(73) Assignee: Ohio University, Technology Transfer Office, Technology and Enterprise Building

(21) Appl. No.: 10/357,567

(22) Filed: Feb. 4, 2003

Related U.S. Application Data
(63) Continuation-in-part of application No. 09/072,433, filed on May 4, 1998, now Pat. No. 6,551,814.
(60) Provisional application No. 60/046,845, filed on May 5, 1997.

(51) Int. Cl. C12S 1/00; B09B 3/00

(52) U.S. Cl. 435/262.5

(57) ABSTRACT

Compositions and methods for the degradation of compounds contained in a liquid or solid waste stream are described. Genes encoding toluene-degrading enzymes are described. The enzymes have homology to the E. coli pyruvate formate lyase and pyruvate formate lyase activator.

This application is a continuation-in-part of non-provisional application Ser. No. 09/072,433, filed May 4, 1998, which was a conversion of provisional Application Serial No. 60/046,845, filed May 5, 1997.

This invention was made with government support under NSF grant MCB9507132 and DARPA grant N00014-92-J-1888. The government has certain rights in the invention.

### FIELD OF THE INVENTION

This invention relates to biological treatment of organic compounds, and particularly to the degradation of toluene and toluene analogues.

### BACKGROUND

Industrial processes that use or generate toxic organic compounds (e.g., toluene, benzene, xylenes) has lead to the contamination of nearby water and land. Such compounds are among the most water soluble of all gasoline components and can also enter aquatic environments from many sources such as gasoline underground storage tanks, leaks, and spills.

Most approaches to decontamination or “remediation” involve stopping the local dumping of such compounds and transport of the waste to another area for containment. This is costly and does not eliminate the hazard.

As a remediation technology, bioremediation is considerably more attractive. Rather than merely transporting wastes, it offers the possibility of degrading toxic compounds to harmless reaction products by the use of biologicals.

Bioremediation field trials have involved both in-situ and ex-situ treatment methods. Typically, ex-situ treatment involves the transfer of contaminated waste from the site into a treatment tank designed to support microbial growth, i.e., a “bioreactor”. The reactor provides for effective mixing of nutrients and control over temperature, pH and aeration to allow optimum microbial growth.

In-situ treatment involves adding biologicals directly to the waste. This avoids the problems associated with handling (e.g., pumping) toxic compounds. However, in-situ treatment has its own problems. Unlike bioreactors, where microbial growth can be monitored and adjusted, in-situ environmental conditions are difficult to measure and control.

Fries et al., “Isolation, characterization and distribution of denitrifying toluene degraders from a variety of habitats,” Appl. Environ. Microbiol. 60:2802 (1994) generally indicates that biodegradation of benzene, toluene, ethylbenzene and xylenes under aerobic conditions is well known, although the availability of oxygen due to its low solubility in water and low rate of transport in soils and sediments is rate limiting. Fries et al. describes anaerobic respiration of toluene by microorganisms isolated from nature. The microorganisms could grow on 25 ppm toluene and could be fed 50 ppm toluene.

Rates have been determined at 28-30° C. with intact cells from a variety of strains. The rates vary from between 8 to 80 nmoles toluene min⁻¹ mg⁻¹ protein (A. Frazer et al., “Toluene Metabolism Under Anaerobic Conditions: A Review” Anaerobe 1:293, 1995).

There remains a need to develop a bioremediation procedure that can be operated economically on a commercial scale. Such a procedure must be able to degrade organic compounds with high efficiency.

### SUMMARY OF THE INVENTION

This invention relates to biological treatment of organic compounds, and particularly to the degradation of toluene and toluene analogues. In one embodiment, the present invention contemplates a method of degrading compounds contained in a liquid or solid waste source, comprising the steps of: a) providing, i) a waste source comprising toluene (and/or a toluene analogue), ii) a reaction containing means, and iii) a compound selected from the group consisting of a functional, cell-free pyruvate formate lyase homologue of a toluene-degrading bacterium and a functional, cell-free pyruvate formate lyase activating homologue of a toluene-degrading bacterium; and b) reacting said homologue and said waste source in said containing means under conditions such that toluene (and/or the toluene analogue) is degraded.

It is not intended that the present invention be limited by the specific toluene-degrading bacterium. In one embodiment, said homologue is derived from an organism of the genus Thauera. In one embodiment, the organism is Thauera aromatica.

In another embodiment, said homologue is derived from an organism of the genus Xanthomonas. In one embodiment, the organism is Xanthomonas maltophilia.

In yet another embodiment, said homologue is derived from an organism of the genus Geobacter. In one embodiment, the organism is Geobacter metallireducens.

In still another embodiment, said homologue is derived from members of the genus Azoarcus. In one embodiment, the organism is Azoarcus tolulyticus.

The present invention contemplates nucleic acid sequences (and constructs comprising said sequences) and amino acid sequences of toluene degrading enzymes as compositions of matter (as well as antibodies to such amino acid sequences). In one embodiment, the present invention contemplates a purified nucleic acid comprising DNA having the sequence as set forth in FIG. 12. In one embodiment, said DNA is in a vector. In another embodiment, said vector is a bacterial plasmid. In a particular embodiment, said bacterial plasmid is in a host cell. In one embodiment, said host cell expresses a toluene-degrading enzyme.

The present invention contemplates a functional, cell-free product of the tutD gene having the amino acid sequence as set forth in FIG. 11. In one embodiment, said product is contained within a reaction containing means. In a preferred embodiment, said reaction containing means is a bioreactor.

It is also not intended that the present invention be limited by the precise amino acid sequence of the homologue. In one embodiment, it is encoded by the tutD gene, a nucleic acid sequence for which is shown in FIG. 5, and has the amino acid sequence shown in FIG. 7. In another embodiment, the homologue is an expanded TutD protein having the amino acid shown in FIG. 11 and the corresponding nucleic acid sequence shown in FIG. 12. In another embodiment, the homologue is encoded by the tutE gene having a nucleic acid sequence shown in FIG. 12, and a corresponding amino acid sequence shown in FIG. 13.

Additionally, the present invention contemplates a reporter gene fusion product constructed by fusing the tutD gene in frame to a reporter such as lacZ, luxA, 6-his or green fluorescence protein. Such constructs can be used to demonstrate regulated expression in response to toluene.

In another embodiment, the present invention contemplates a reporter gene fusion product constructed by fusing the tutE gene in frame to a reporter such as lacz, luxA, 6-his or green fluorescence protein. Such constructs can be used to demonstrate regulated expression in response to toluene.

The present invention contemplates a functional, cell-free product of the tutH gene having the nucleic acid sequence as set forth in FIG. 18 and the amino acid sequence shown in FIG. 19. In one embodiment, said product is contained within a reaction containing means. In a preferred embodiment, said reaction containing means is a bioreactor.

Additionally, the present invention contemplates a reporter gene fusion product constructed by fusing the tutH gene in frame to a reporter such as lacZ, luxA, 6-his or green fluorescence protein. Such constructs can be used to demonstrate regulated expression in response to toluene.

The present invention contemplates a functional, cell-free product of the tutI gene having the nucleic acid sequence as set forth in FIG. 21 and the amino acid sequence shown in FIG. 22. In one embodiment, said product is contained within a reaction containing means. In a preferred embodiment, said reaction containing means is a bioreactor.

Additionally, the present invention contemplates a reporter gene fusion product constructed by fusing the tutI gene in frame to a reporter such as lacz, luxA, 6-his or green fluorescence protein. Such constructs can be used to demonstrate regulated expression in response to toluene.

The present invention contemplates a functional, cell-free product of the tutF gene having the nucleic acid sequence as set forth in FIG. 24 and the amino acid sequence shown in FIG. 25. In one embodiment, said product is contained within a reaction containing means. In a preferred embodiment, said reaction containing means is a bioreactor.

Additionally, the present invention contemplates a reporter gene fusion product constructed by fusing the tutF gene in frame to a reporter such as lacZ, luxA, 6-his or green fluorescence protein. Such constructs can be used to demonstrate regulated expression in response to toluene.

The present invention contemplates a functional, cell-free product of the tutG gene having the nucleic acid sequence as set forth in FIG. 26 and the amino acid sequence shown in FIG. 27. In one embodiment, said product is contained within a reaction containing means. In a preferred embodiment, said reaction containing means is a bioreactor.

Additionally, the present invention contemplates a reporter gene fusion product constructed by fusing the tutG gene in frame to a reporter such as lacZ, luxA, 6-his or green fluorescence protein. Such constructs can be used to demonstrate regulated expression in response to toluene.

Additionally, the present invention contemplates a composition comprising isolated and purified DNA having an oligonucleotide sequence selected form the group consisting of, SEQ ID NO: 43, SEQ ID NO: 45, SEQ ID NO: 47, and SEQ ID NO: 49.

Additionally, the present invention contemplates a composition comprising isolated and purified polypeptide selected form the group consisting of, SEQ ID NO: 44, SEQ ID NO: 46, SEQ ID NO: 48, and SEQ ID NO: 50.

In one embodiment, the present invention contemplates a composition comprising the TutD (SEQ ID NO: 23), TutF (SEQ ID NO: 48), TutG (SEQ ID NO: 50) and TutE (SEQ ID NO: 33) proteins. In another embodiment, the present invention contemplates a composition consisting essentially of the TutD (SEQ ID NO: 23), TutF (SEQ ID NO: 48), TutG (SEQ ID NO: 50) and TutE (SEQ ID NO: 33) proteins. In yet another embodiment, the present invention contemplates a composition consisting of the TutD (SEQ ID NO: 23), TutF (SEQ ID NO: 48), TutG (SEQ ID NO: 50) and TutE (SEQ ID NO: 33) proteins. In still yet another embodiment, the present invention contemplates a gene construct (e.g., a plasmid, vector or the like) capable of expressing the TutD, TutF, TutG and TutE proteins. In still yet another embodiment, the present invention contemplates a microorganism transformed with the gene construct.

In one embodiment, the present invention contemplates a method of detoxifying toluene and toluene comprising mixtures by adding to the toluene or toluene comprising mixture a composition comprising the TutD (SEQ ID NO: 23), TutF (SEQ ID NO: 48), TutG (SEQ ID NO: 50) and TutE (SEQ ID NO: 33) proteins. In another embodiment, the present invention contemplates a method of detoxifying toluene and toluene comprising mixtures by adding to the toluene or toluene comprising mixture a composition consisting essentially of the TutD, TutF, TutG and TutE proteins. In yet another embodiment, the present invention contemplates a method of detoxifying toluene and toluene comprising mixtures by adding to the toluene or toluene comprising mixture a composition consisting of the TutD, TutF, TutG and TutE proteins. In still yet another embodiment, the present invention contemplates a method of detoxifying toluene and toluene comprising mixtures by adding to the toluene or toluene comprising mixture a microorganism transformed with the gene construct (e.g., a plasmid, vector or the like) capable of expression the TutD, TutF, TutG and TutE proteins.

In one embodiment of the present invention, the amino acid sequences of the TutD (SEQ ID NO: 23), TutF (SEQ ID NO: 48), TutG (SEQ ID NO: 50) and TutE (SEQ ID NO: 33) proteins are given by their respective SEQ ID NOS. In another embodiment of the present invention, the nucleic acids encoding the TutD, TutF, TutG and TutE proteins are, respectively, TutD (SEQ ID NO: 21), TutF (SEQ ID NO: 47), TutG (SEQ ID NO: 49) and TutE (SEQ ID NO: 22).

It is not intended that the present invention be limited by the specific toluene-degrading bacterium or Tut proteins from a specific toluene-degrading bacterium. In one embodiment, said Tut proteins are derived from an organism of the genus Thauera. In one embodiment, the organism is Thauera aromatica.

In another embodiment, said Tut proteins are derived from an organism of the genus Xanthomonas. In one embodiment, the organism is Xanthomonas maltophilia.

In yet another embodiment, said Tut proteins are derived from an organism of the genus Geobacter. In one embodiment, the organism is Geobacter metallireducens.

In still another embodiment, said Tut proteins are derived from members of the genus Azoarcus. In one embodiment, the organism is Azoarcus tolulyticus.

The present invention contemplates in one embodiment, a method of degrading compounds contained in a liquid or solid waste source, comprising the steps of: a) providing i) a waste source comprising toluene, ii) a reaction containing means, and iii) a mixture consisting essentially of the TutD, TutF, TutG and TutE proteins, and; b) reacting said compound and said waste source in said containing means under conditions such that toluene is degraded. In another embodiment, the present invention contemplates the method above, wherein said TutD, TutF, TutG and TutE proteins are derived from an organism selected from the group consisting of Thauera aromatica, Xanthomonas maltophilia, Geobacter metallireducens, and Azoarcus tolulyticus. In yet another embodiment, the present invention contemplates the above method wherein said Tut proteins have the amino acid sequences TutD (SEQ ID NO: 23), TutF (SEQ ID NO: 48), TutG (SEQ ID NO: 50) and TutE (SEQ ID NO: 33), respectively. In still yet another embodiment, the present invention contemplates that the method is performed in a bioreactor. In still yet another embodiment, the present invention contemplates that benzylsuccinate is added to the reaction vessel.

In one embodiment, the present invention contemplates a composition comprising the isolated TutD (SEQ ID NO: 23), TutF (SEQ ID NO: 48), TutG (SEQ ID NO: 50) and TutE (SEQ ID NO: 33) proteins. In another embodiment, the present invention contemplates an expression construct comprising nucleic acids encoding the TutD, TutF, TutG and TutE proteins. In yet another embodiment, the present invention contemplates that the expression construct comprises nucleic acids encoding TutD (SEQ ID NO: 21), TutF (SEQ ID NO: 47), TutG (SEQ ID NO: 49) and TutE (SEQ ID NO: 22).

The present invention is not limited to the use of the isolated Tut proteins. In some embodiments, organisms expressing the Tut proteins are used and introduced directly into the waste stream. In other embodiments, the Tut proteins (and/or the organisms producing such proteins) are protected or shielded from the waste stream. In one such embodiment, the Tut proteins are shielded by placing them in liposomes or microparticles in a manner such that the proteins or complex can act on toluene but are constrained by the membrane or pore sizes.

In one embodiment, the present invention contemplates a method of degrading toluene contained in a liquid or solid waste stream, comprising the steps of: a) providing, i) a reaction containing means having a semi-permeable membrane partition, ii) a complex consisting essentially of the TutD, TutF, TutG and TutE proteins; b) adding to the containing means on one side of the partition, the complex in solution to create a reaction mixture; c) adding to the containing means on the other side of the partition, the compounds contained in said waste stream, under conditions whereby toluene is degraded.

In one embodiment, the present invention contemplates a method of degrading toluene contained in a liquid or solid waste stream, comprising the steps of: a) providing, i) a reaction containing means having a semi-permeable membrane partition, ii) a complex consisting essentially of TutD, TutF, TutG and TutE proteins for which the membrane is not permeable; b) adding to the containing means on one side of the partition, the complex in solution to create a reaction mixture; c) adding to the containing means on the other side of the partition, the compounds contained in said waste stream, under conditions whereby toluene is degraded.

When generating the proteins in organisms, the present invention is not limited to transforming with a single construct. While in one embodiment, the present invention contemplates a vector comprising genes encoding for the TutD, TutE, TutF, and TutG, in another embodiment, separate vectors are used for each gene. In still other embodiments, organisms transformed with one or more of the above-noted genes are crossed with other organisms that have been transformed with the other genes.

It is not intended that the present invention be limited to wild type TutD, TutE, TutF, and TutG genes and resulting proteins. It is contemplated that variants can be readily made and tested for activity. Such variants comprise the substitution of amino acids with conservative replacements. For example, the replacement of a basic amino acid with another basic amino acid (e.g., histidine, lysine or arginine) would be a conservative substitution. Other variants comprise the substitution of motifs with other motifs. For example, binding domains or reactive domains may be readily replaced by methods known in the art. It is not necessary that a substitution result in a more active protein. In some instances, a less active protein may be desired. Other variants comprise the removal of portions of the protein. The portion removed may be from one amino acid to twenty or more amino acids. Removal of certain portions may, for example, result in fewer non-specific interactions or less degradation of the protein. Still other variants comprise the addition of portions to the proteins. Such additions may be, for example, binding sites. Such binding sites may be useful in binding the protein to a stationary surface.

Definitions

To facilitate understanding of the invention, a number of terms are defined below.

The term “reaction” or “chemical reaction” means reactions involving chemical reactants, such as organic compounds. A “reaction containing means” refers to anything that can contain a reaction, including but not limited to, tubes, microtiter plates, vessels, and bioreactors. It is not intended that the present invention be limited by a particular reaction containing means. U.S. Pat. Nos. 5,610,061, 5,585,272, 5,571,705, 5,560,737, 5,057,221 and 5,037,551 all describe various reaction containing means (including bioreactors) and are hereby incorporated by reference. Other bioreactors are described in U.S. Pat. Nos. 6,174,720, 6,159,726, 6,051,130 and 6,033,568 and are incorporated by reference.

“Initiating a reaction” means causing a reaction to take place. Reactions can be initiated by any means (e.g., mixing, heat, wavelengths of light, addition of a catalyst, etc.).

A “solvent” is a liquid substance capable of dissolving or dispersing one or more other substances. It is not intended that the present invention be limited by the nature of the solvent used.

A “waste source” can be a solid or liquid waste source (e.g., paper pulp, pulp mill effluent, sludge, wastewater, petroleum spill, etc.).

“Toluene analogues” are structural analogues of toluene. While it is not intended that the present invention be limited to particular analogues, examples include the o-, m-, and p-isomers of chlorotoluene, fluorotoluene and xylene.

A “pyruvate formate lyase homologue” is defined as a gene product from a toluene-degrading organism, said gene product comprising i) regions of identity with the pyruvate formate lyase from E. coli (the PflD gene Genebank G418519) and/or from Clostridium pasteurianum (Genebank G1072361) such that the gene product contains the motif RVSGY (SEQ ID NO:1), RVAGY (SEQ ID NO:2), or VRVSGYSA (SEQ ID NO:3) at the essential glycine (shown in bold and discussed below), and ii) regions of non-identity. The gene product may contain other regions of identity with pyruvate formate lyase from E. coli (the PflD gene Genebank G418519) and from Clostridium pasteurianum (Genebank G1072361), including but not limited to, the motif TPDGR (SEQ ID NO:4), TPDGRF (SEQ ID NO:5), GPTAVL (SEQ ID NO:6), and GNDDD (SEQ ID NO:7). As noted below, the present invention also identifies other conserved regions, including but not limited to those associated with an essential conserved cysteine.

A “functional” homologue is one where transfer of the gene or expression of the gene product confers the ability to degrade toluene. Functional homologues need not comprise the entire gene product, i.e. functional peptide fragments (portions that are less than the entire gene product) are specifically contemplated.

The term “purified” means separated from some components that are normally present in the native state. Thus, a spectrum of purity is contemplated. At the very basic level, a cell-free preparation is “purified.” Similarly, nucleic acid that is even substantially protein-free is “purified.” At a more extreme level, the present invention contemplates a particular toluene degrading protein that is substantially free of all other proteins (usually less than 10% and preferably less than 5% of other proteins are present).

The term “gene” refers to a DNA sequence that comprises control and coding sequences necessary for the production of a polypeptide or precursor thereof. The polypeptide can be encoded by a full length coding sequence or by any portion of the coding sequence so long as the desired enzymatic activity is retained.

The term “wild-type” refers to a gene or gene product which has the characteristics of that gene or gene product when isolated from a naturally occurring source. A wild-type gene is that which is most frequently observed in a population and is thus arbitrarily designated the “normal” or “wild-type” form of the gene. In contrast, the term “modified” or “mutant” refers to a gene or gene product which displays modifications in sequence and or functional properties (i.e., altered characteristics) when compared to the wild-type gene or gene product. It is noted that naturally-occurring mutants can be isolated; these are identified by the fact that they have altered characteristics when compared to the wild-type gene or gene product.

The term “oligonucleotide” as used herein is defined as a molecule comprised of two or more deoxyribonucleotides or ribonucleotides, usually more than three (3), and typically more than ten (10) and up to one hundred (100) or more (although preferably between twenty and thirty). The exact size will depend on many factors, which in turn depends on the ultimate function or use of the oligonucleotide. The oligonucleotide may be generated in any manner, including chemical synthesis, DNA replication, reverse transcription, or a combination thereof.

Because mononucleotides are reacted to make oligonucleotides in a manner such that the 5′ phosphate of one mononucleotide pentose ring is attached to the 3′ oxygen of its neighbor in one direction via a phosphodiester linkage, an end of an oligonucleotide is referred to as the “5′ end” if its 5′ phosphate is not linked to the 3′ oxygen of a mononucleotide pentose ring and as the “3′ end” if its 3′ oxygen is not linked to a 5′ phosphate of a subsequent mononucleotide pentose ring. As used herein, a nucleic acid sequence, even if internal to a larger oligonucleotide, also may be said to have 5′ and 3′ ends.

When two different, non-overlapping oligonucleotides anneal to different regions of the same linear complementary nucleic acid sequence, and the 3′ end of one oligonucleotide points towards the 5′ end of the other, the former may be called the “upstream” oligonucleotide and the latter the “downstream” oligonucleotide.

The term “primer” refers to an oligonucleotide which is capable of acting as a point of initiation of synthesis when placed under conditions in which primer extension is initiated. An oligonucleotide “primer” may occur naturally, as in a purified restriction digest or may be produced synthetically.

A primer or oligonucleotide is selected to be “substantially” complementary to a strand of specific sequence of the template. A primer must be sufficiently complementary to hybridize with a template strand for primer elongation to occur. A primer sequence need not reflect the exact sequence of the template. For example, a non-complementary nucleotide fragment may be attached to the 5′ end of the primer, with the remainder of the primer sequence being substantially complementary to the strand. Non-complementary bases or longer sequences can be interspersed into the primer, provided that the primer sequence has sufficient complementarily with the sequence of the template to hybridize and thereby form a template primer complex for synthesis of the extension product of the primer.

“Hybridization” methods involve the annealing of a complementary sequence to the target nucleic acid (the sequence to be detected). The ability of two polymers of nucleic acid containing complementary sequences to find each other and anneal through base pairing interaction is a well-recognized phenomenon. The initial observations of the “hybridization” process by Marmur and Lane, Proc. Natl. Acad. Sci. USA 46:453 (1960) and Doty et al., Proc. Natl. Acad. Sci. USA 46:461 (1960) have been followed by the refinement of this process into an essential tool of modern biology.

Even where the sequence of a probe or oligonucleotide is completely complementary to the sequence of the target, i.e., the target's primary structure, the target sequence must be made accessible to the probe via rearrangements of higher-order structure. These higher-order structural rearrangements may concern either the secondary structure or tertiary structure of the molecule. Secondary structure is determined by intramolecular bonding. In the case of DNA or RNA targets this consists of hybridization within a single, continuous strand of bases (as opposed to hybridization between two different strands). Depending on the extent and position of intramolecular bonding, the probe can be displaced from the target sequence preventing hybridization.

Solution hybridization of oligonucleotide probes to denatured double-stranded DNA is further complicated by the fact that the longer complementary target strands can renature or reanneal. Again, hybridized probe is displaced by this process. This results in a low yield of hybridization (low “coverage”) relative to the starting concentrations of probe and target.

Hybridization, regardless of the method used, requires some degree of complementarily between the sequence being assayed (the target sequence) and the fragment of DNA used to perform the test (the probe). (Of course, one can obtain binding without any complementarily but this binding is nonspecific and to be avoided.)

The complement of a nucleic acid sequence as used herein refers to an oligonucleotide which, when aligned with the nucleic acid sequence such that the 5′ end of one sequence is paired with the 3′ end of the other, is in “antiparallel association.” Certain bases not commonly found in natural nucleic acids may be included in the nucleic acids of the present invention and include, for example, inosine and 7-deazaguanine. Complementarily need not be perfect; stable duplexes may contain mismatched base pairs or unmatched bases. Those skilled in the art of nucleic acid technology can determine duplex stability empirically considering a number of variables including, for example, the length of the oligonucleotide, base composition and sequence of the oligonucleotide, ionic strength and incidence of mismatched base pairs.

Stability of a nucleic acid duplex is measured by the melting temperature, or “Tₘ.” The Tₘ of a particular nucleic acid duplex under specified conditions is the temperature at which on average half of the base pairs have disassociated. The equation for calculating the Tₘ of nucleic acids is well known in the art. As indicated by standard references, an estimate of the Tₘ value may be calculated by the equation:

Tₘ=81.5° C.+16.6 log M+0.41(% GC)−0.61(% form)−⁵⁰⁰/L

where M is the molarity of monovalent cations, % GC is the percentage of guanosine and cytosine nucleotides in the DNA, % form is the percentage of formamide in the hybridization solution, and L=length of the hybrid in base pairs. [See, e.g., Guide to Molecular Cloning Techniques, Ed. S. L. Berger and A. R. Kimmel, in Methods in Enzymology Vol. 152, 401, 1987]. Other references include more sophisticated computations which take structural as well as sequence characteristics into account for the calculation of Tₘ.

The present invention contemplates utilizing the nucleic acid sequence of the tutD gene to isolate other genes encoding pyruvate formate lyase homologues by hybridizing portions of the tutD gene to total DNA of various toluene-degrading organisms. Preferably, hybridization is carried out at high stringency (i.e., carried out at or near the Tₘ of the particular duplex). Hybridization can be used to capture other genes. Alternatively, hybridization can be followed by primer extension or PCR.

The present invention also contemplates utilizing the nucleic acid sequence of the tutE gene to isolate other genes encoding pyruvate formate lyase homologues by hybridizing portions of the tutE gene to total DNA of various toluene-degrading organisms. Preferably, hybridization is carried out at high stringency (i.e., carried out at or near the Tₘ of the particular duplex). Hybridization can be used to capture other genes. Alternatively, hybridization can be followed by primer extension or PCR.

Mullis, et al., U.S. Pat. Nos. 4,683,195 and 4,683,202 (both of which are hereby incorporated by reference), describe a methods for increasing the concentration of a segment of target sequence in a mixture of genomic DNA without cloning or purification. This process for amplifying the target sequence consists of introducing a molar excess of two oligonucleotide primers to the DNA mixture containing the desired target sequence. The two primers are complementary to their respective strands of the double-stranded sequence. The mixture is denatured and then allowed to hybridize. Following hybridization, the primers are extended with polymerase so as to form complementary strands. The steps of denaturation, hybridization, and polymerase extension can be repeated as often as needed to obtain are relatively high concentration of a segment of the desired target sequence. The length of the segment of the desired target sequence is determined by the relative positions of the primers with respect to each other, and therefore, this length is a controllable parameter. By virtue of the repeating aspect of the process, the method is referred to by the inventors as the “Polymerase Chain Reaction” (hereinafter PCR). Because the desired segment of the target sequence become the dominant sequences (in terms of concentration) in the mixture, they are said to be “PCR-amplified.”

It is not intended that the present invention be limited to a particular toluene-degrading organism. The present invention contemplates identifying homologues in both known and yet undiscovered toluene-degrading organisms. Known organisms are set forth in the Table 1.

TABLE 1

| Strain Designations | Energy Metabolism |
|---|---|
| T | Denitrifying |
| T1 | Denitrifying |
| Thauera aromatica, K172 | Denitrifying |
| S100 and S2 | Denitrifying |
| Azoarcus tolulyticus, Tol 4 (type strain); | Denitrifying |
| others include Td-1, Td-2, Td-3, Td-15, | |
| Td-17, Td-19, Td-21 | |
| ToN1, mXyN1, and EbN1 | Denitrifying |
| Xanthomonas maltophilia, Sul | Denitrifying |
| Geobacter metallireducens, Gs-15 | Denitrifying, Iron reduction |
| Desulfobacula toluolica, To12 | Denitrifying |
| PRTOL1 | Denitrifying, Sulfate reducer |

The term “probe” as used herein refers to a labeled oligonucleotide which forms a duplex structure with a sequence in another nucleic acid, due to complementarily of at least one sequence in the probe with a sequence in the other nucleic acid.

The term “label” as used herein refers to any atom or molecule which can be used to provide a detectable (preferably quantifiable) signal, and which can be attached to a nucleic acid or protein. Labels may provide signals detectable by fluorescence, radioactivity, colorimetry, gravimetry, X-ray diffraction or absorption, magnetism, enzymatic activity, and the like.

The terms “nucleic acid substrate” and nucleic acid template” are used herein interchangeably and refer to a nucleic acid molecule which may comprise single- or double-stranded DNA or RNA.

The term “substantially single-stranded” when used in reference to a nucleic acid substrate means that the substrate molecule exists primarily as a single strand of nucleic acid in contrast to a double-stranded substrate which exists as two strands of nucleic acid which are held together by inter-strand base pairing interactions.

The term “sequence variation” as used herein refers to differences in nucleic acid sequence between two nucleic acid templates. For example, a wild-type structural gene and a mutant form of this wild-type structural gene may vary in sequence by the presence of single base substitutions and/or deletions or insertions of one or more nucleotides. These two forms of the structural gene are said to vary in sequence from one another. A second mutant form of the structural gene may exist. This second mutant form is said to vary in sequence from both the wild-type gene and the first mutant form of the gene. It is noted, however, that the invention does not require that a comparison be made between one or more forms of a gene to detect sequence variations.

The term “Kₘ” as used herein refers to the Michaelis-Menten constant for an enzyme and is defined as the concentration of the specific substrate at which a given enzyme yields one-half its maximum velocity in an enzyme catalyzed reaction.

The term “nucleotide analog” as used herein refers to modified or non-naturally occurring nucleotides such as 7-deaza purines (i.e., 7-deaza-dATP and 7-deaza-dGTP). Nucleotide analogs include base analogs and comprise modified forms of deoxyribonucleotides as well as ribonucleotides. As used herein the term “nucleotide analog” when used in reference to substrates present in a PCR mixture refers to the use of nucleotides other than dATP, dGTP, dCTP and dTTP; thus, the use of dUTP (a naturally occurring dNTP) in a PCR would comprise the use of a nucleotide analog in the PCR. A PCR product generated using dump, 7-deaza-dATP, 7-deaza-dGTP or any other nucleotide analog in the reaction mixture is said to contain nucleotide analogs.

“Oligonucleotide primers matching or complementary to a gene sequence” refers to oligonucleotide primers capable of facilitating the template-dependent synthesis of single or double-stranded nucleic acids. Oligonucleotide primers matching or complementary to a gene sequence may be used in PCRs, RT-PCRs and the like.

A “consensus gene sequence” refers to a gene sequence which is derived by comparison of two or more gene sequences and which describes the nucleotides most often present in a given segment of the genes; the consensus sequence is the canonical sequence. A “motif” refers to the corresponding amino acid sequence defining a region of identity following a comparison of two or more amino acid sequences.

The term “polymorphic locus” is a locus present in a population which shows variation between members of the population (i.e., the most common allele has a frequency of less than 0.95). In contrast, a “monomorphic locus” is a genetic locus at little or no variations seen between members of the population (generally taken to be a locus at which the most common allele exceeds a frequency of 0.95 in the gene pool of the population).

The term “microorganism” as used herein means an organism too small to be observed with the unaided eye and includes, but is not limited to bacteria, viruses, protozoans, fungi, and ciliates.

The term “microbial gene sequences” refers to gene sequences derived from a microorganism.

The term “bacteria” refers to any bacterial species including abacterial and archaebacterial species.

The term “recombinant DNA molecule” as used herein refers to a DNA molecule which is comprised of segments of DNA joined together by means of molecular biological techniques.

The terms “in operable combination” or “operably linked” as used herein refers to the linkage of nucleic acid sequences in such a manner that a nucleic acid molecule capable of directing the synthesis of a desired protein molecule is produced. When a promoter sequence is operably linked to sequences encoding a protein, the promoter directs the expression of mRNA which can be translated to produce a functional form of the encoded protein. The term also refers to the linkage of amino acid sequences in such a manner that a functional protein is produced.

The term “an oligonucleotide having a nucleotide sequence encoding a gene” means a DNA sequence comprising the coding region of a gene or, in other words, the DNA sequence which encodes a gene product. The coding region may be present in either a cDNA or genomic DNA form. Suitable control elements such as enhancers/promoters, operons, etc. may be placed in close proximity to the coding region of the gene if needed to permit proper initiation of transcription and/or correct processing of the primary RNA transcript. Alternatively, the coding region utilized in the expression vectors of the present invention may contain endogenous enhancers/promoters, intervening sequences, operons, etc. or a combination of both endogenous and exogenous control elements.

The term “recombinant oligonucleotide” refers to an oligonucleotide created using molecular biological manipulations, including but not limited to, the ligation of two or more oligonucleotide sequences generated by restriction enzyme digestion of a polynucleotide sequence, the synthesis of oligonucleotides (e.g., the synthesis of primers or oligonucleotides) and the like.

The term “recombinant oligonucleotide having a sequence encoding a protein operably linked to a heterologous promoter” or grammatical equivalents indicates that the coding region encoding the protein (e.g., an enzyme) has been joined to a promoter which is not the promoter naturally associated with the coding region in the genome of an organism (i.e., it is linked to an exogenous promoter). The promoter which is naturally associated or linked to a coding region in the genome is referred to as the “endogenous promoter” for that coding region.

The term “transcription unit” as used herein refers to the segment of DNA between the sites of initiation and termination of transcription and the regulatory elements necessary for the efficient initiation and termination. For example, a segment of DNA comprising an enhancer/promoter, a coding region or regions (e.g., the tutE, tutD, tutG and tutH genes are encoded by the same gene and comprises coding regions), and a termination sequence comprises a transcription unit.

The term “regulatory element” as used herein refers to a genetic element which controls some aspect of the expression of nucleic acid sequences. For example, a promoter is a regulatory element which facilitates the initiation of transcription of an operably linked coding region.

The term “expression vector” or “vector” as used herein refers to a recombinant DNA molecule containing a desired coding sequence and appropriate nucleic acid sequences necessary for the expression of the operably linked coding sequence in a particular host organism. Nucleic acid sequences necessary for expression in prokaryotes include a promoter, optionally an operator sequence, a ribosome binding site and possibly other sequences. Eukaryotic cells are known to utilize promoters, enhancers, and termination and polyadenylation signals.

Transcriptional control signals in eucaryotes comprise “promoter” and “enhancer” elements. Promoters and enhancers consist of short arrays of DNA sequences that interact specifically with cellular proteins involved in transcription (Maniatis et al., Science 236:1237, 1987). Promoter and enhancer elements have been isolated from a variety of eukaryotic sources including genes in yeast, insect and mammalian cells and viruses (analogous control elements, i.e., promoters, are also found in prokaryotes). The selection of a particular promoter and enhancer depends on what cell type is to be used to express the protein of interest. Some eukaryotic promoters and enhancers have a broad host range while others are functional in a limited subset of cell types (for review see Voss, et al., Trends Biochem. Sci. 11:287, 1986; Maniatis, et al., supra, 1987). For example, the SV40 early gene enhancer is very active in a wide variety of cell types from many mammalian species and has been widely used for the expression of proteins in mammalian cells (Dijkema, et al., EMBO J. 4:761, 1985). Two other examples of promoter/enhancer elements active in a broad range of mammalian cell types are those from the human elongation factor 1α gene (Uetsuki et al., J. Biol. Chem., 264:5791, 1989; Kim, et al., Gene 91:217, 1990; Mizushima and Nagata, Nuc. Acids. Res., 18:5322, 1990) and the long terminal repeats of the Rous sarcoma virus (Gorman et al., Proc. Natl. Acad. Sci. USA 79:6777, 1982) and the human cytomegalovirus (Boshart et al., Cell 41:521, 1985).

The term “promoter/enhancer” denotes a segment of DNA which contains sequences capable of providing both promoter and enhancer functions (for example, the long terminal repeats of retroviruses contain both promoter and enhancer functions). The enhancer/promoter may be “endogenous” or “exogenous” or “heterologous.” An endogenous enhancer/promoter is one which is naturally linked with a given gene in the genome. An exogenous (heterologous) enhancer/promoter is one which is placed in juxtaposition to a gene by means of genetic manipulation (i.e., molecular biological techniques).

As used herein “tutF” denotes a segment of DNA (presented in FIG. 24) substantially similar to the open reading frame designated as “open reading frame 2” which consists of a 60 amino acid sequence which would code for a protein with a calculated molecular mass of 6,900 Da and a predicted pI of 5.2. The translational start begins at the NcoI restriction site and hence no upstream transcriptional regulatory sites or ribosome binding sites for this open reading frame are included on this fragment.

As used herein “tutG” denotes a segment of DNA (presented in FIG. 26) substantially similar to the open reading frame designated as “open reading frame 4” identified in the SacII/EcoRI fragment consisting essentially of an 81 amino acids sequence with a calculated molecular mass of 9,300 Da and a predicted pI of 7.8.

As used herein “biodegradation,” “biodegraded” and “degraded” shall mean broken down into constituent components by biochemical means such as, for example, by the action of enzymes. It is not necessary that the breakdown be complete. It is contemplated that the breakdown may be from 1% to 100%. In a preferred embodiment, the breakdown is from 50% to 99%.

The term “mixture” includes the situation where one or more of the components interact to form an association or complex.

### DESCRIPTION OF THE DRAWINGS

FIG. 1 shows the restriction map of a cosmid clone capable of restoring the ability to grow on toluene in toluene-nondegrading mutants.

FIG. 2 shows the nucleic acid sequence (SEQ ID NO: 8) of the tutB gene and tutC gene (submitted to the GenBank data base and assigned accession number U57900) and the amino acid sequences (SEQ ID NOS: 55 and 56) encoded thereby.

FIG. 3 shows the amino acid sequence of the tutB gene product (SEQ ID NO: 9) and gene products from Bradyrhizobium japonicum Bra ja NodW (SEQ ID NO: 10), Bradyrhizobium japonicum Bra ja FixJ (SEQ ID NO: 11), Azorhizobium caulinodans Azo ca FixJ (SEQ ID NO: 12), Rizobium meliloti Rhi me FixJ (SEQ ID NO: 13) and Rhodobacter capsulatus Rho ca DctR (SEQ ID NO: 14).

FIG. 4 shows the amino acid sequence of the tutC gene product (SEQ ID NO: 15) and gene products from Bradyrhizobium japonicum Bra ja NodV (SEQ ID NO: 16), Bradyrhizobium japonicum Bra ja FixL (SEQ ID NO: 17), Azorhizobium caulinodans Azo ca FixL (SEQ ID NO: 18), Rizobium meliloti Rhi me FixL (SEQ ID NO: 19) and Rhodobacter capsulatus Rho ca DctS (SEQ ID NO: 20).

FIG. 5 shows the nucleic acid sequence of the tutD gene (SEQ ID NO: 21).

FIG. 6 shows part of the nucleic acid sequence of the tutE gene (SEQ ID NO:22).

FIG. 7 shows the amino acid sequence of the tutD gene product (SEQ ID NO:23) and gene products from E. coli PfLD.coli (SEQ ID NO: 24 and Clostridium pasteurianum Pfl.Clostrid (SEQ ID NO: 25).

FIG. 8 shows the restriction map for pRK415.

FIG. 9 shows the polylinker (SEQ ID NO: 26) contained in pRK415 and the encoded amino acid sequence (SEQ ID NO: 27).

FIG. 10 shows the restriction map of a cosmid clone containing the tutD and tutE genes.

FIG. 11 shows an expanded amino acid sequence of the tutD gene product (SEQ ID NO:28) and gene products from E. coli f810.coli (SEQ ID NO: 29) E. coli PflD.coli (SEQ ID NO: 30) and E. coli PflB.coli (SEQ ID NO: 31).

FIG. 12 shows an expanded nucleic acid sequence encompassing both the tutD and tutE gene (SEQ ID NO:32).

FIG. 13 shows the amino acid sequence for the tutE gene product (SEQ ID NO:33) and gene products from E. coli f308.coli (SEQ ID NO: 34) E. coli PflC.coli (SEQ ID NO: 35) and E. coli pflA.coli (SEQ ID NO: 36).

FIG. 14 shows Northern gel results indicating that both tutD and tutE are regulated by toluene.

FIG. 15 shows Northern analysis of total RNA isolated from cells grown under denitrifying conditions with either pyruvate (P) or toluene (T) as the carbon source and visualized with probes derived from tutD, tutE, tutG, or tutF. Samples of digoxigenin-labeled RNA were included to serve as size markers (M).

FIG. 16 shows Northern analysis of total RNA isolated from cells grown under denitrifying conditions with toluene (T) as the carbon source. Samples of digoxigenin-labeled RNA were included to serve as size markers (M).

FIG. 17 presents primer extension analysis to map the transcriptional start sites of the tutE and tutF genes. End-labeled primer E-PE3 was used to identify the tutE start of transcription and end-labeled primer F-PE1 was used to identify the tutF start of transcription. The same primers were used to generate the sequencing ladder by the dideoxy method (lanes marked G A T C). The sequence (SEQ ID NOS: 57 and 58) encompassing the transcriptional start (marked with an asterisk) is enlarged.

FIG. 18 shows the nucleic acid sequence of the tutH gene (SEQ ID NO: 43).

FIG. 19 shows the amino acid sequence of the tutH gene product (SEQ ID NO: 44).

FIG. 20 presents a comparison of the predicted amino acid sequence of the TutH protein (SEQ ID NO: 44) to the predicted sequences of the N or Q proteins from P. halodenitrificans NorQ.Phalo (SEQ ID NO: 37), P. denitrificans NorQ.Pdei (SEQ ID NO: 38), and R. sphaeroides NorQ.Rsph (SEQ ID NO: 40), and the NirQ protein from P. stutzeri NirQ.Psst (SEQ ID NO: 39). The region defined as a putative ATP/GTP binding domain is shown with a line above it (position 47 to 54 of TutH). Amino acids identical to the tutH translation are shaded and conserved amino acids are boxed. Dashes indicate gaps introduced by the computer program to maximize the alignment score.

FIG. 21 shows the nucleic acid sequence of the tutI gene (SEQ ID NO: 45).

FIG. 22 shows the amino acid sequence of the tutI gene product (SEQ ID NO: 46).

FIG. 23 presents a restriction map of the region of cosmid clone 13-6-4 containing the tutEtutFDGHI genes. The five identified open reading frames are indicated with arrows. Abbreviations are: B=BamHI, C=ClaI, N=NcoI, P=PstI, R=EcoRI, Sa=Sac II, Sc=SacI. Sites blocked by methylation are omitted from the figure.

FIG. 24 shows the nucleic acid sequence of the tutF gene (SEQ ID NO: 47).

FIG. 25 shows the amino acid sequence of the tutF gene product (SEQ ID NO: 48).

FIG. 26 shows the nucleic acid sequence of the tutG gene (SEQ ID NO: 49).

FIG. 27 shows the amino acid sequence of the tutG gene product (SEQ ID NO: 50).

FIG. 28 shows confirmation of complementation by PCR. A, PCR was carried out on tutD deletion strains. B, PCR was carried out on tutG deletion strains.

### DESCRIPTION OF THE INVENTION

This invention relates to biological treatment of organic compounds, and particularly to the degradation of toluene. Toluene, along with benzene and xylenes, is a common contaminant of ground and surface water. Toluene has been classified by the U.S. Environmental Protection Agency as a priority pollutant due to its ability to depress the central nervous system and to enhance the effect of known carcinogens.

Anaerobic toluene degrading bacterial strains have been isolated. Most importantly, mutants have been obtained. These mutants fall into two classes, one class that fails to metabolize toluene, and another class that metabolizes toluene but fails to use it as a growth substrate.

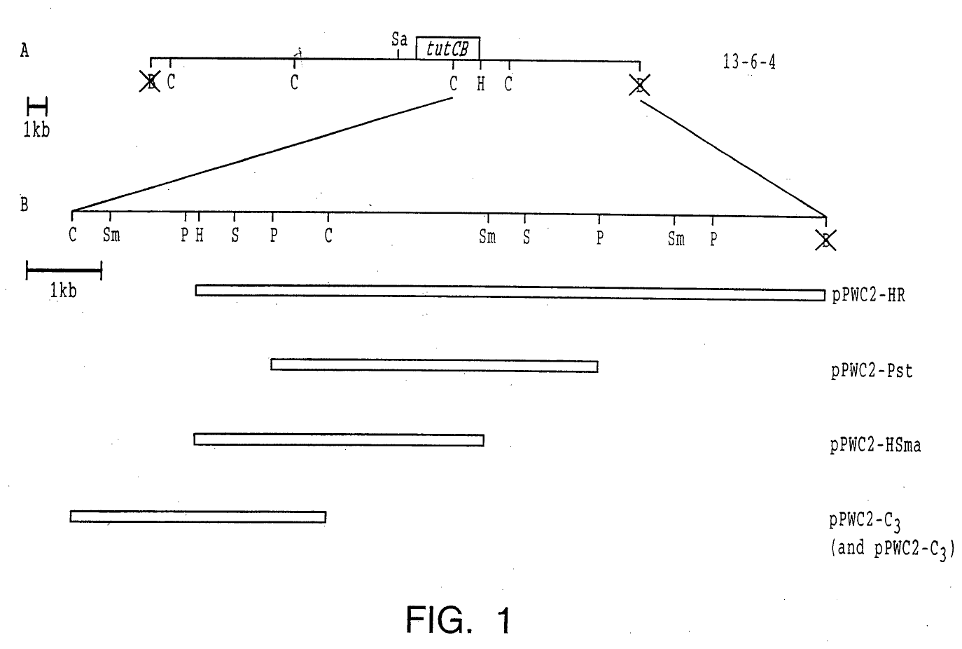

A cosmid library was generated from total DNA isolated from the toluene-degrading bacterium strain T1. Triparental matings were used to identify a clone that restored the ability of mutants to grow on toluene and utilize it as a carbon source. This clone has now been characterized (FIG. 1 shows the restriction map). The DNA of this clone has now been sequenced and the genes identified are believed to be both regulatory and structural.

Regulatory Genes

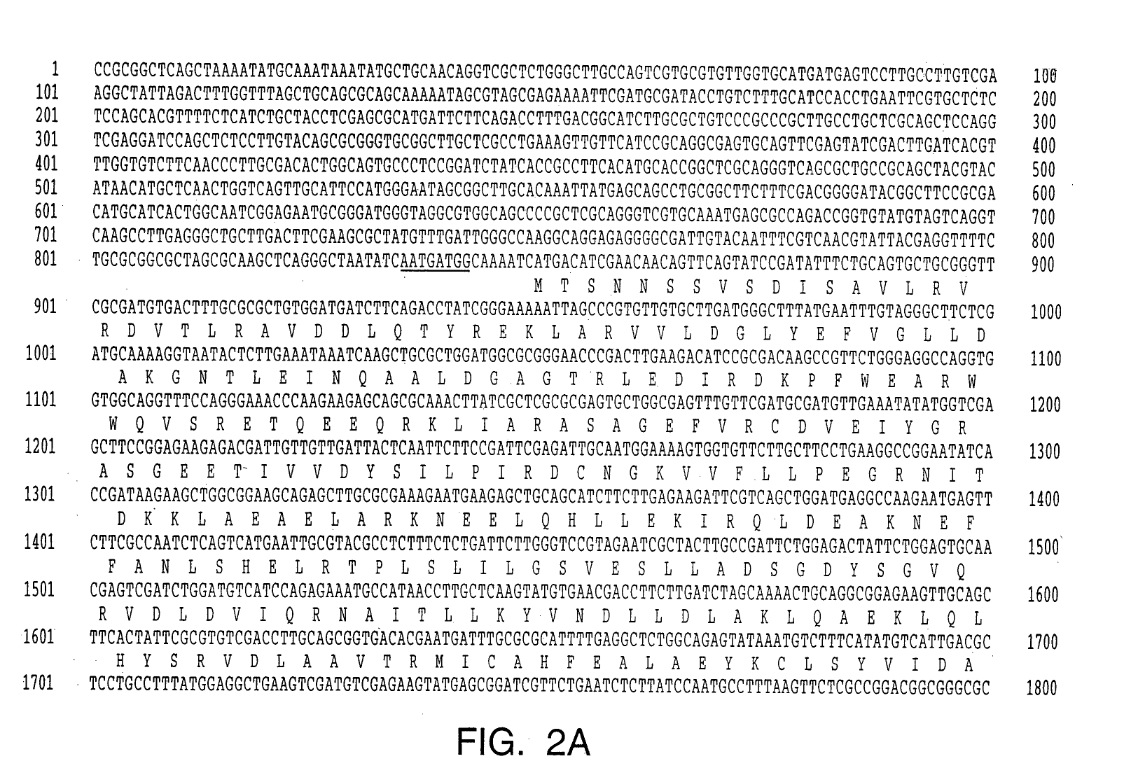

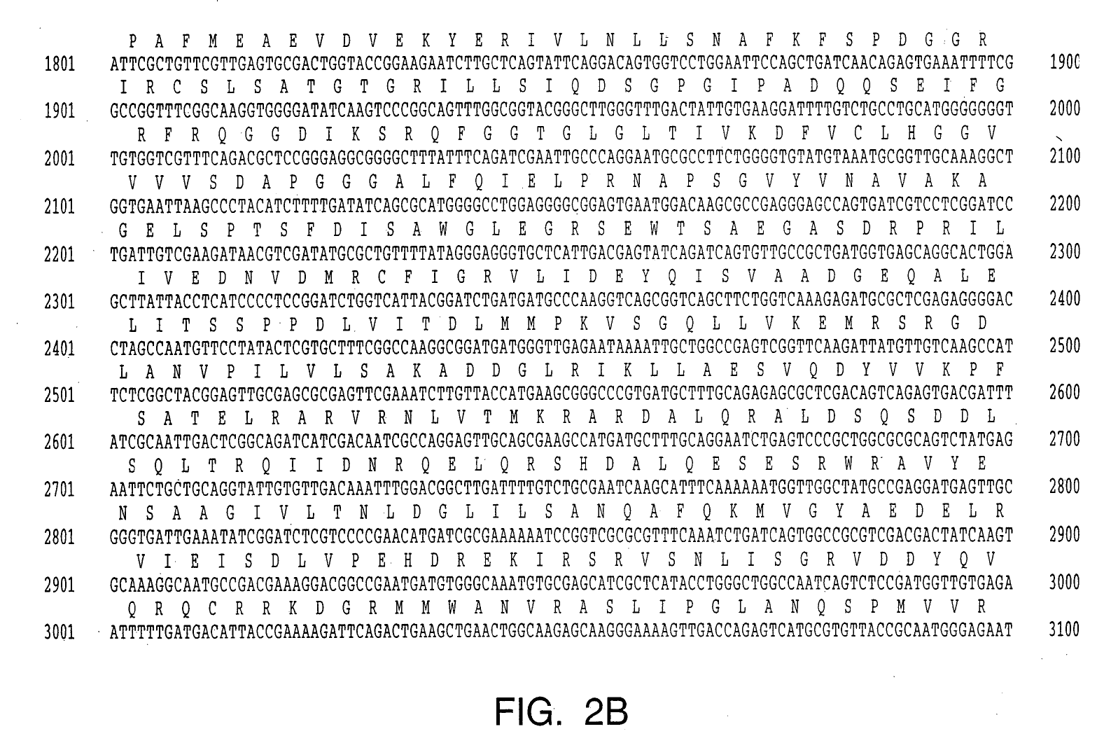

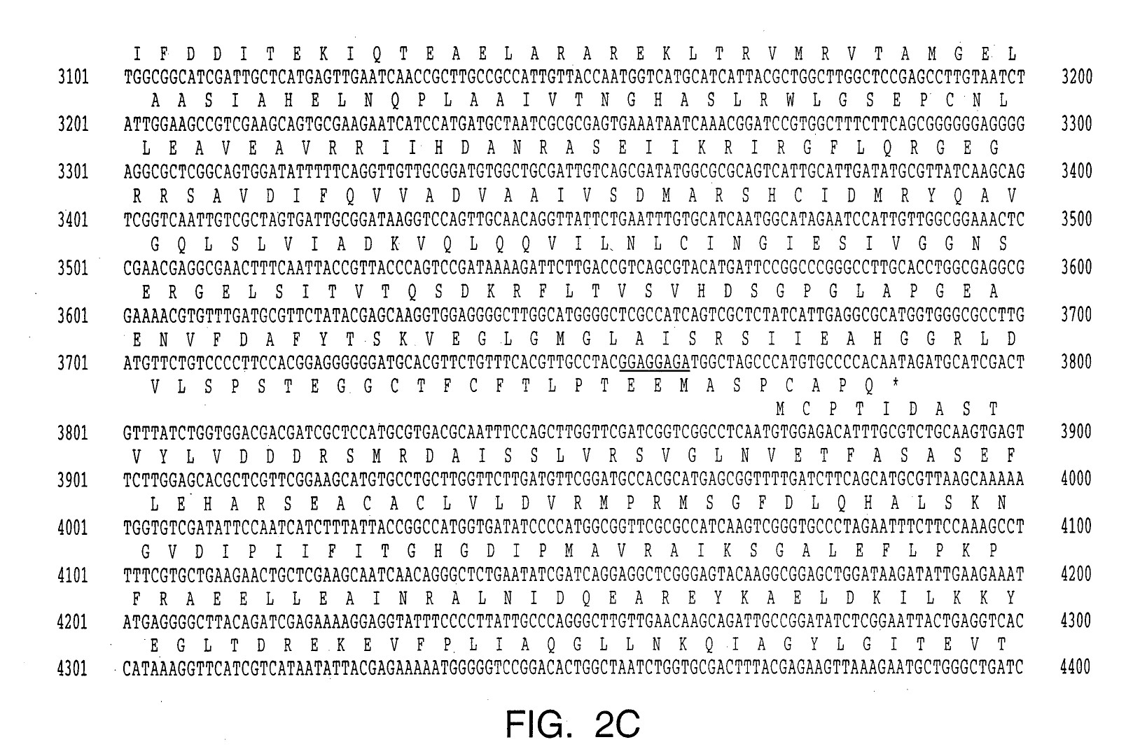

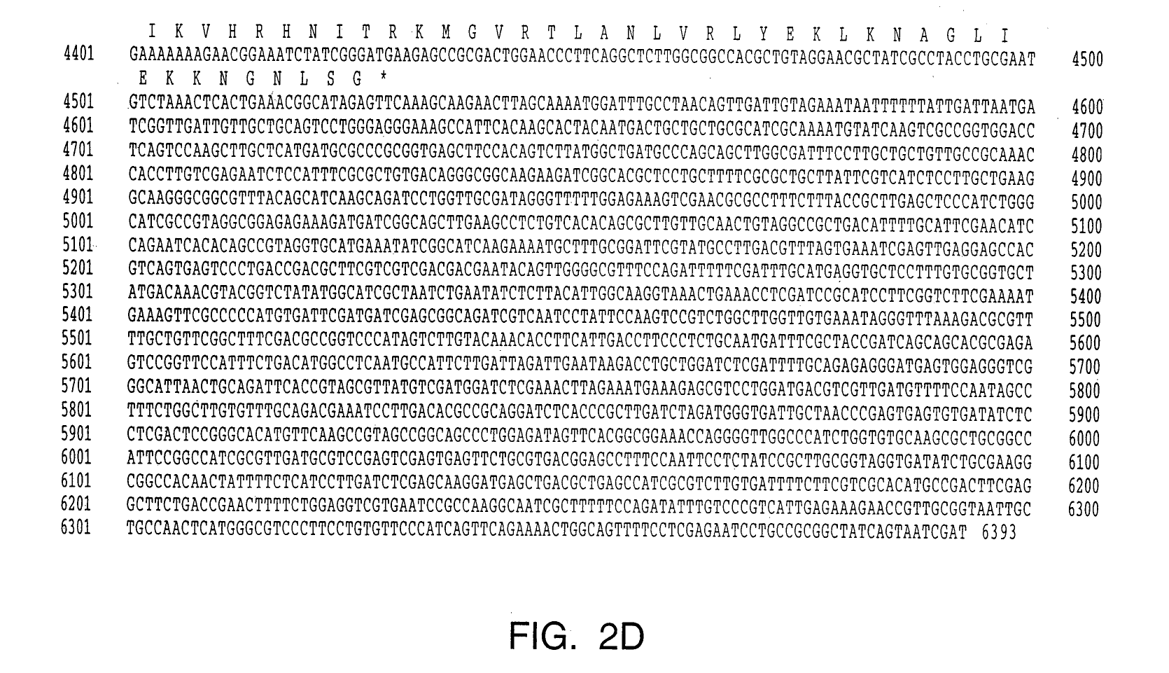

The sequence of the cloned SacII-ClaI-ClaI fragment (approximately 6.4 kb containing the tutB gene and the tutC gene), that fully complements the tutB-16 mutation and carries all the information necessary to restore the ability to utilize toluene, is shown in FIG. 2 (the restriction sites for SacI and ClaI are indicated in FIG. 1 as “Sa” and C″ respectively, although not all SacII sites are shown; BamHI, HindIII, PstI, SmaI and SalI sites are indicated as “B”, “H”, “P”, “Sm” and “S”, respectively). The subclone complements the mutation when inserted into the pRK415 vector (described below) in either orientation. This strongly suggests that the subclone provides all the cis acting factors necessary for gene expression and the vector does not provide any elements essential for expression of the insert.

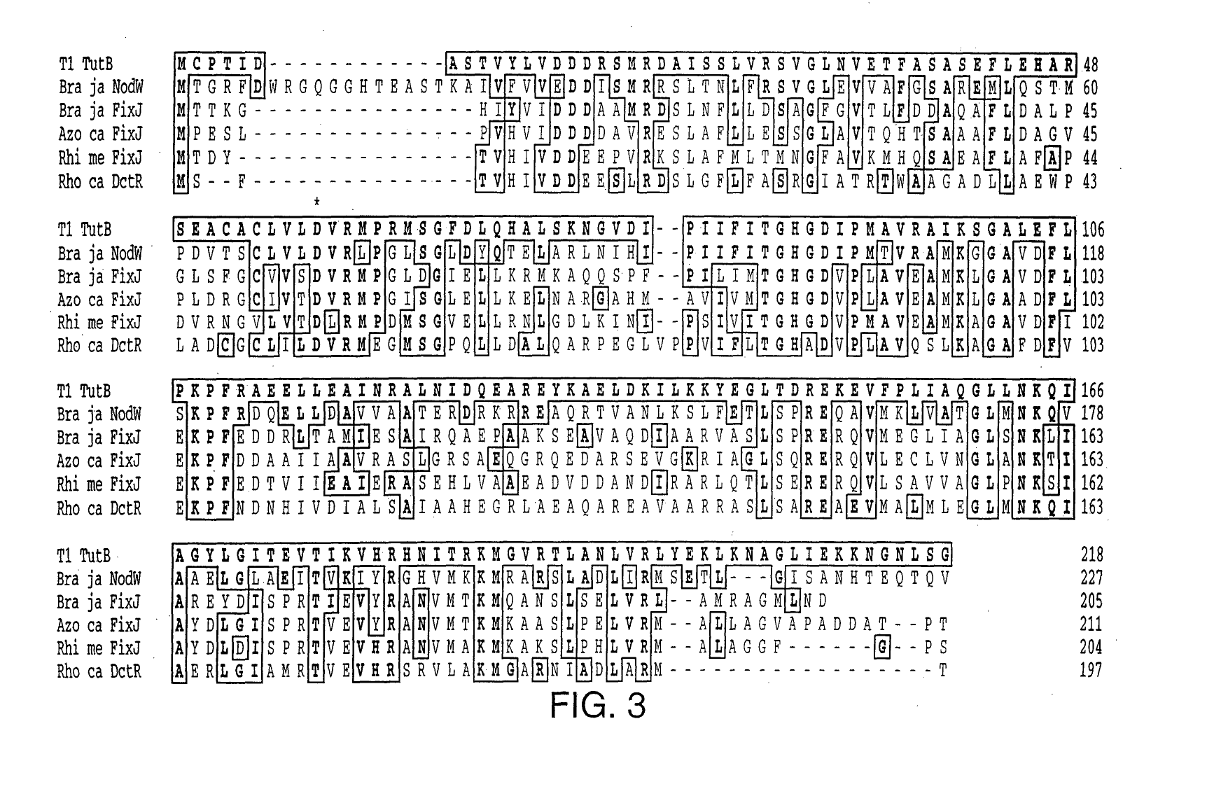

DNA sequence analysis of the fragment has identified an open reading frame that has homology to the nodW gene product of B. japonicum and other proteins presented in FIG. 3. All of these proteins have been identified as DNA binding regulatory proteins and members of the two component family of signal transduction proteins. All have phosphorylation sites at a conserved aspartic acid residue. The tutB gene product also has an aspartic acid residue in the analogous location, at amino acid 58.

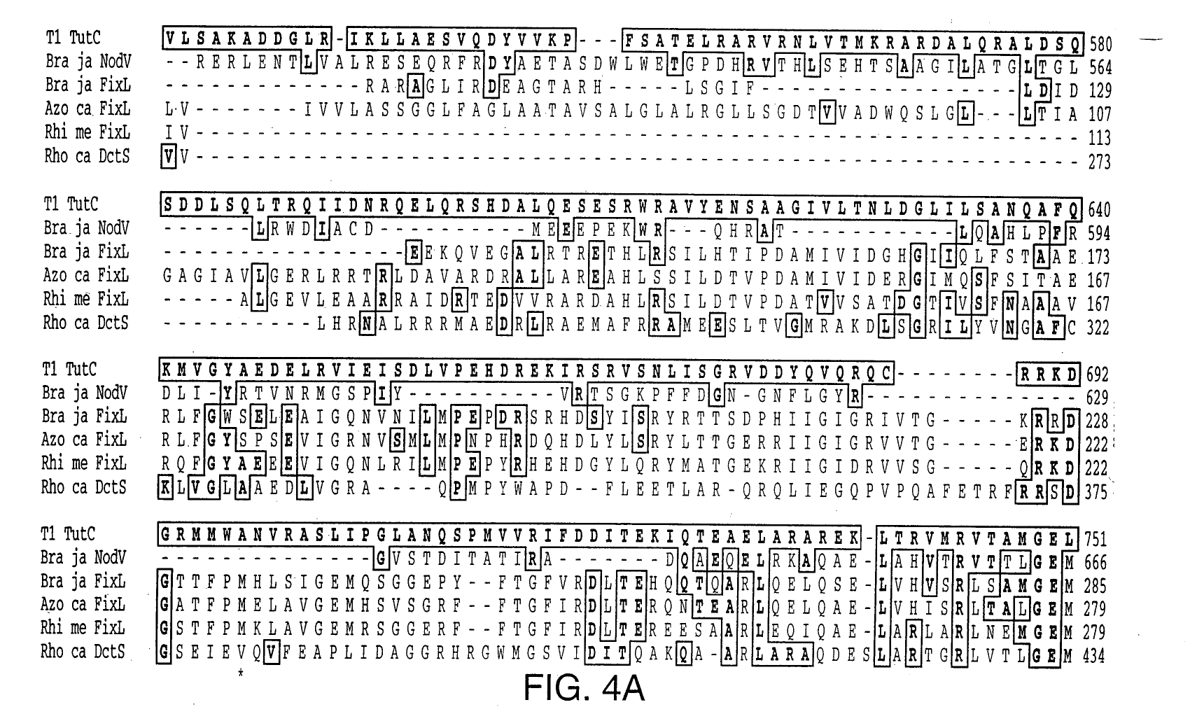

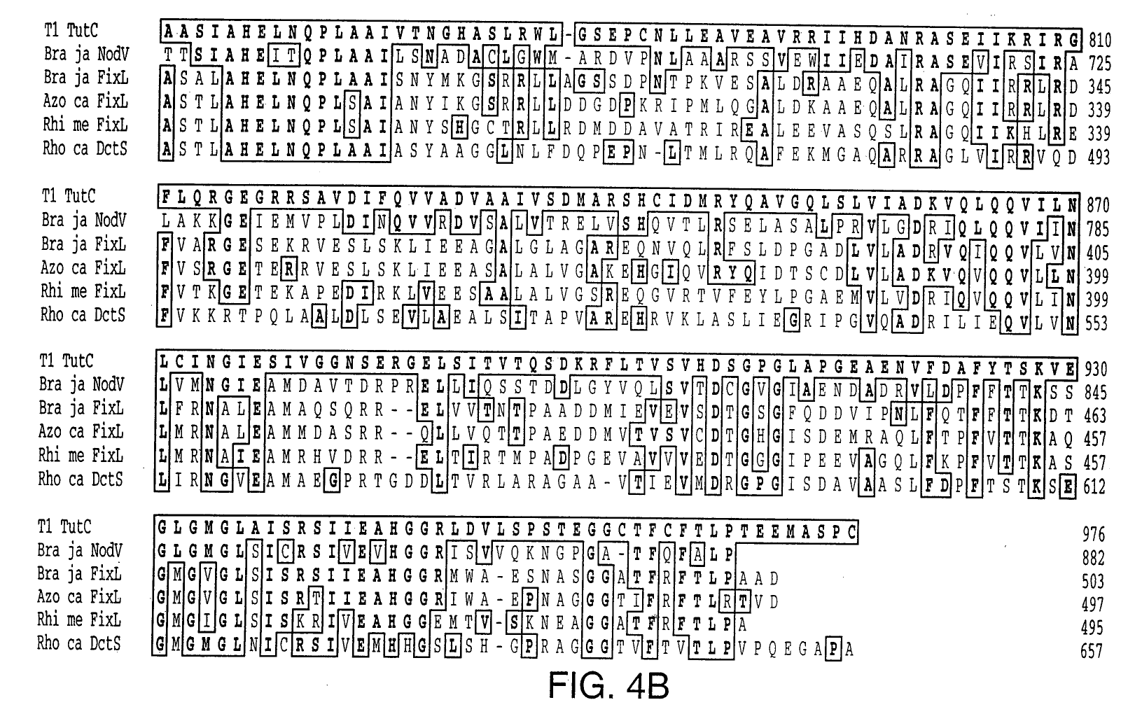

Additional DNA sequence analysis has identified a second open reading frame upstream of the tutB gene. This open reading frame, named tutC, has homology to the nodV gene product of B. japonicum and other proteins presented in FIG. 4. These gene products are proposed to serve as the sensor protein in the two component regulatory system). In their role as sensor proteins, they must autophosphorylate and then transfer the phosphate to the DNA binding protein. The site of autophosphorylation is a histidine residue that is conserved in all the systems. The tutC gene product has a histidine residue in the analogous location at amino acid 757. As can also be seen in FIG. 4, the homology of the sensor proteins extends only about 400 amino acids. This region is proposed to be the transmitter domain, the part of the protein that sends the regulatory signal to the DNA binding protein. The remainder of the protein presumably serves to detect the signal from the environment and would not be expected to be conserved across the different systems.

The proteins that have the greatest similarity to the tutCB gene products appear to regulate a diverse set of genes. Both FixL/FixJ from R. meliloti and from A. caulinodans regulate genes involved in nitrogen fixation, while FixL/FixJ from B. japonicum are proposed to regulate anaerobic respiratory genes. The nodVW gene products of B. japonicum play a role in the nodulation process, while the dctSR gene products of R. capsulatus serve as regulators of C4-dicarboxylate transport. It is apparent that these genes function in a similar manner but the classes of genes they regulate have little in common.

Structural Genes

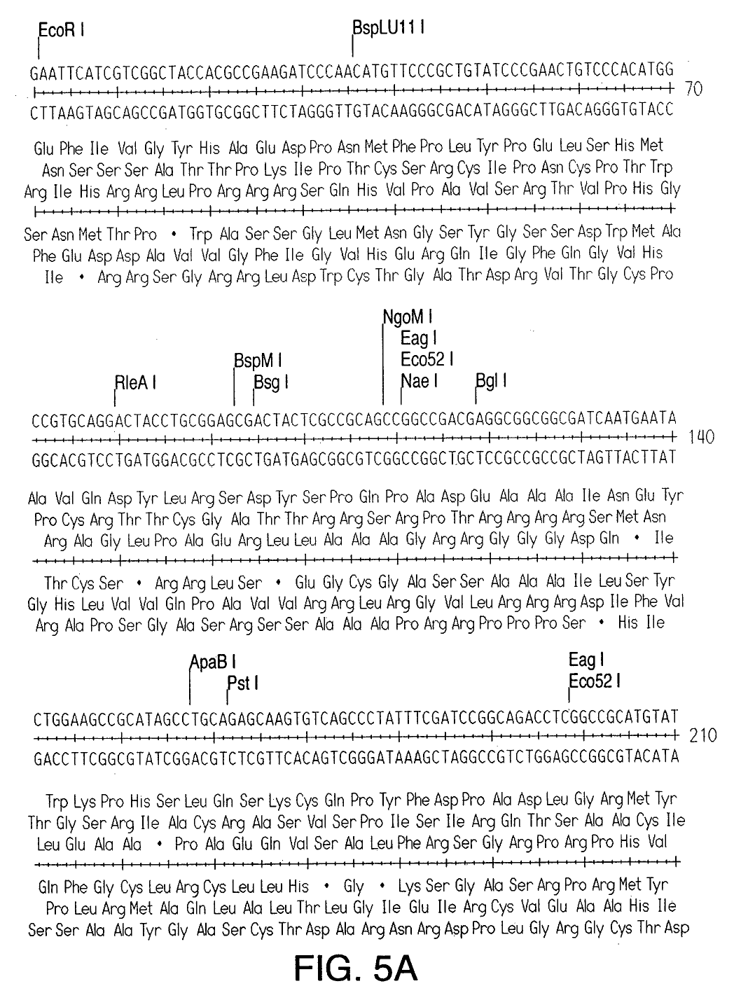

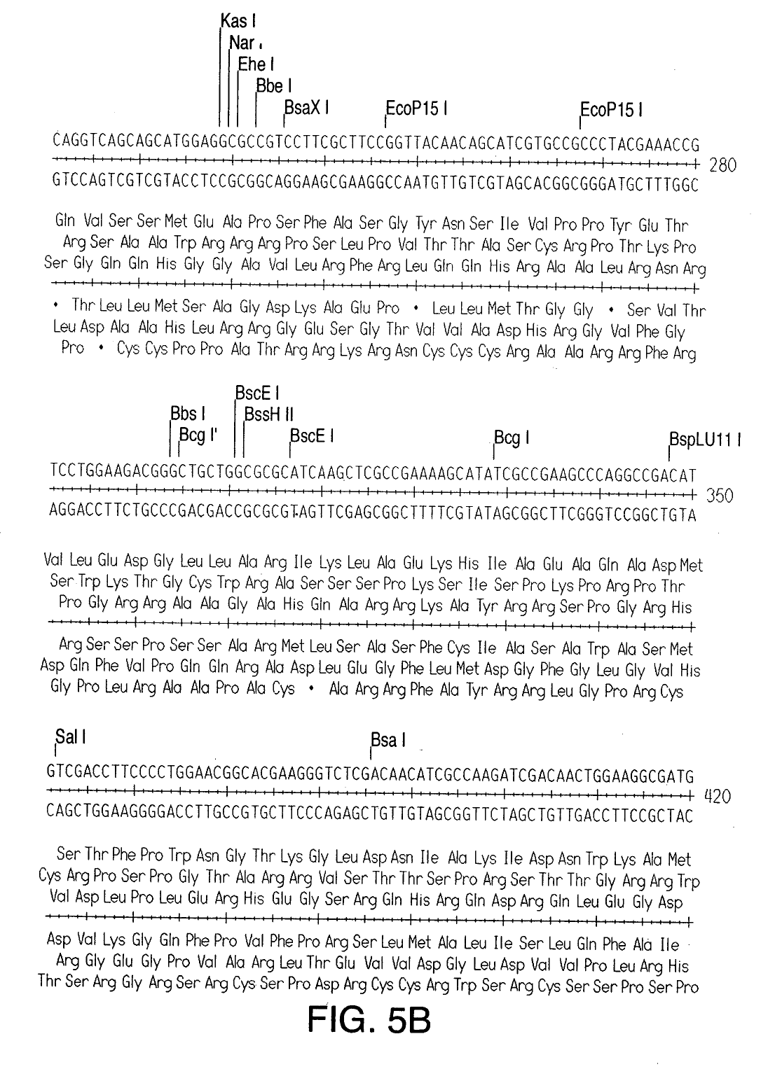

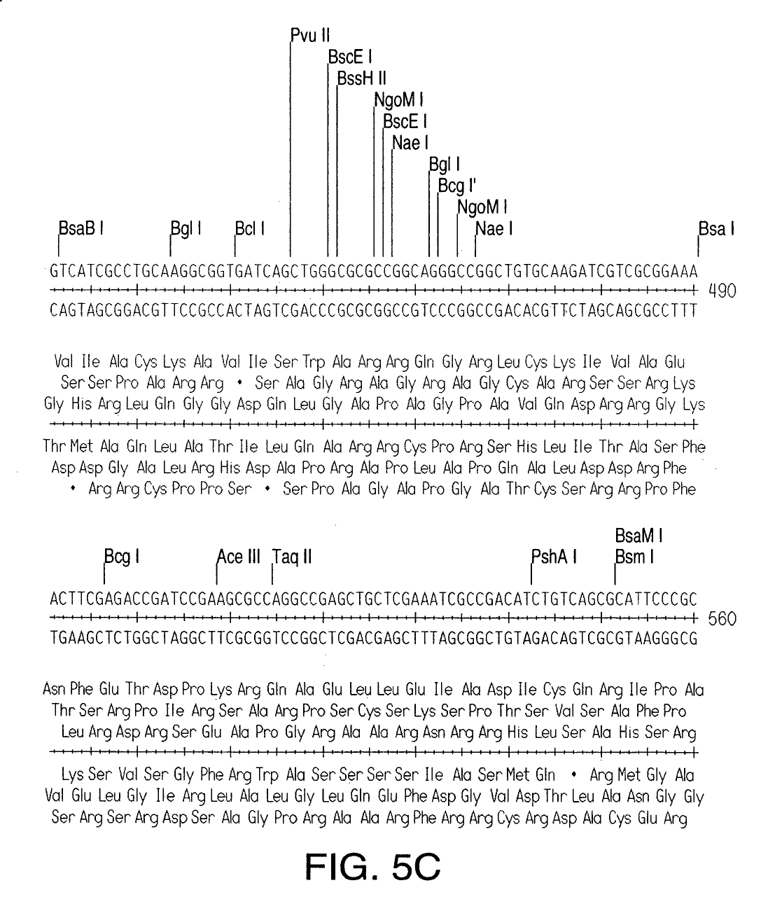

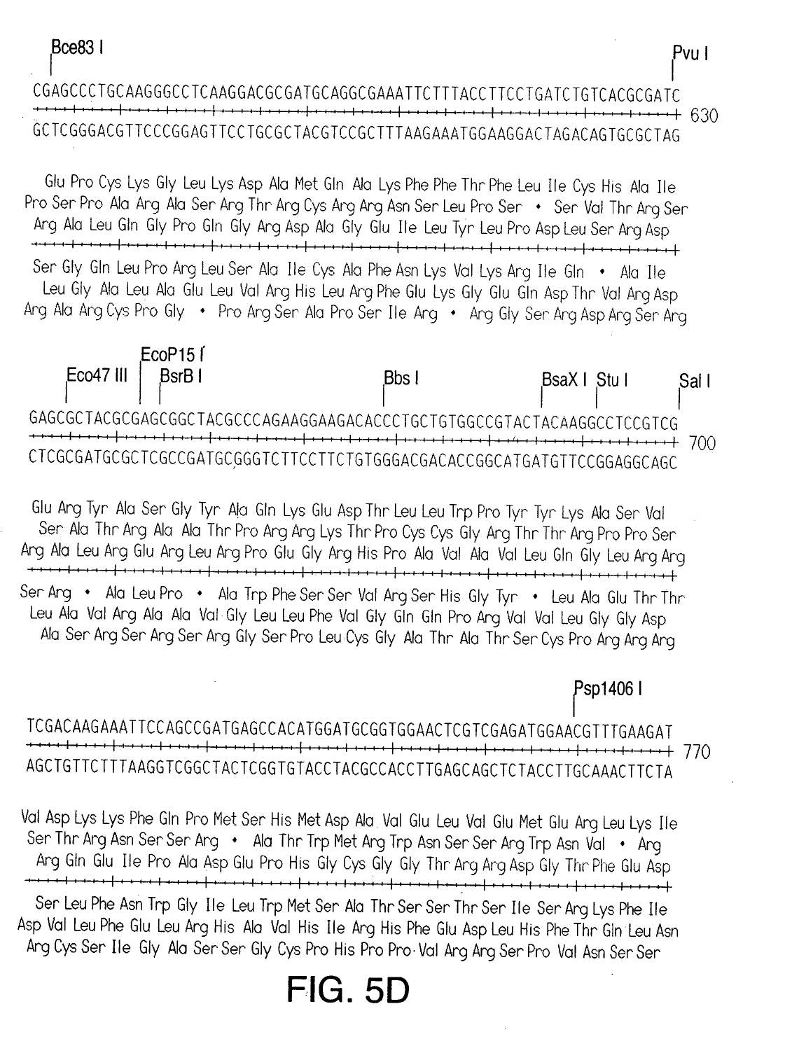

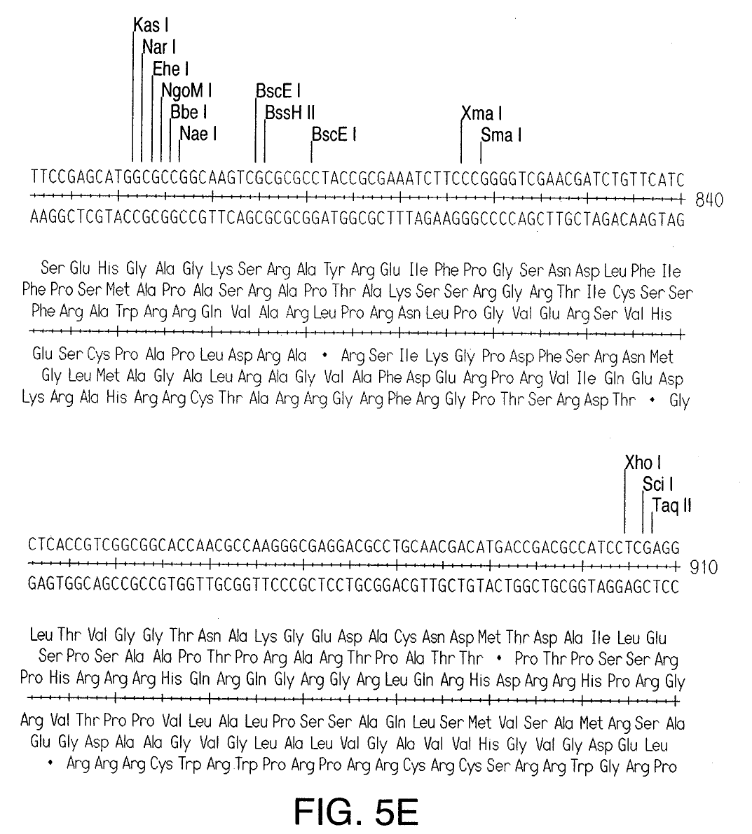

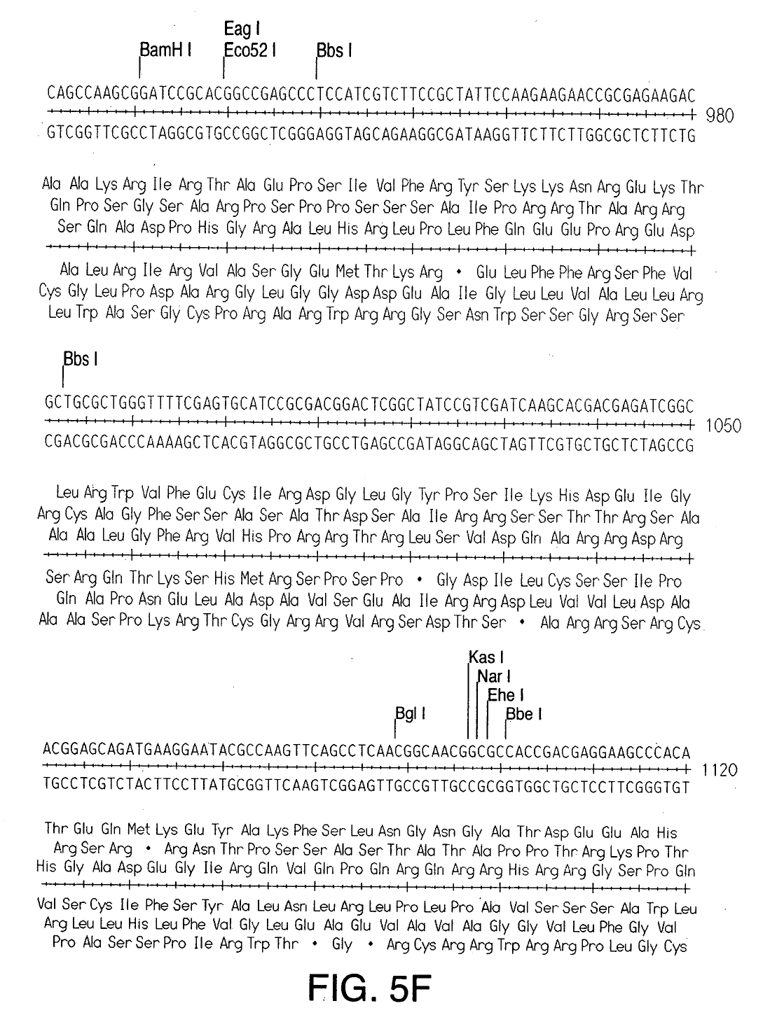

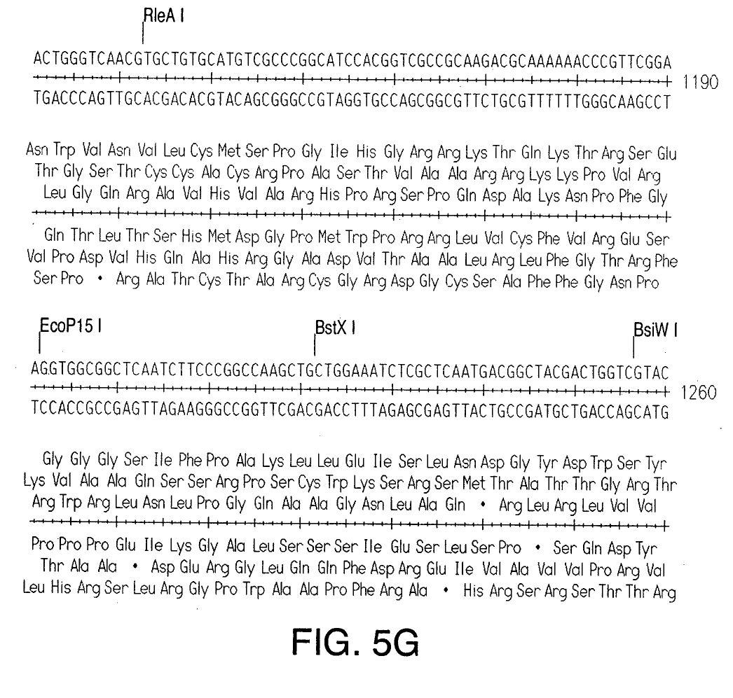

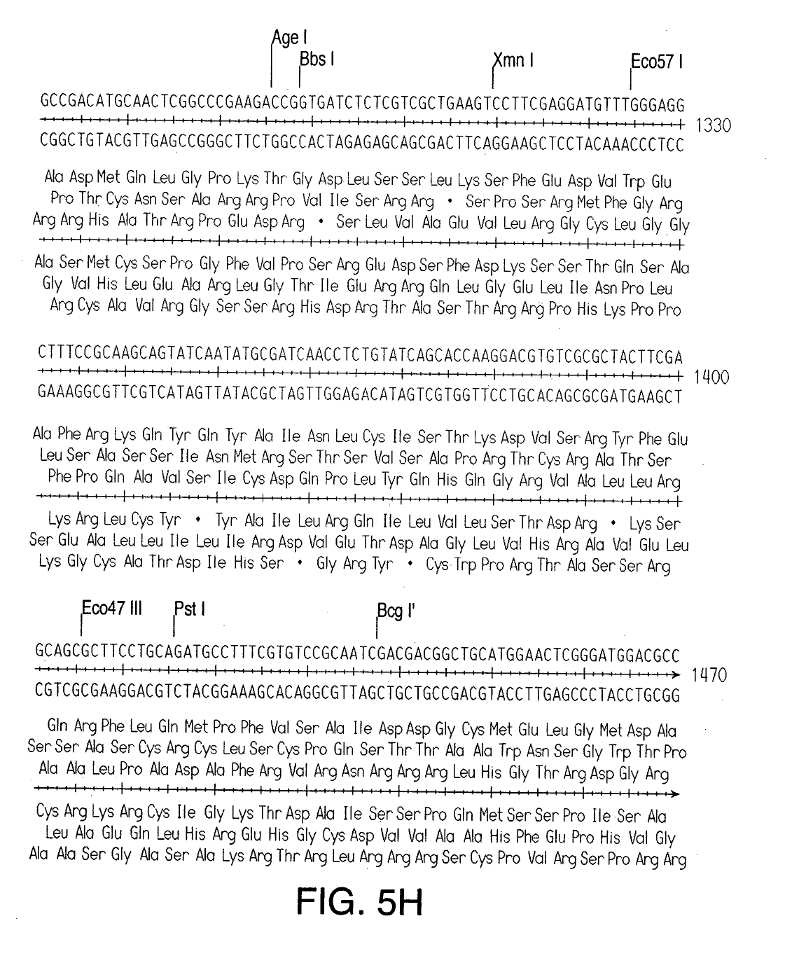

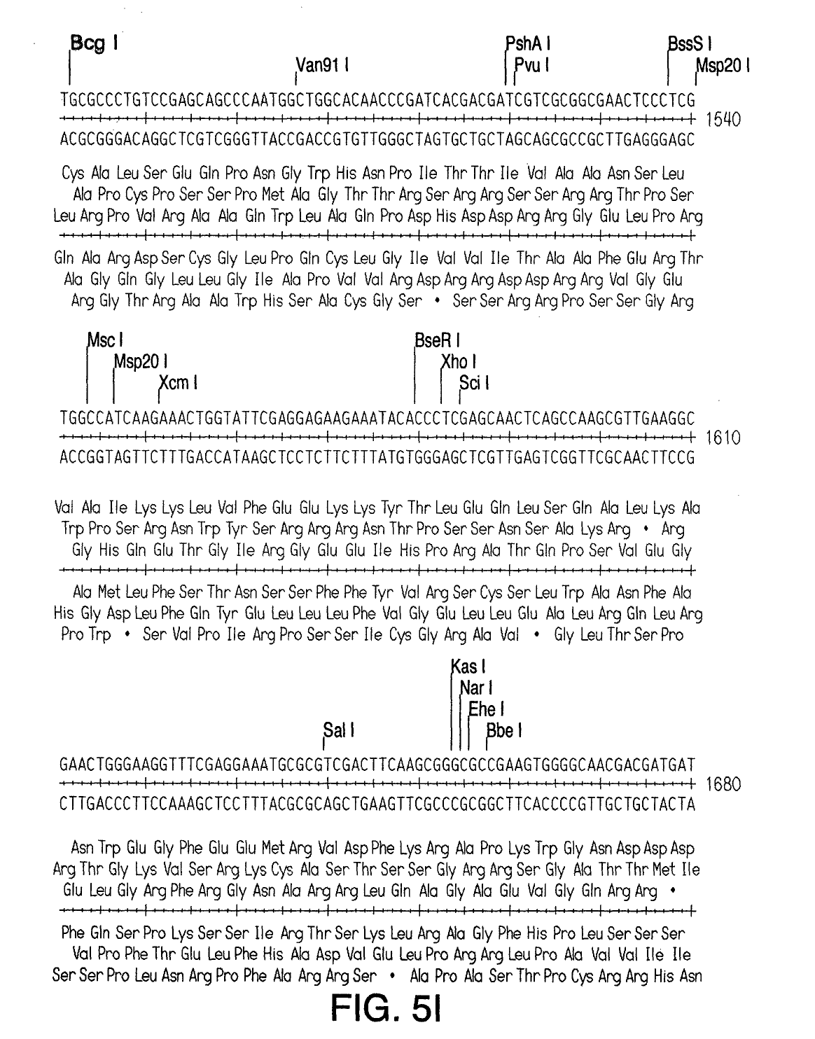

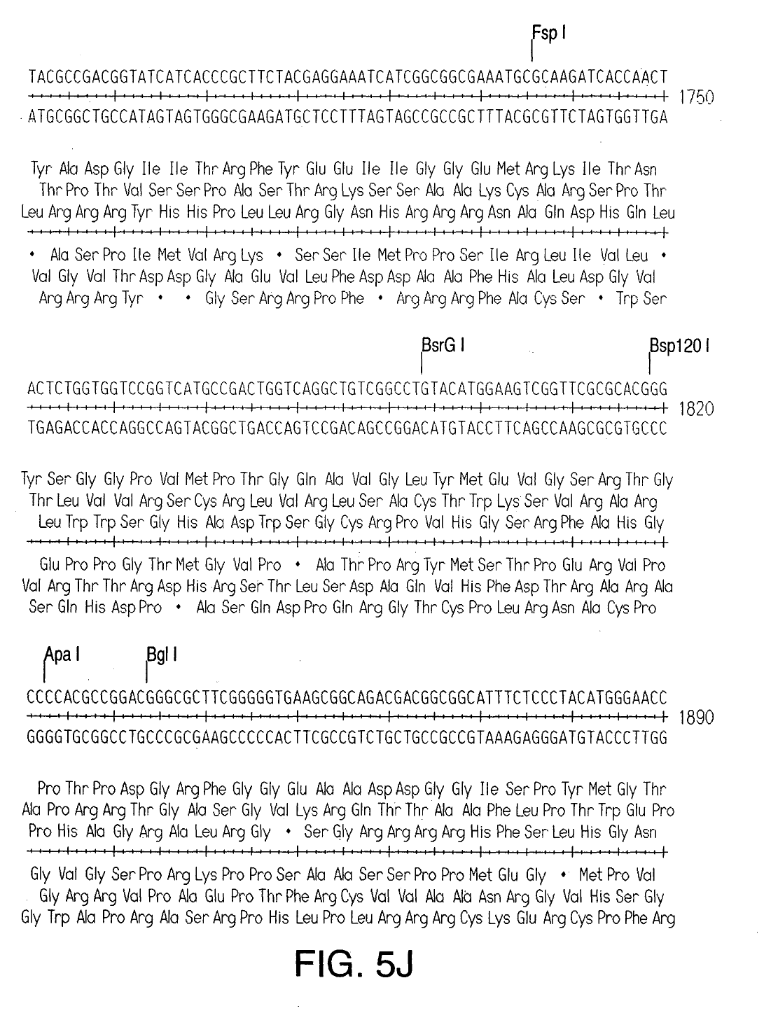

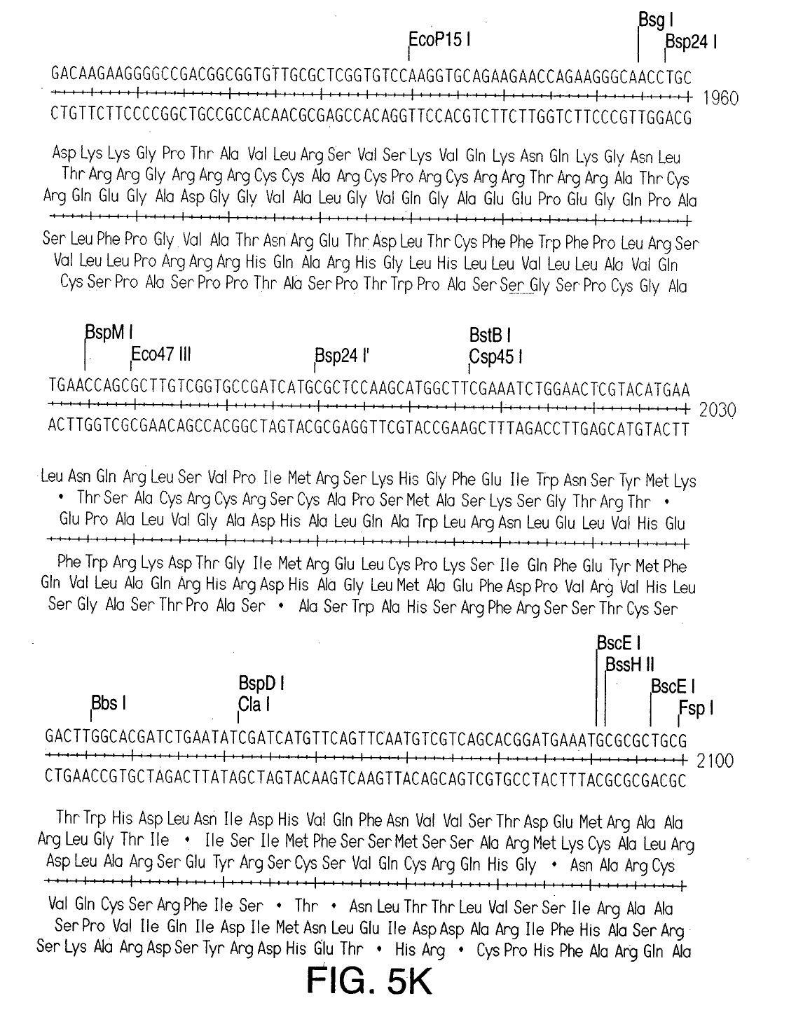

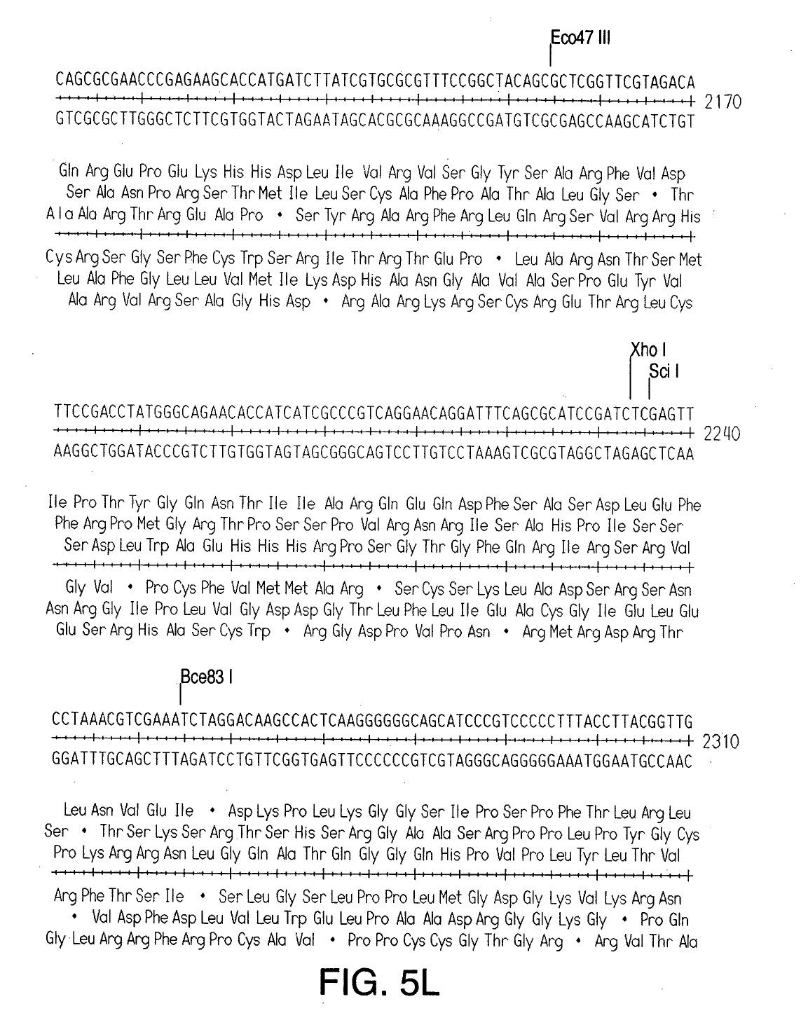

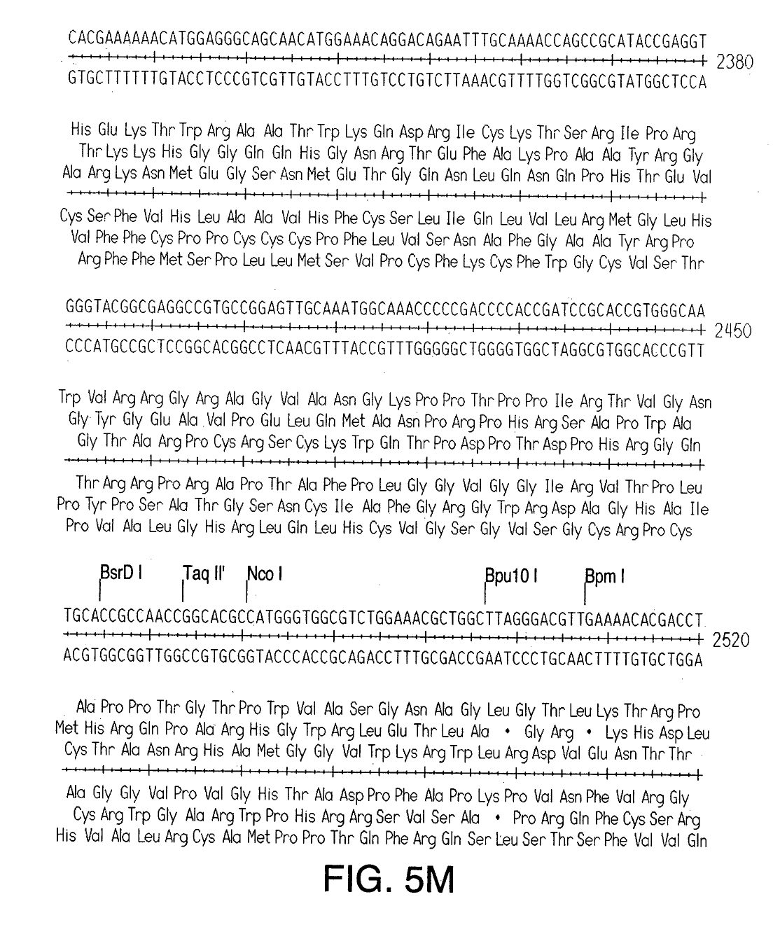

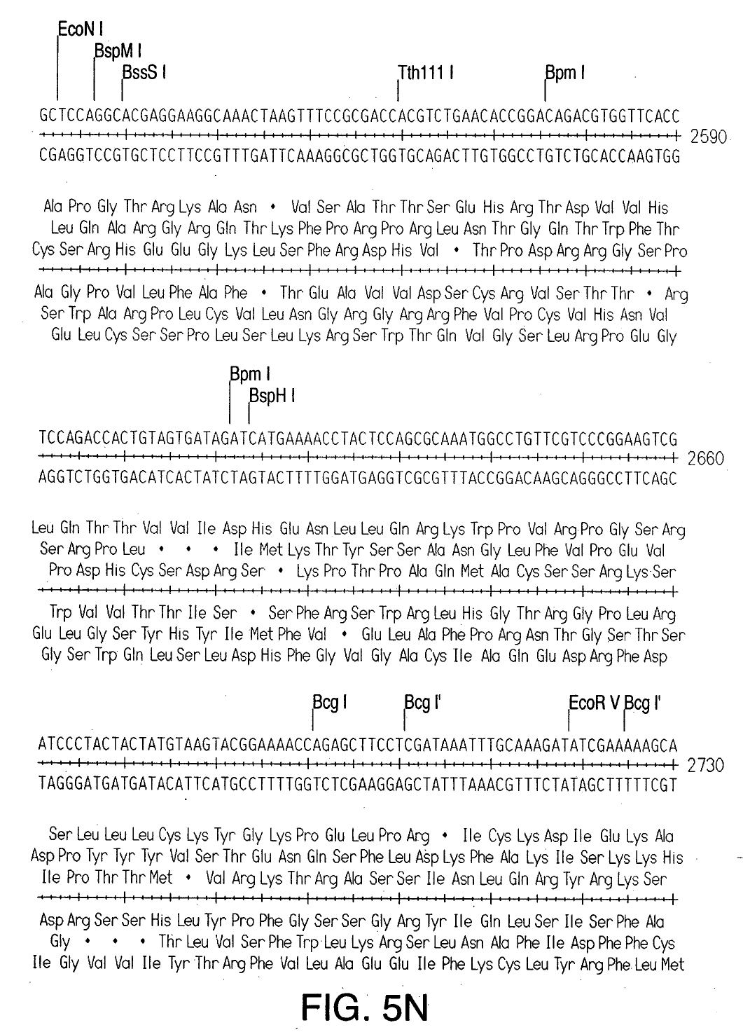

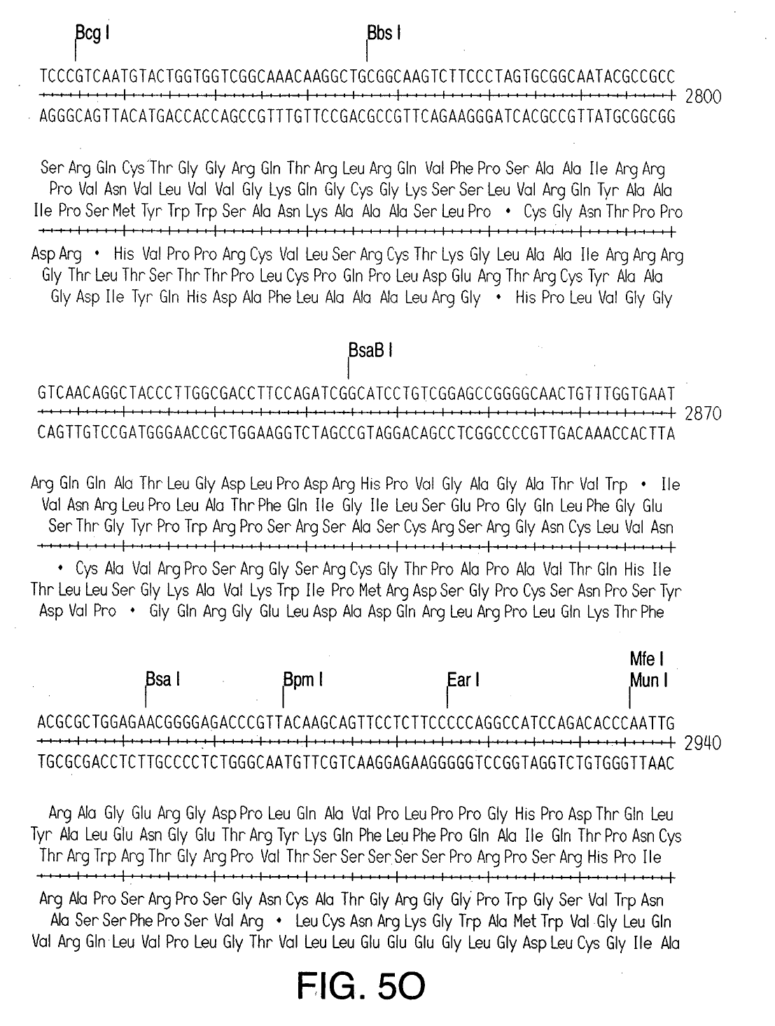

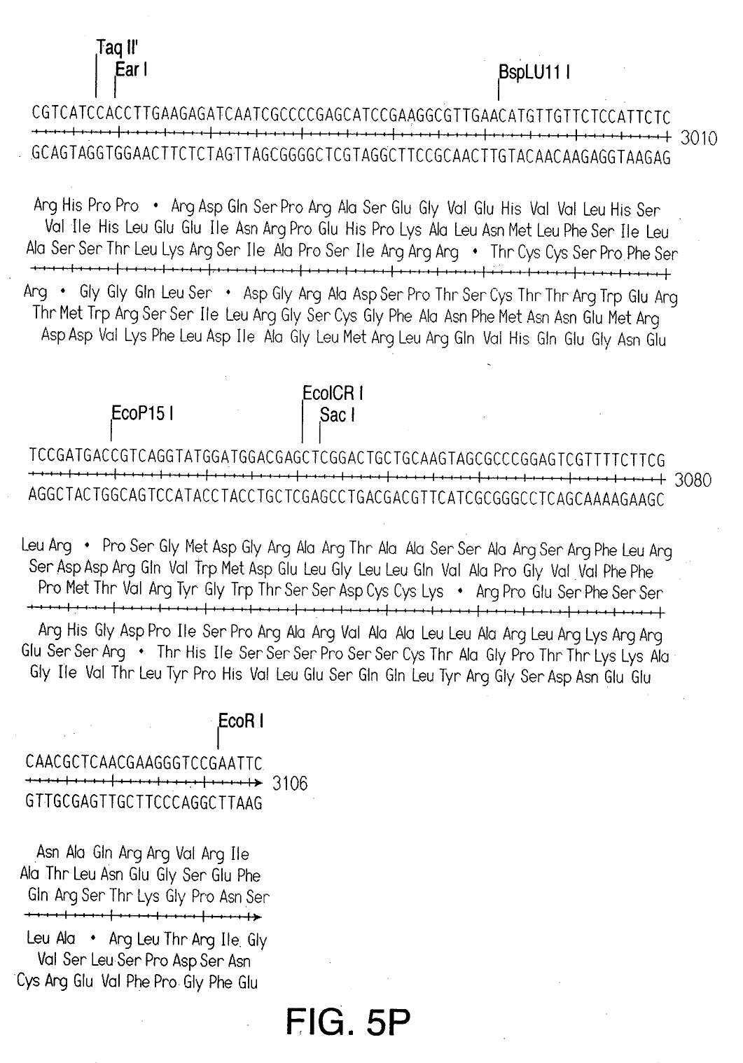

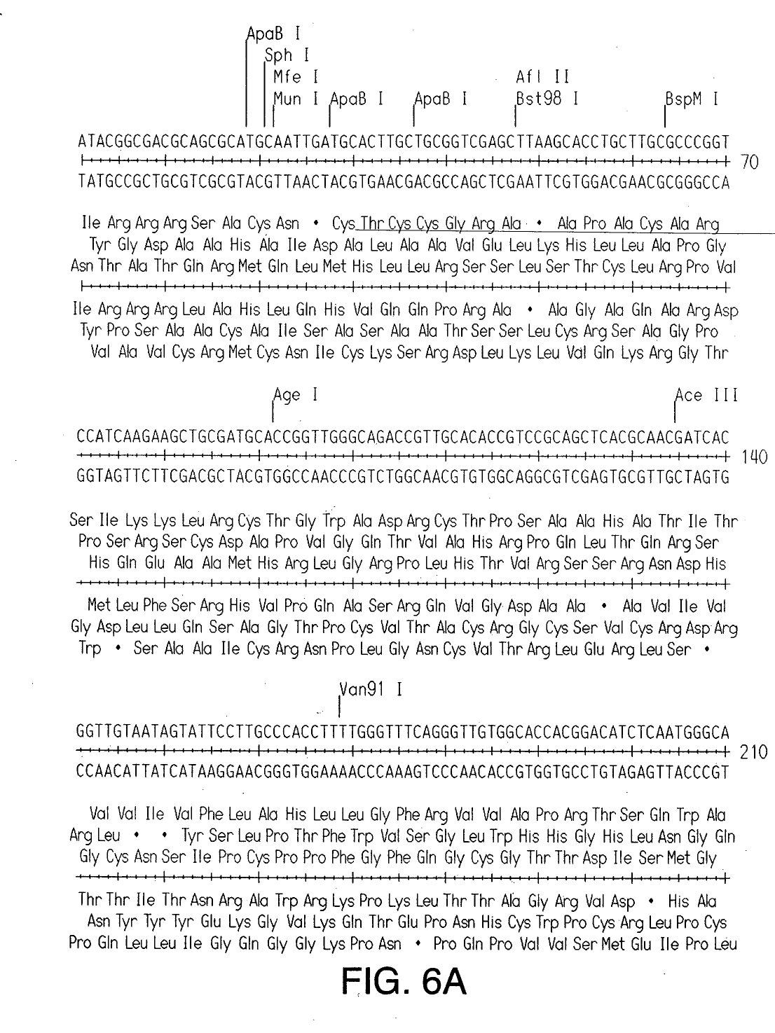

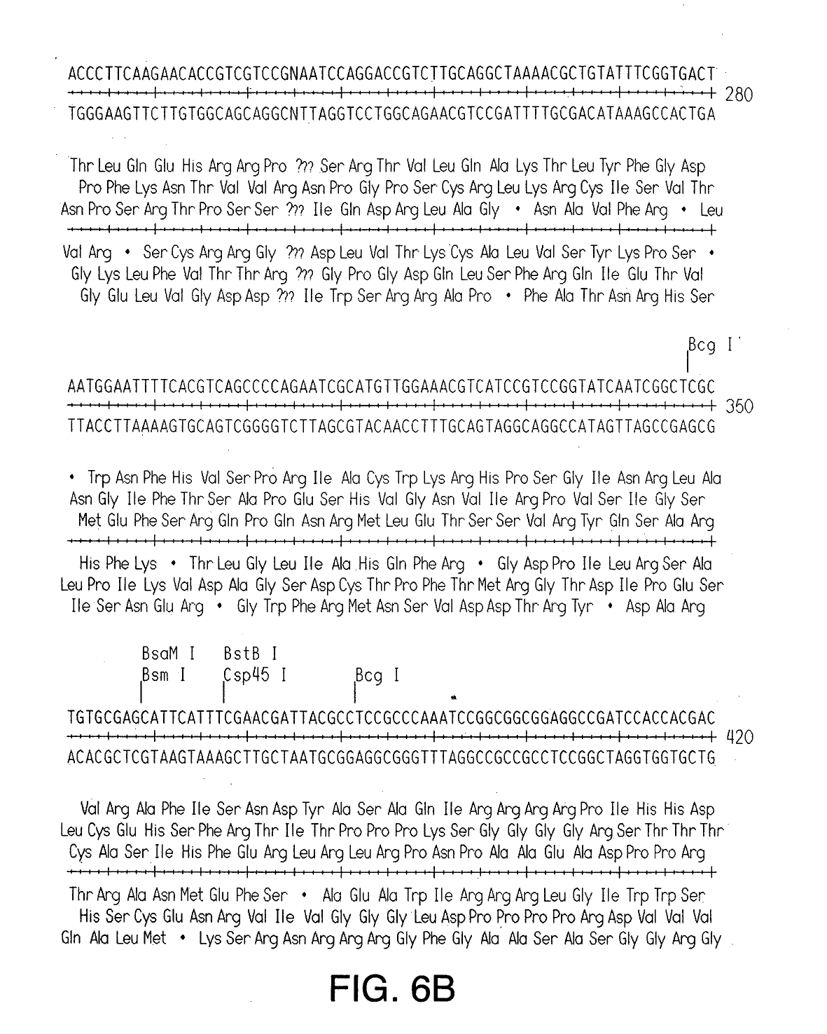

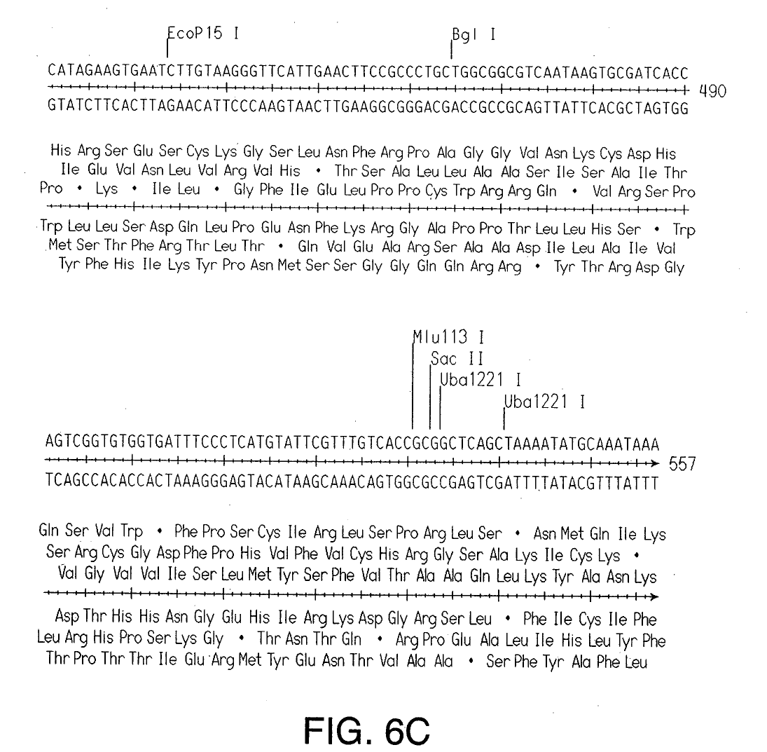

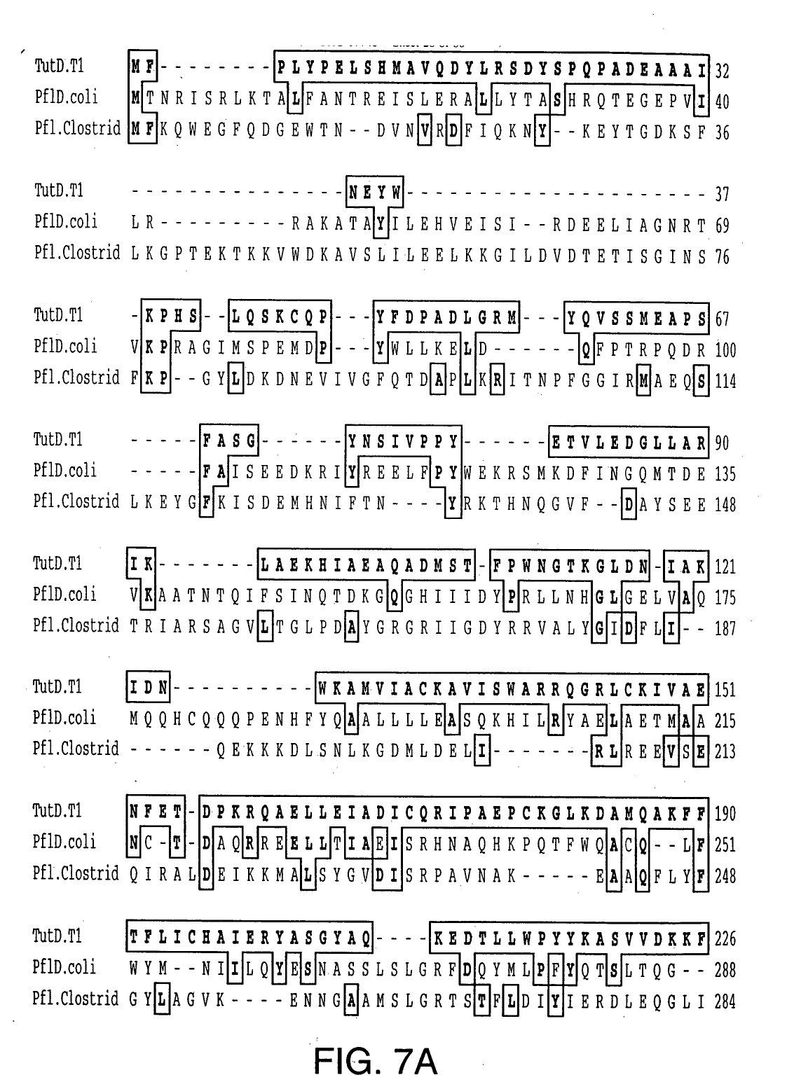

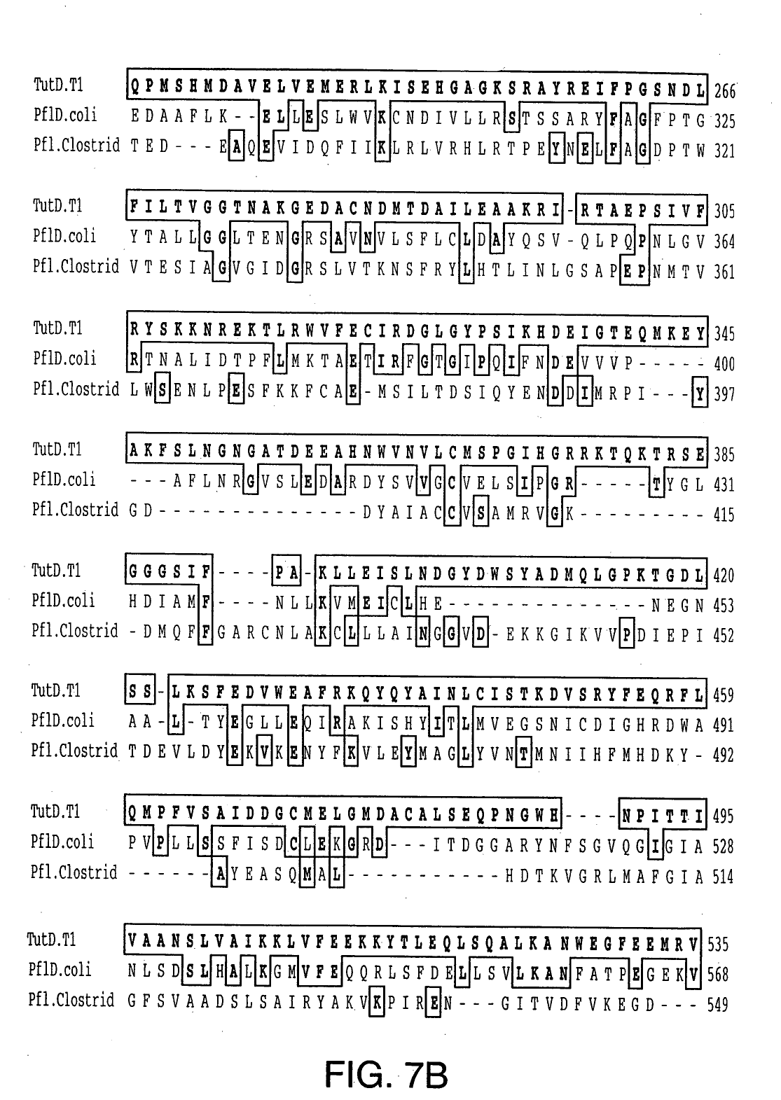

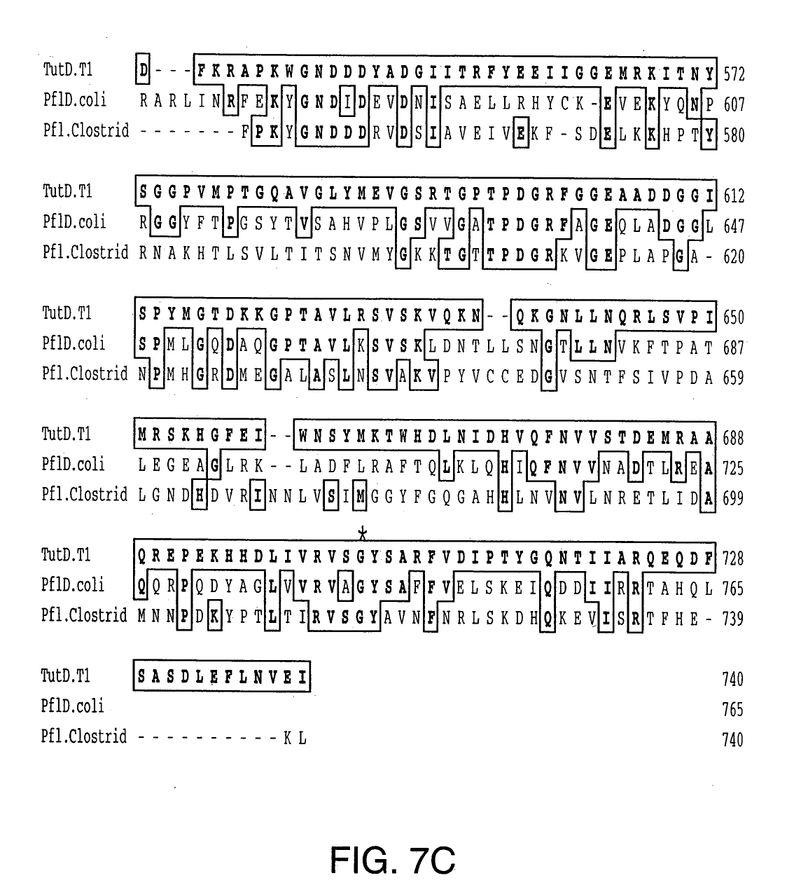

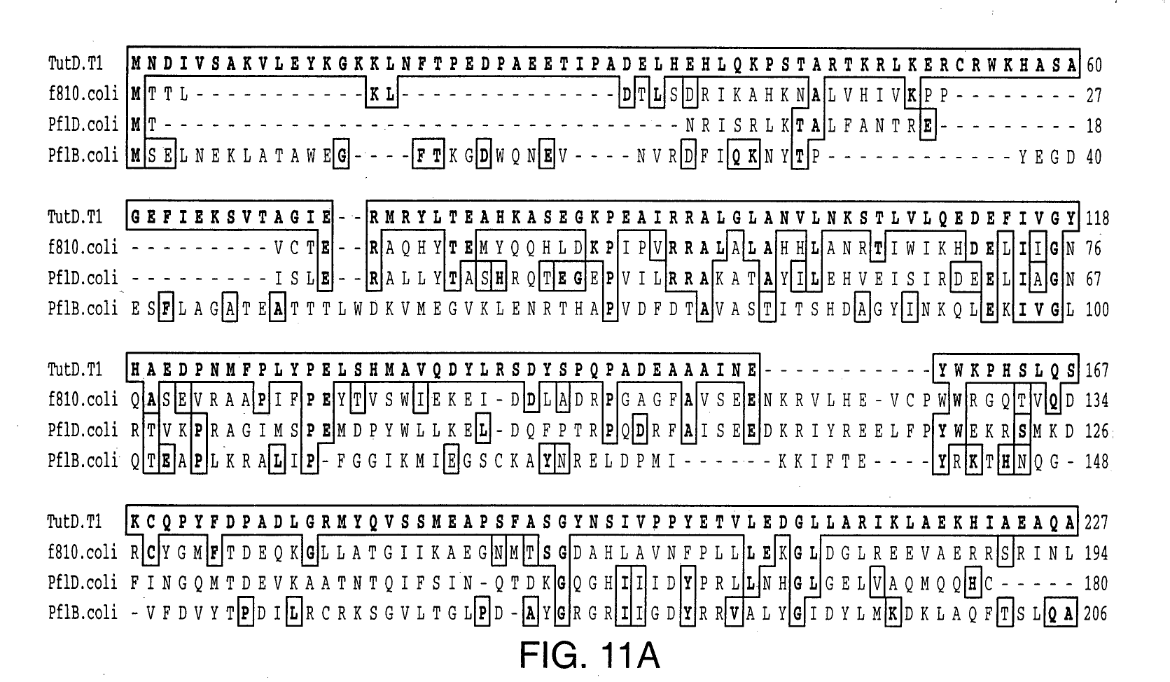

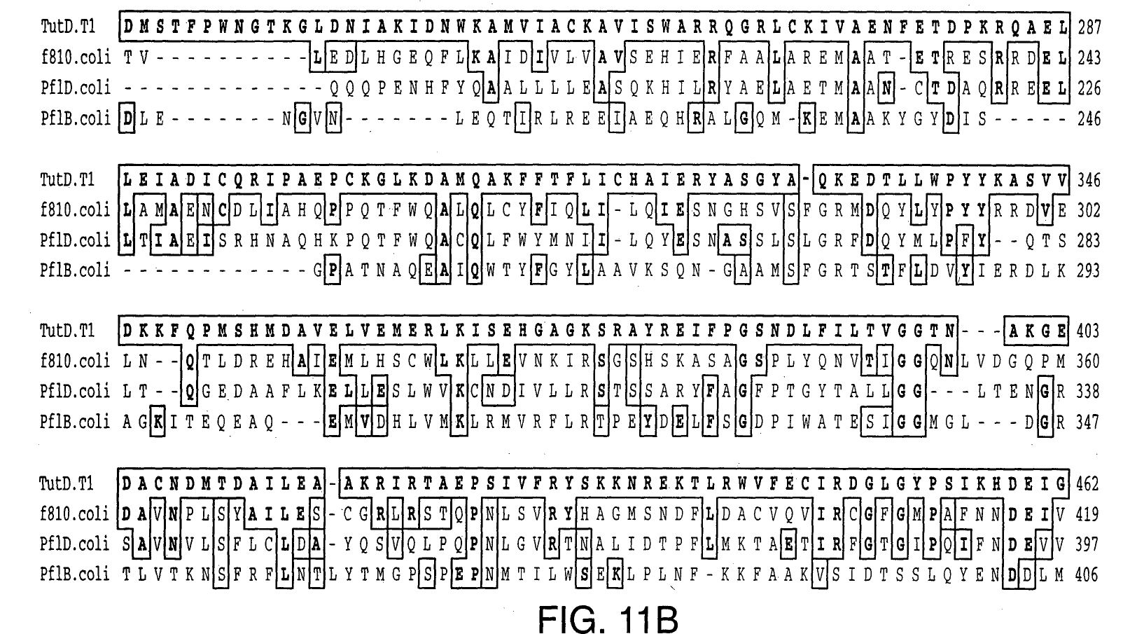

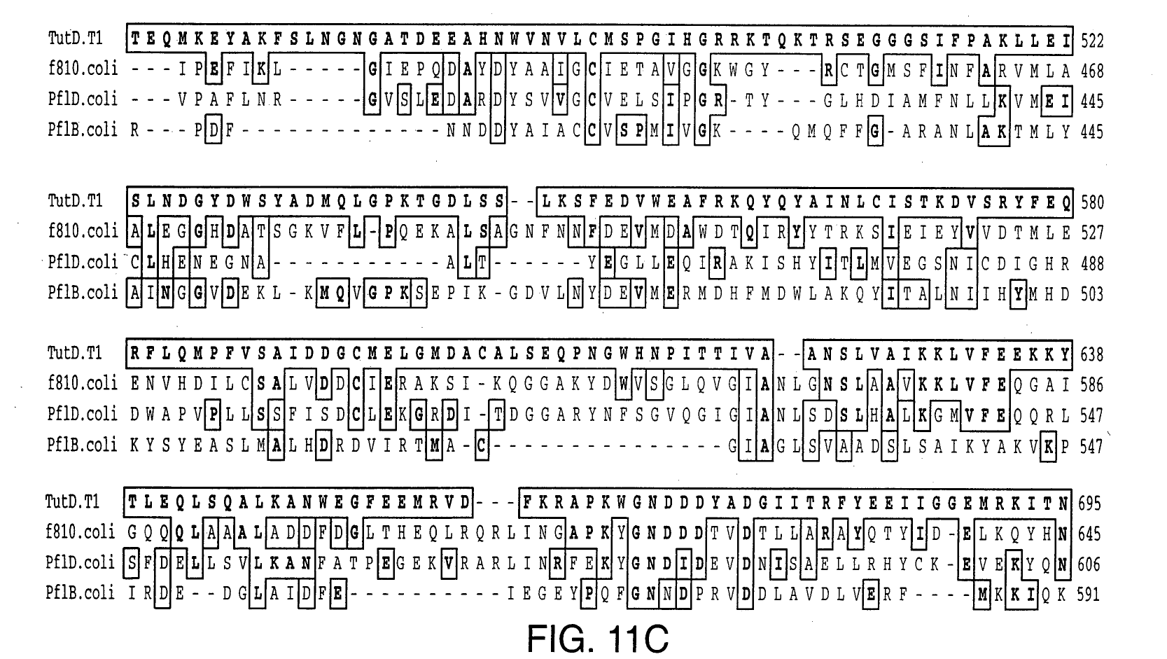

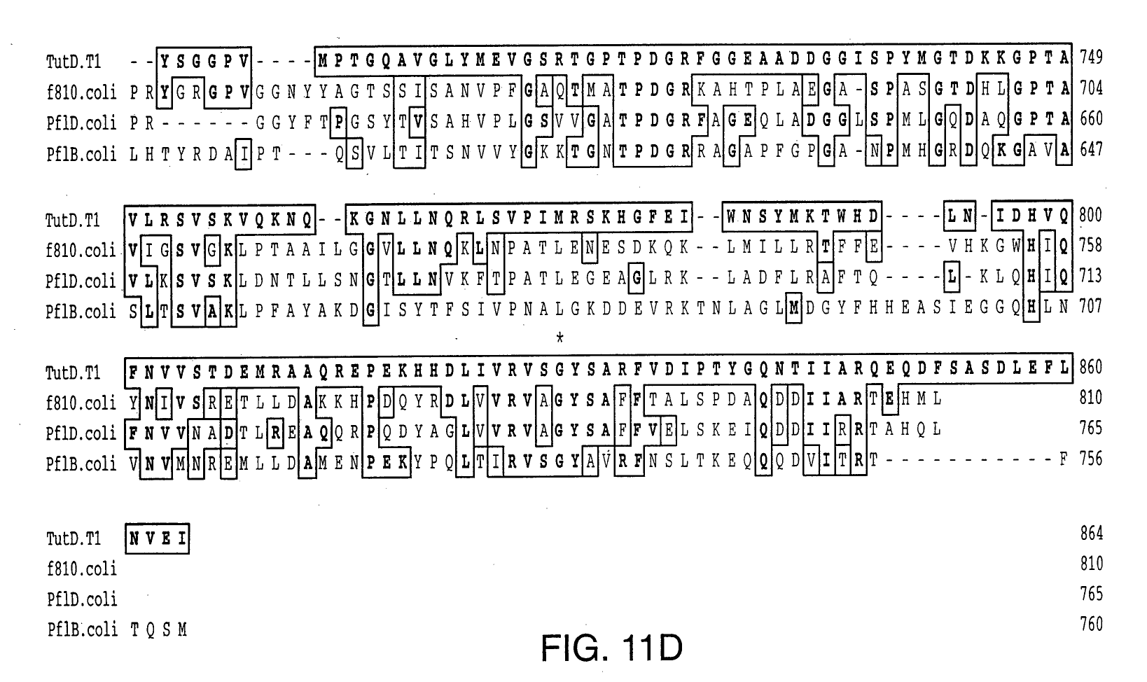

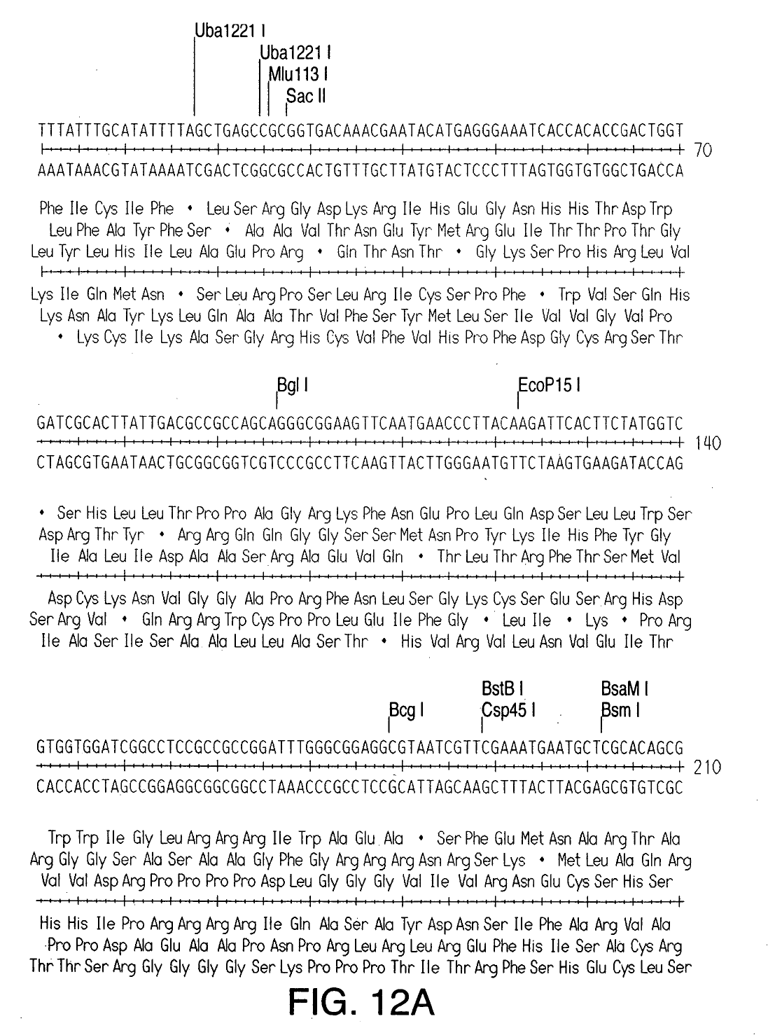

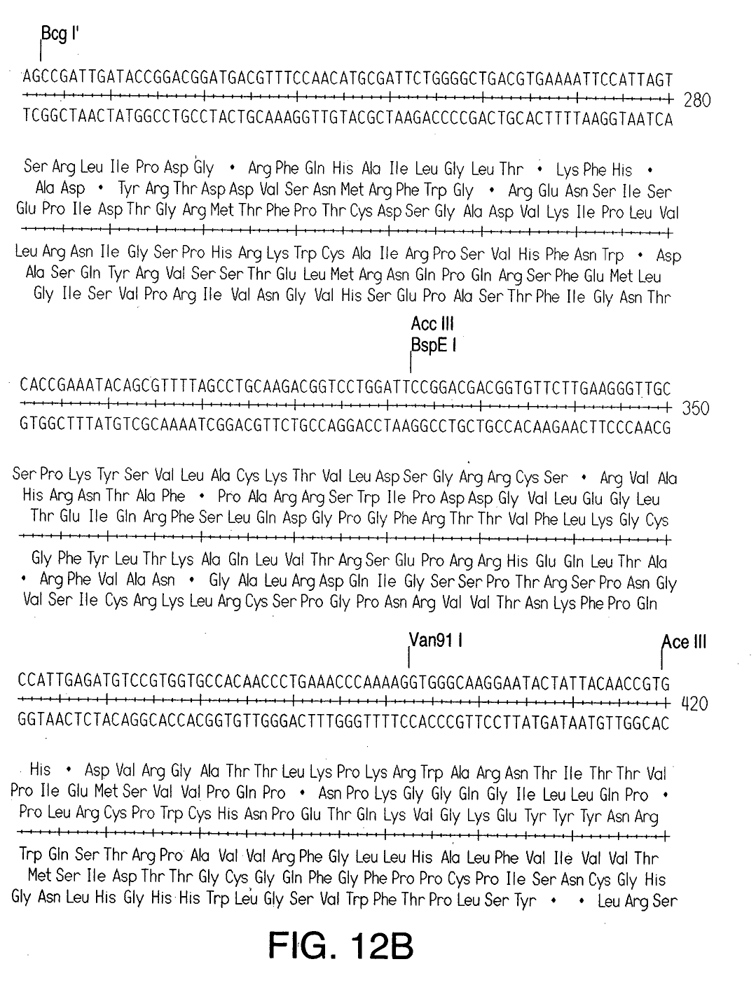

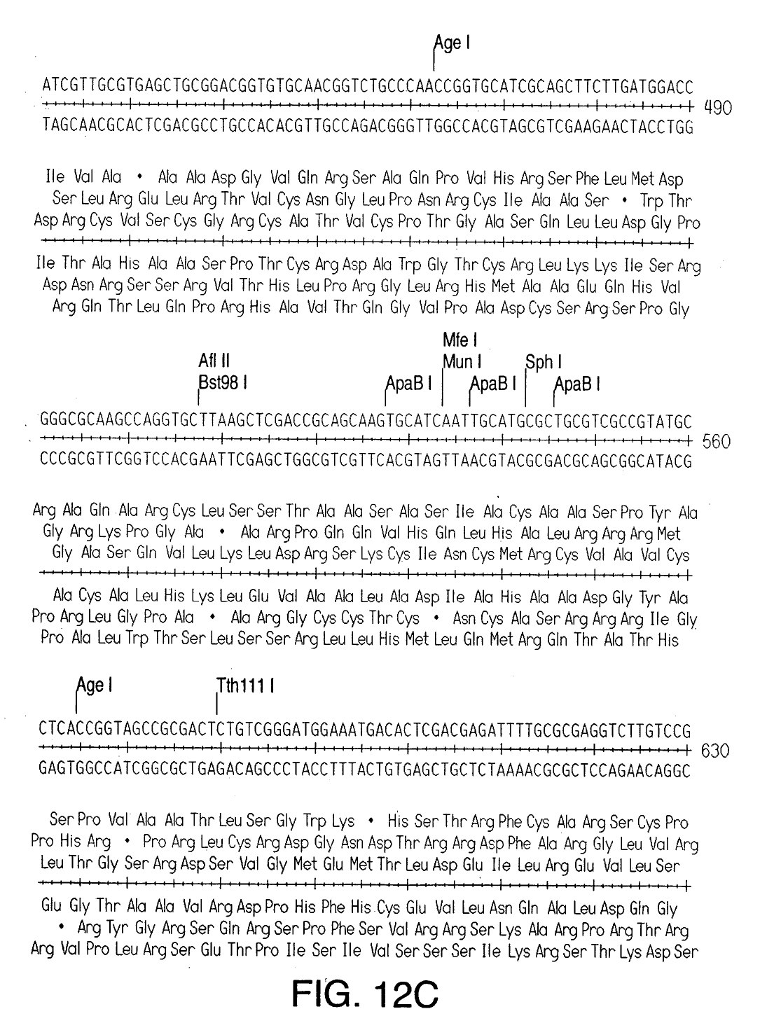

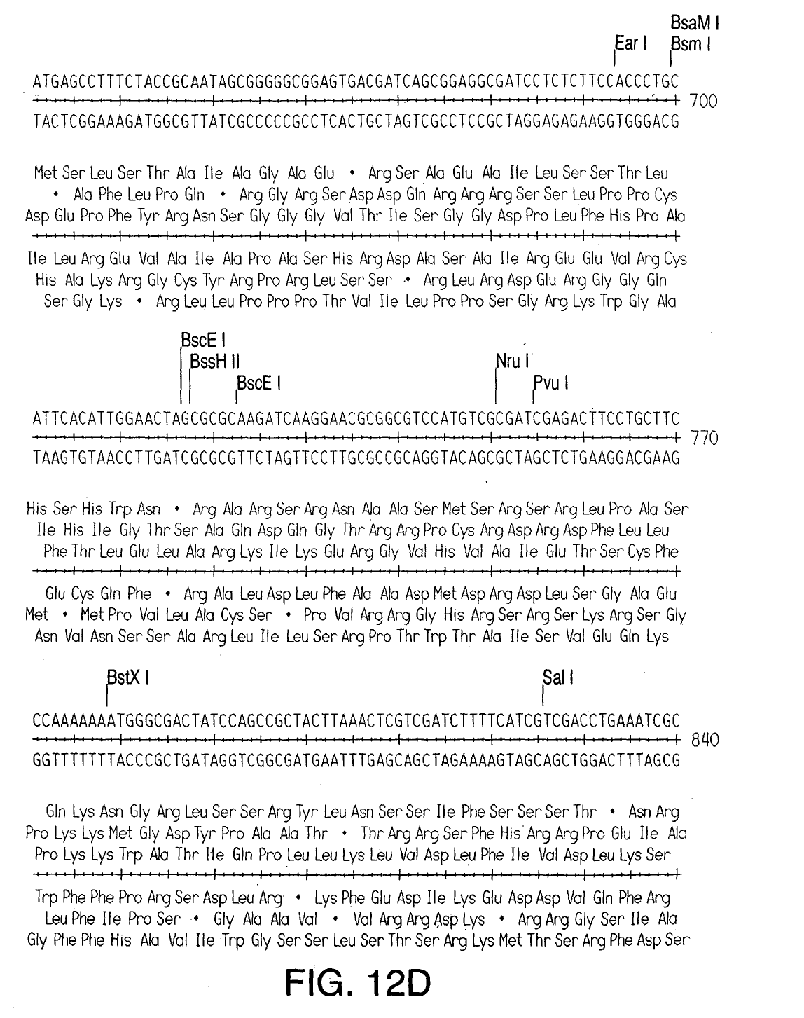

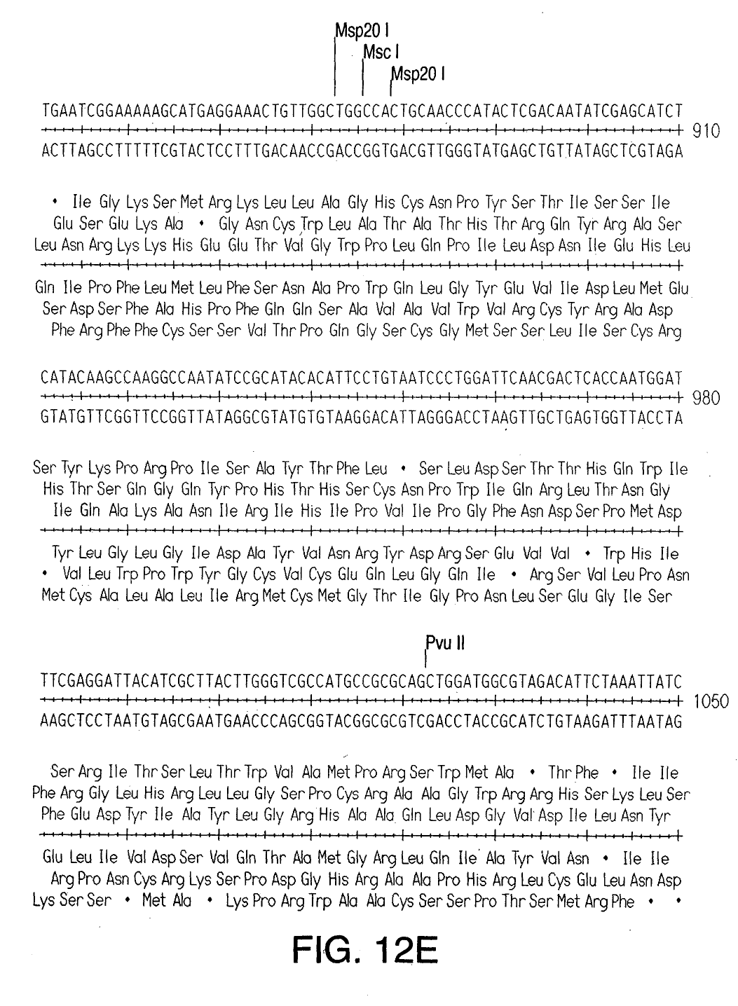

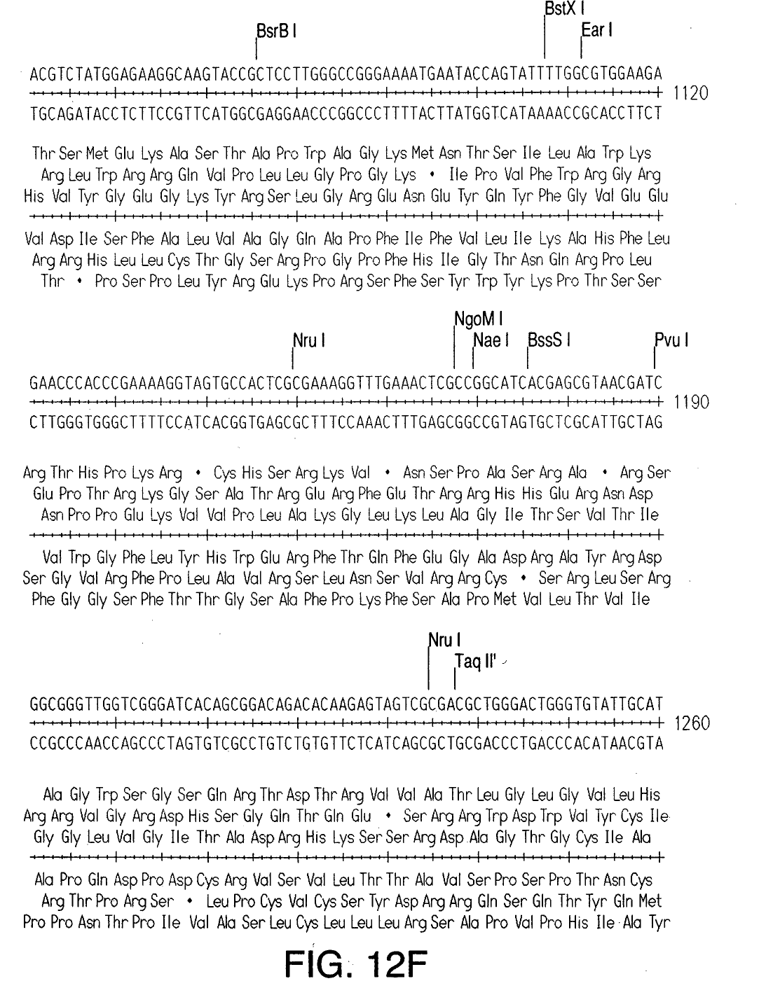

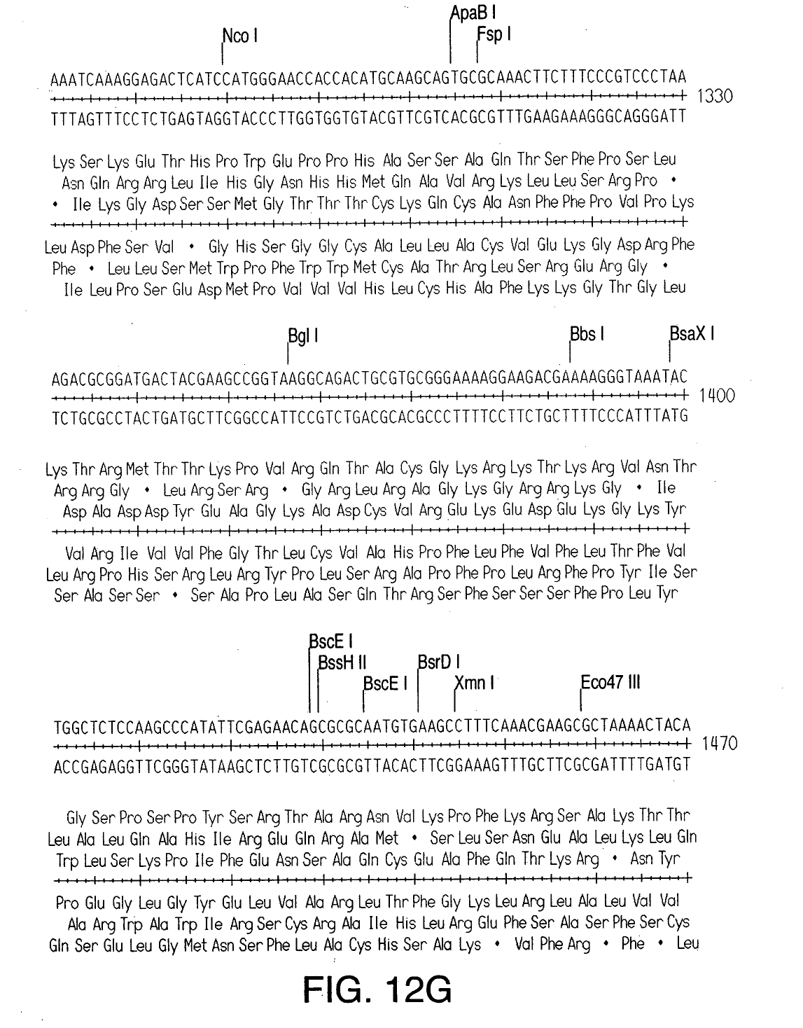

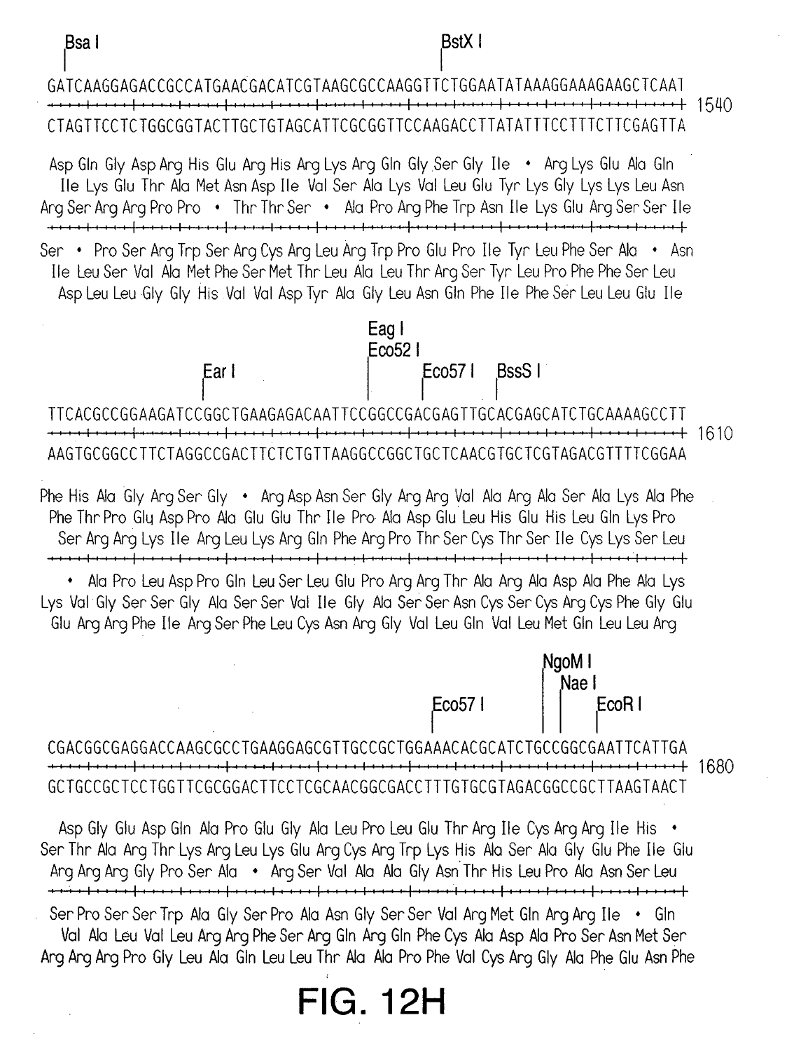

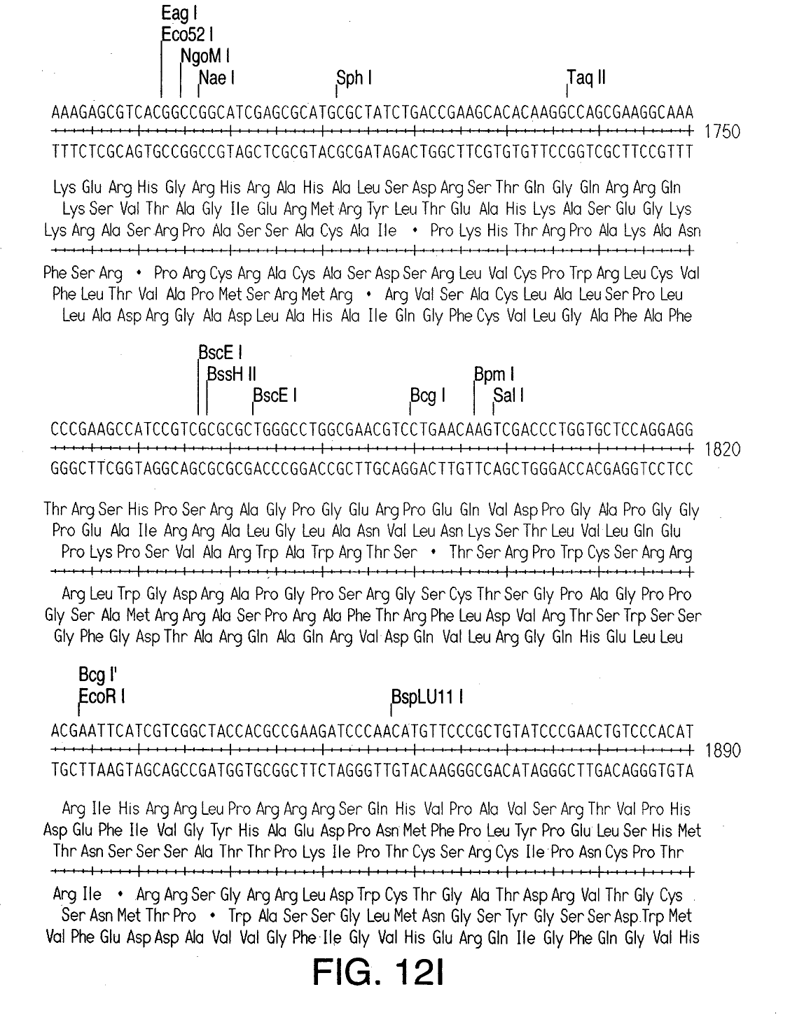

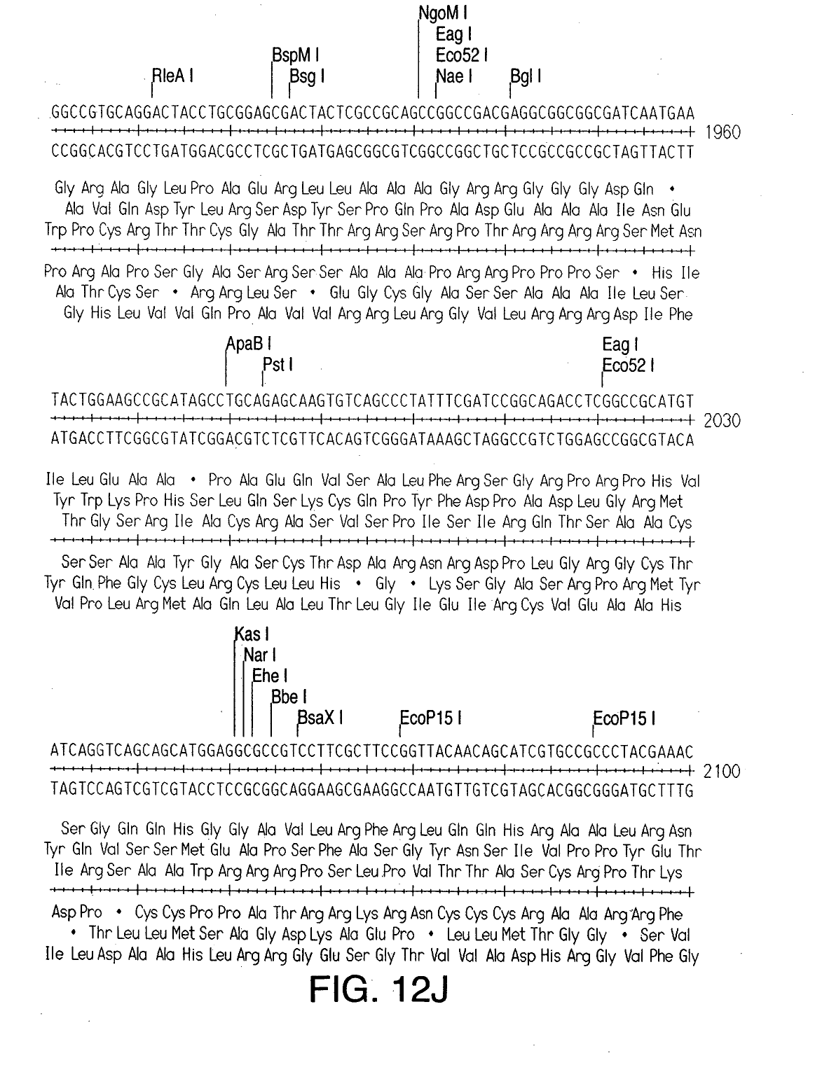

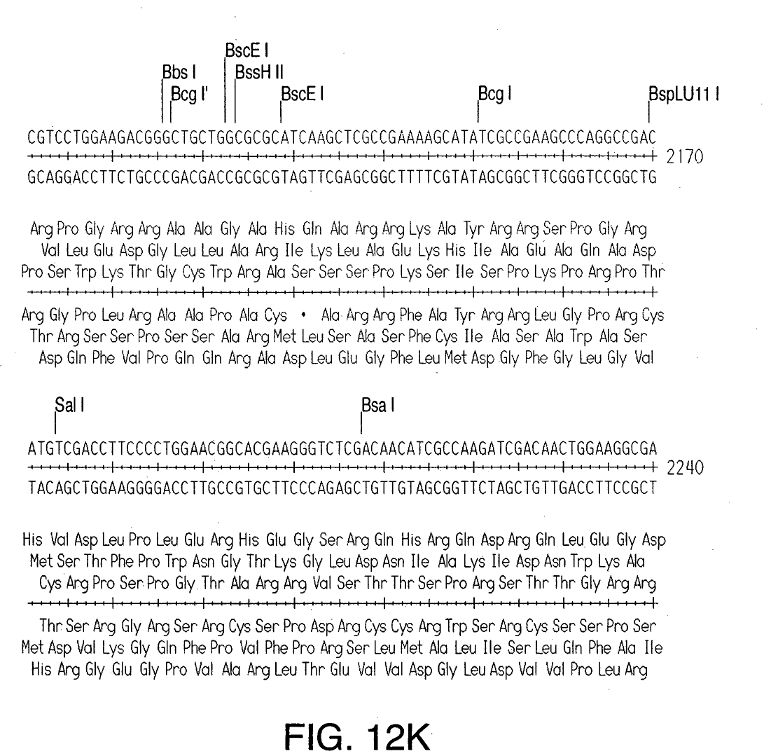

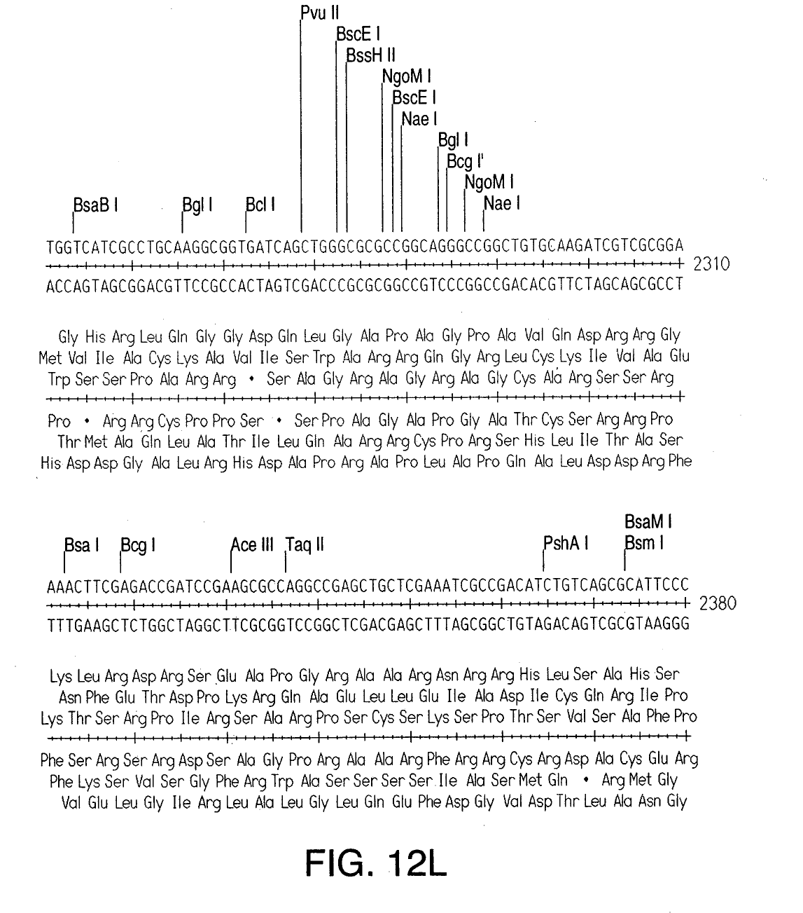

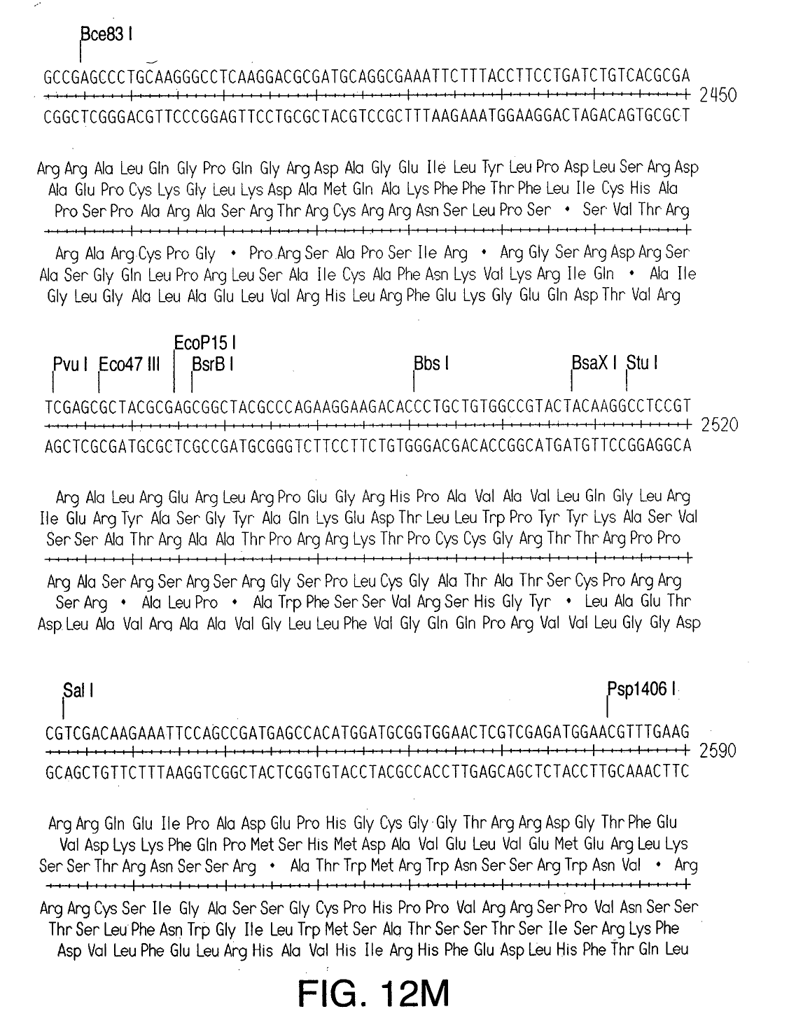

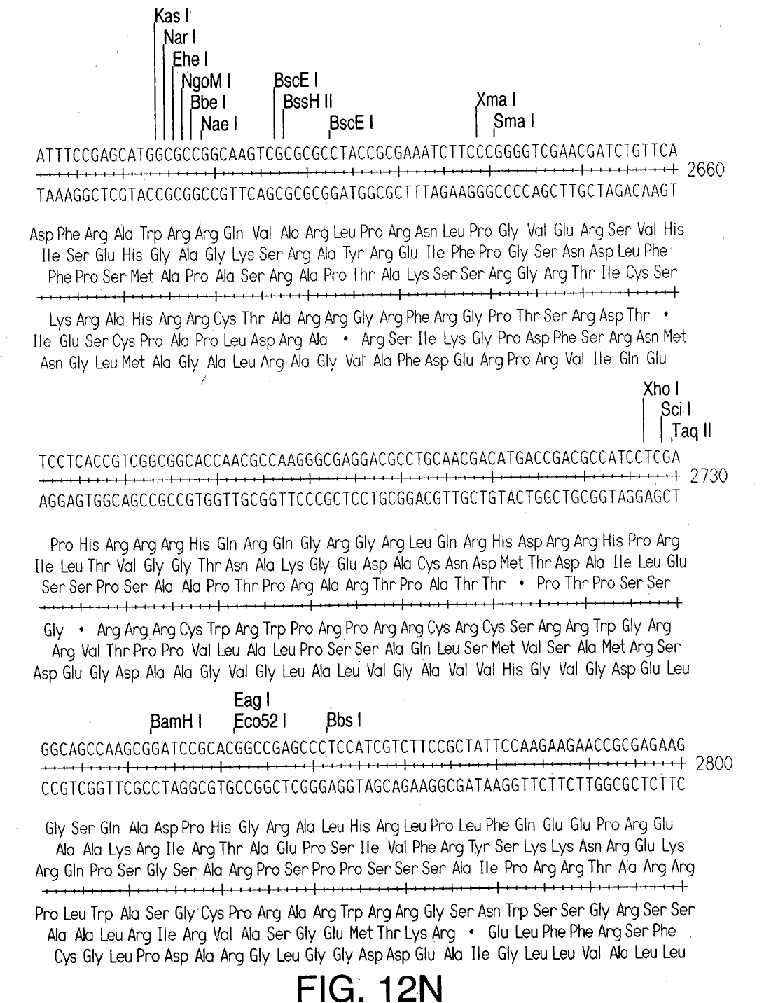

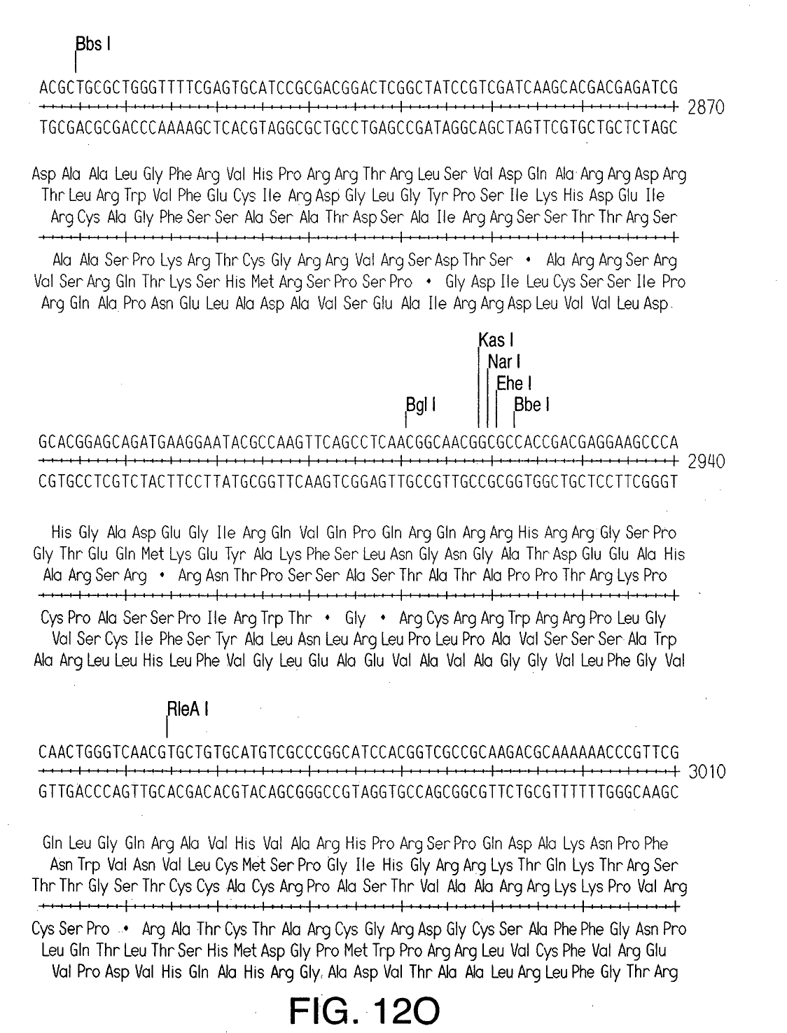

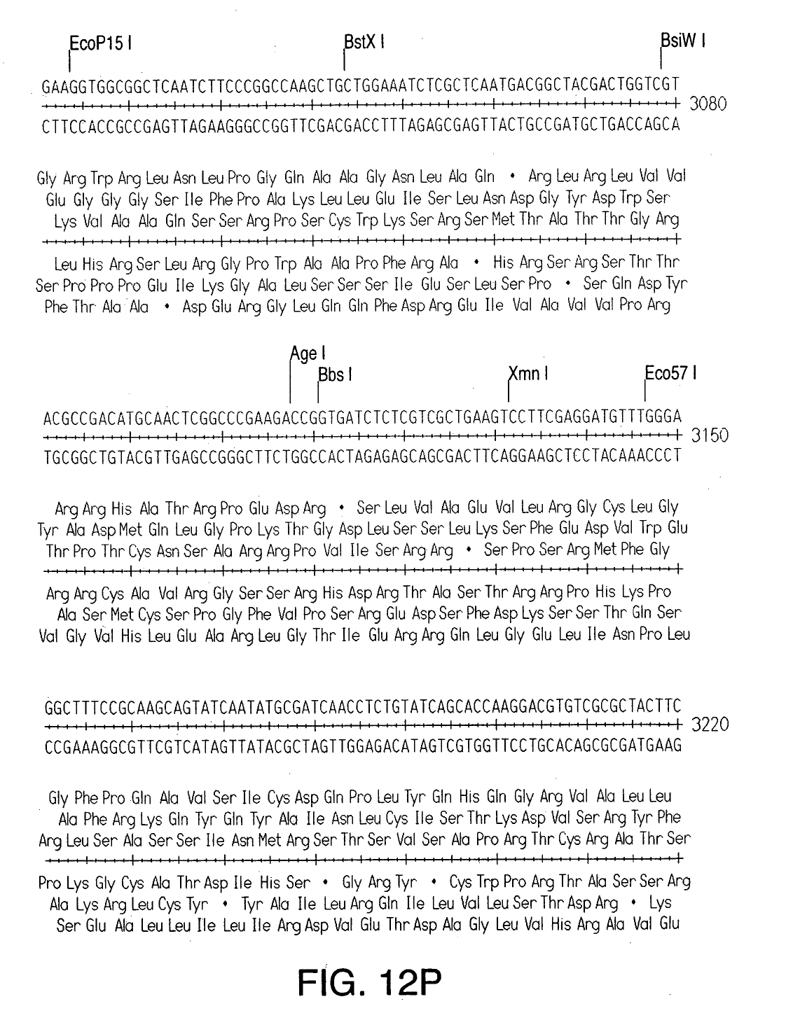

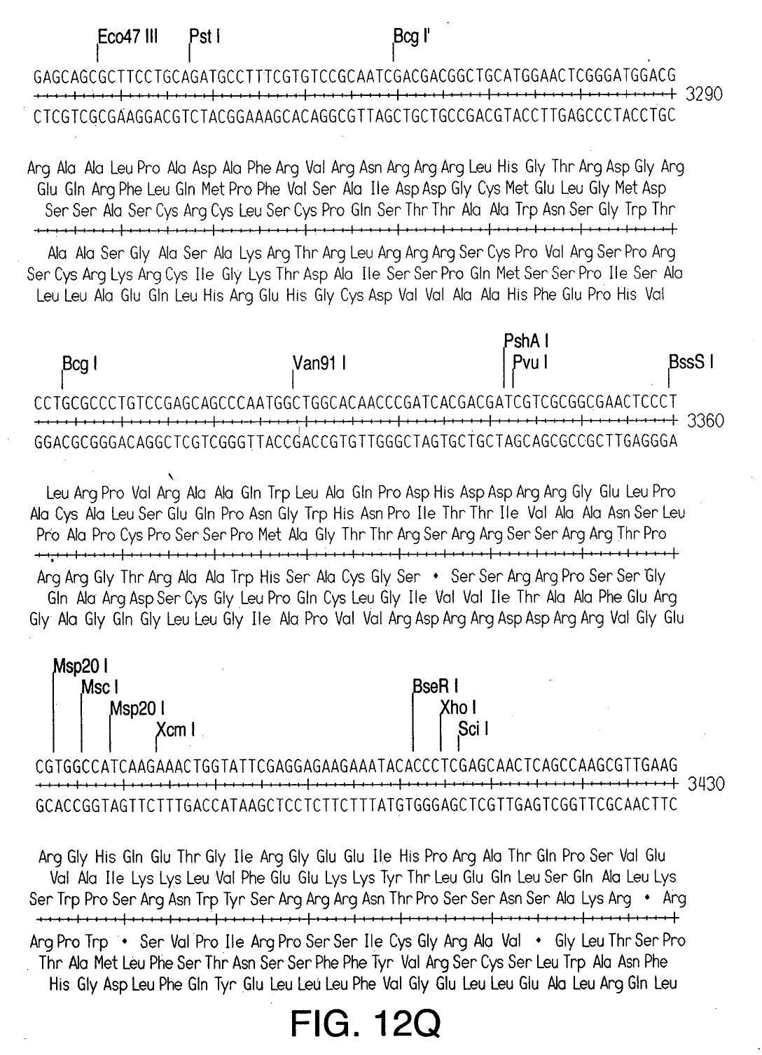

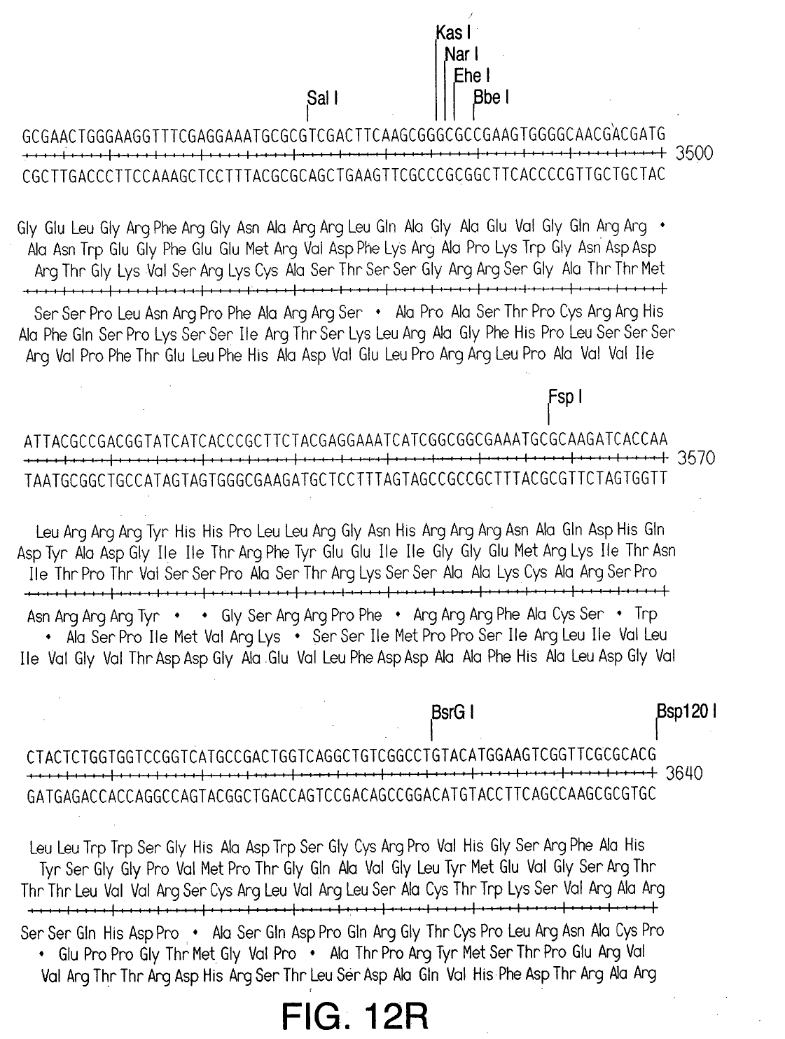

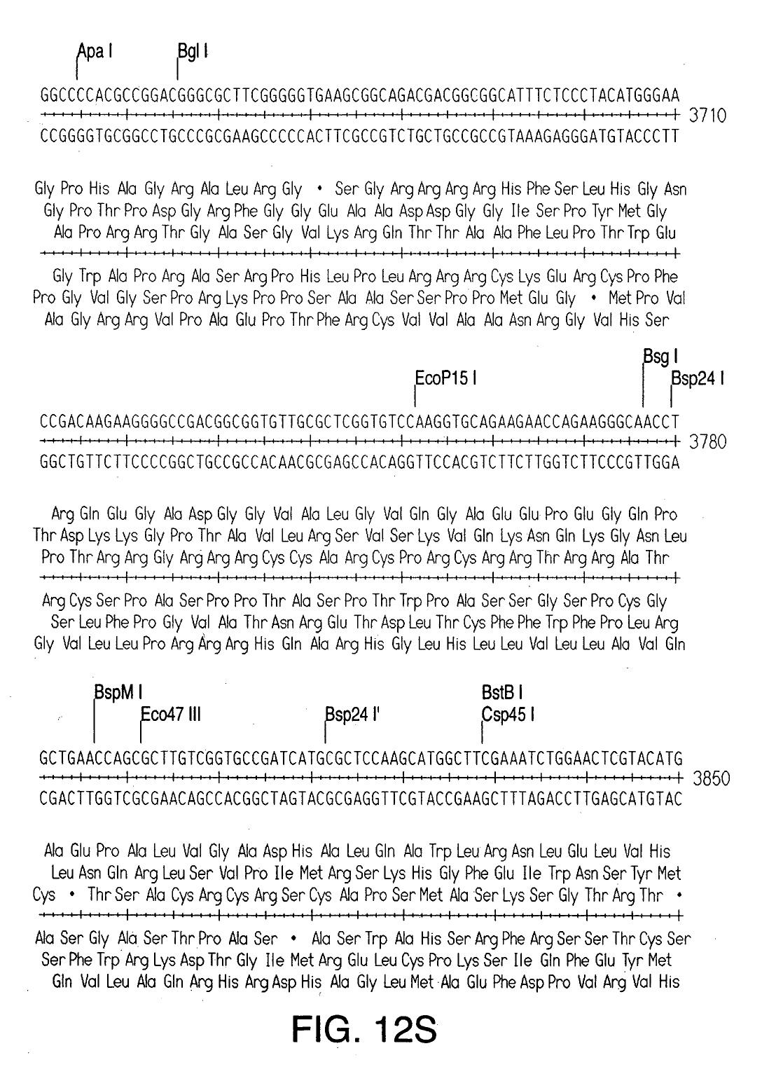

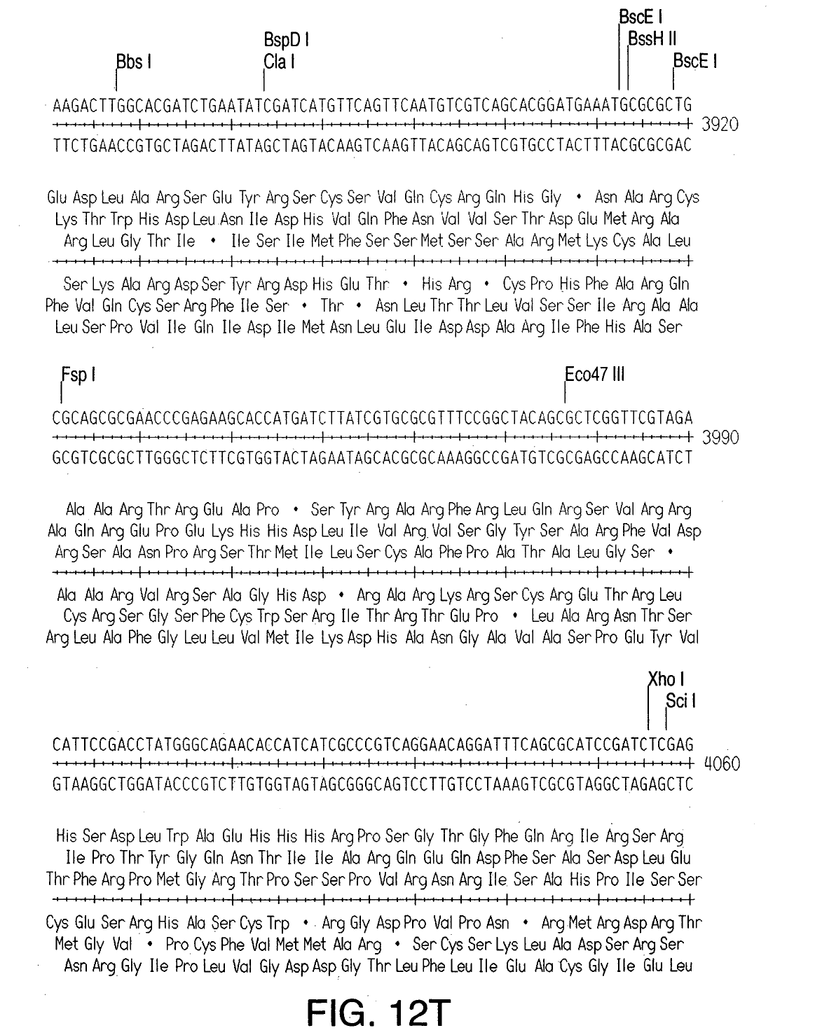

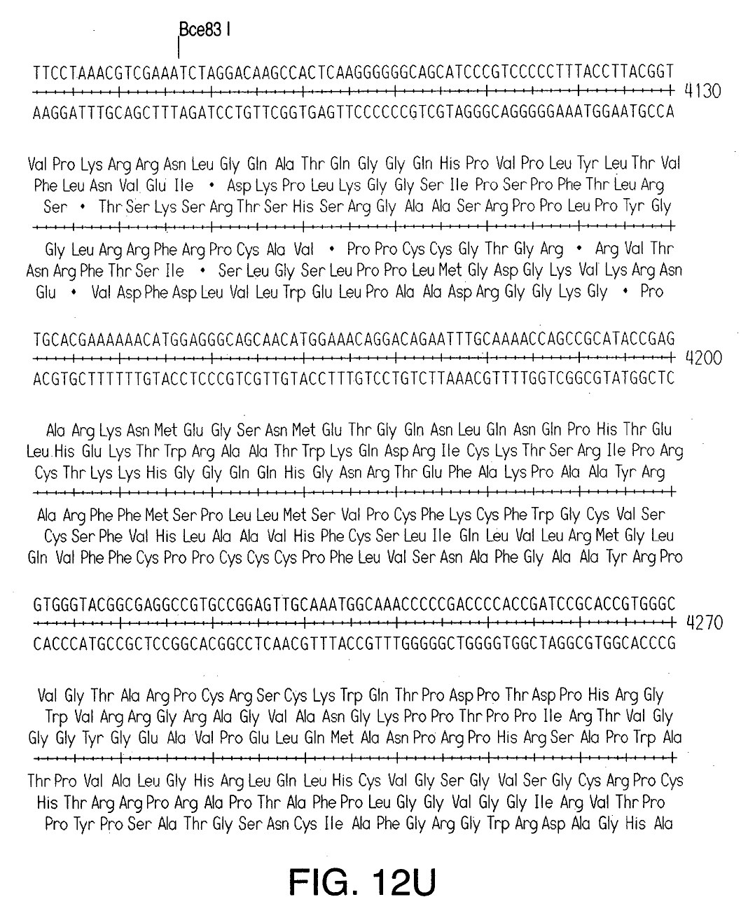

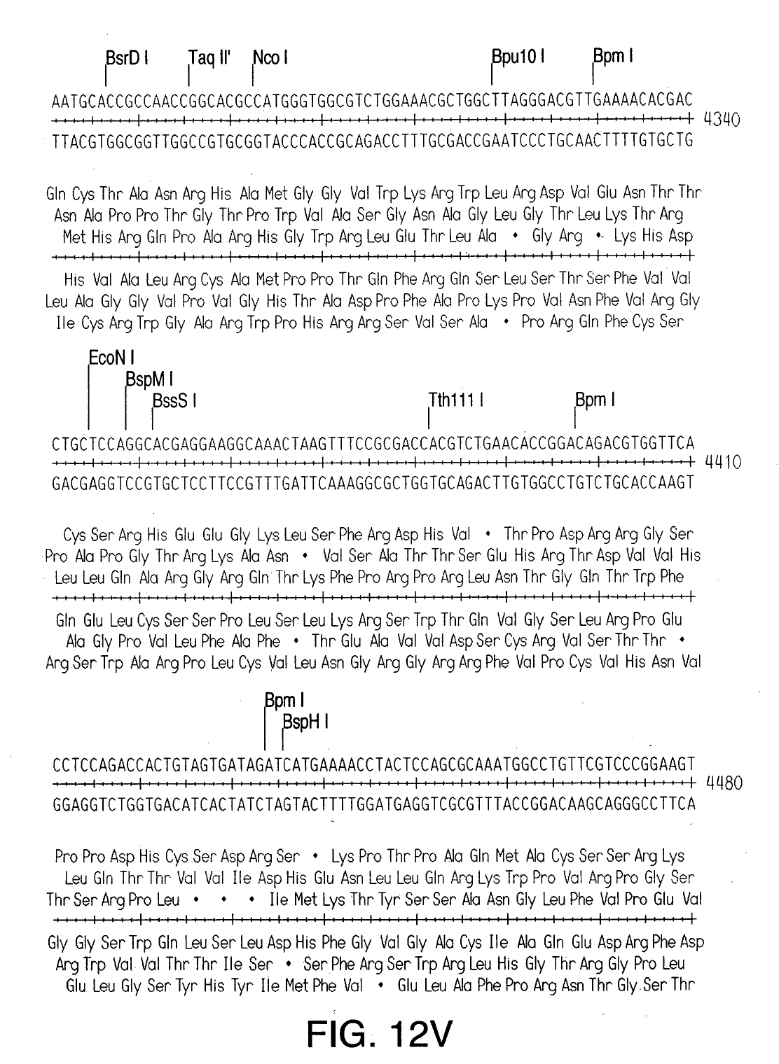

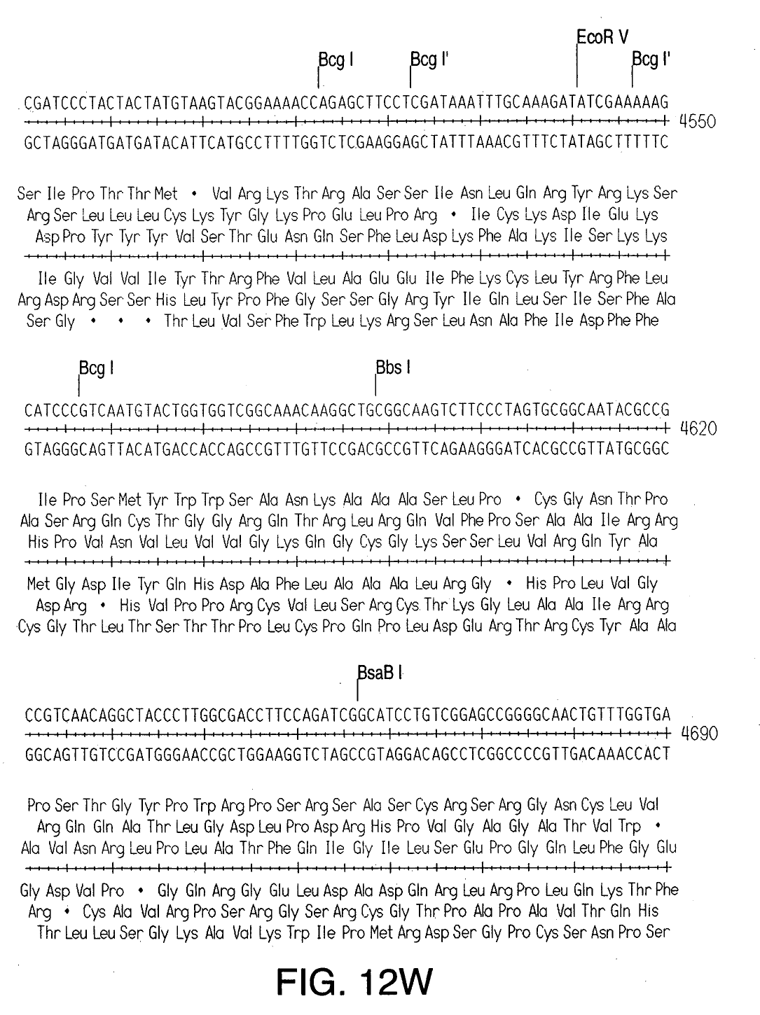

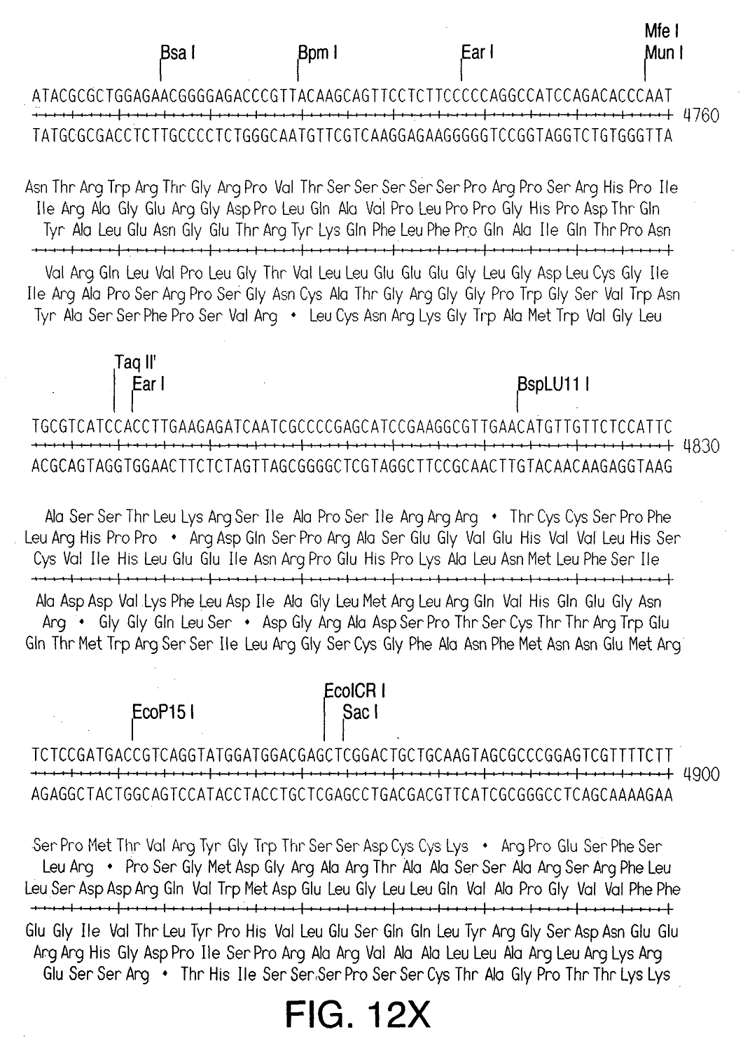

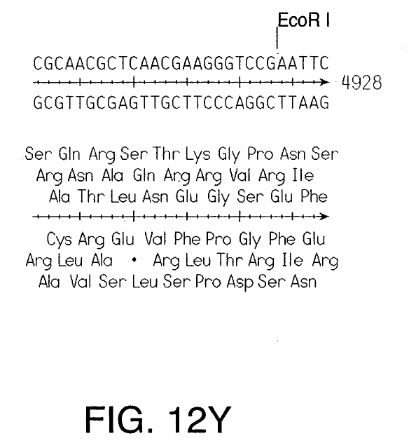

Sequencing of another region of the cosmid clone has revealed the tutD gene (FIG. 5 shows the sequence of an approximately 3.1 kb fragment) and part of the tutE gene (FIG. 6). An expanded tutD gene is presented in FIG. 12 (FIG. 12 shows the sequence of approximately 5 kb fragment) with a corresponding amino acid sequence presented in FIG. 11 (shown aligned with other pyruvate formate lyases). An analysis of this sequence shows that tutD encodes a protein having homologies with the pyruvate formate lyase from E. coli (the PflD gene Genebank G418519) and from Clostridium pasteurianum (Genebank G1072361) (FIG. 7). Other pyruvate formate lyases also show homologies (not shown).

Pyruvate formate lyase catalyzes the conversion of pyruvate and CoA to acetyl-CoA and formate, which is the key step of the glucose fermentation route in anaerobically grown E. coli cells. See generally, Knappe and Wagner, Methods Enzymol. 258:343 (1995). The active form of pyruvate formate-lyase (PFL) from Escherichia coli contains a glycyl radical in position 734 of the polypeptide chain which is produced post-translationally by pyruvate formate-lyase-activating enzyme (PFL activase) using S-adenosylmethionine (AdoMet) and dihydroflavodoxin as co-substrates. A. F. Wagner et al., “The free radical in pyruvate formate-lyase is located on glycine-734,” Proc. Natl. Acad. Sci. U.S.A. 89, 996-1000 (1992). The glycyl radical has been shown to participate in catalysis by guiding the carbon-carbon bond cleavage step along a radical-chemical route. The radical is thought to interact with a cystein residue; indeed, a reversible hydrogen transfer, induced by substrate binding, has been proposed between the Gly-734 resting-state spin localization and Cys-418, whose thiyl radical will function as the “working radical” for substrate processing.

It is not known how the homologue of the present invention functions. However, the comparison shown in FIG. 7 reveals the essential glycine (marked in the Figure with a ‘*’). While an understanding of the precise mechanism is hot necessary to the successful practice of the invention, it is now known that a cysteine of the tutD gene product is also involved in the transfer that is ultimately directed to the methyl group of toluene (see discussion below). Again, while it is not necessary to the successful practice of the invention, the lack of homology at the 5′ end of the tutD gene suggests that this portion of the gene product involves the unique substrate recognition.

Transcriptional Organization and Regulation

Data presented herein is consistent with the toluene regulated tutE and tutFDGH genes of T. aromatica T1 being organized into two operons. Additionally, these data are consistent with the tutF, tutD, tutG and tutH genes being organized in a single operon and use the same transcriptional start site. The tutEtutFDG genes of T. aromatica T1 are similar to the bssDCAB genes of T. aromatica K172. Specifically, the bssDCAB genes are regulated in response to toluene. However, the bssDCAB are organized into only one transcriptional unit. Since genes encoding subunits of the benzylsuccinate synthase enzyme (bssCAB) are included in the bssDCAB gene cluster, it is not surprising that they would be located together in a single operon. In contrast, since both the tutE and bssD gene products likely function as activators that enzymatically form a glycine free radical in the proteins encoded by the tutD and bssA genes respectively, it would not be completely unexpected that the activator proteins and the activated proteins are located on separate transcriptional units. Indeed, in the case of the pyruvate formate-lyase systems of E. coli, Haemophilus influenzae, and Clostridium pasteurianum, which show sequence similarities to the tutD/tutE genes and the bssA/bssD genes, the pyruvate formate-lyase activating protein is located on a different transcriptional unit from the pyruvate formate-lyase (Rodel, W., et al., “Primary structure of Escherichia coli pyruvate formate-lyase and pyruvate formate-lyase activating enzyme deduced from the DNA nucleotide sequences” Eur. J. Biochem., 177:153-158, 1988).

Northern analysis of toluene grown T. aromatica T1 using probes derived from the tutF, tutD, and tutG genes all identified a mRNA transcript with a maximum size of about 5.0 kb.

### EXPERIMENTAL

The following examples serve to illustrate certain preferred embodiments and aspects of the present invention and are not to be construed as limiting the scope thereof.

In the experimental disclosure which follows, the following abbreviations apply: eq (equivalents); M (Molar); μM (micromolar); N (Normal); mol (moles); mmol (millimoles); μmol (micromoles); nmol (nanomoles); gm (grams); mg (milligrams); μg (micrograms); L (liters); ml (milliliters); μl (microliters); cm (centimeters); mm (millimeters); [m (micrometers); nm (nanometers); ° C. (degrees Centigrade).

Strains And Plasmids

The Escherichia coli strains HB101, XL-1 Kan Blue (Stratagene, LaJolla, Calif.), and XL-1 Blue (Stratagene), used to propagate and transfer DNA, were transformed by the calcium chloride technique or were purchased from the company as competent cells. Strain HB101(pRK2013) (Kan^{R}) contains a helper plasmid that permitted mobilization of cosmids and plasmids into the T1 strain background.

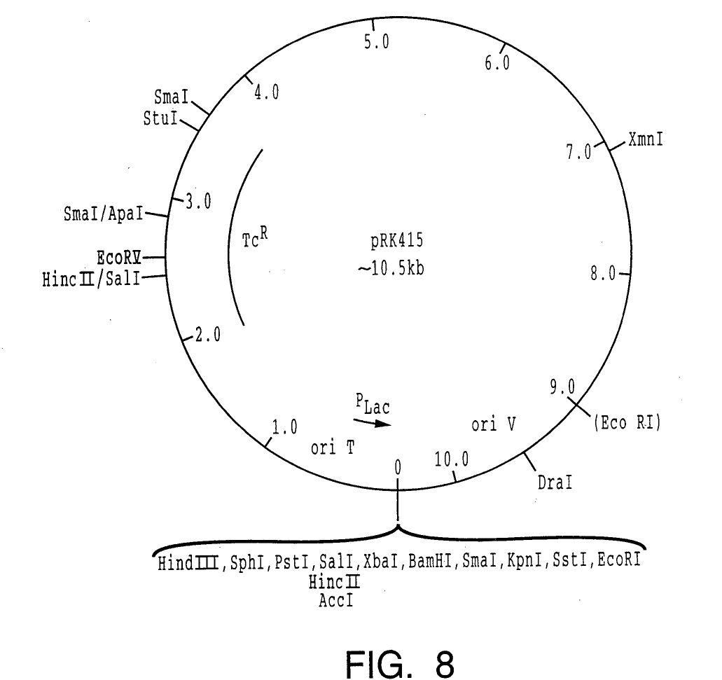

Plasmids used in this study include pLAFR3 for construction of the genomic cosmid library, pRK415 (FIG. 8) for construction of subclones and matings, and the pBluescript vector (Stratagene) for subcloning and preparation of DNA fragments.

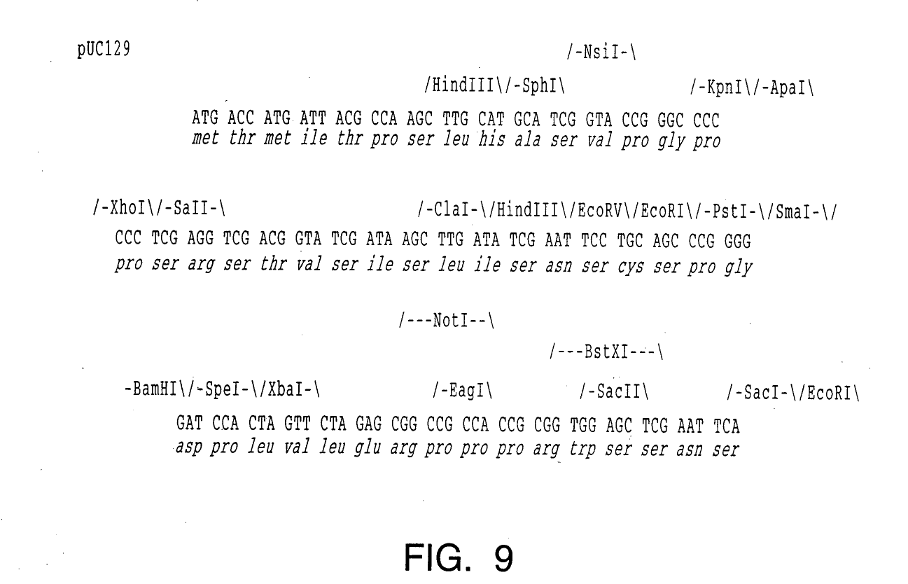

Ditta et al. (Plasmid 13:149-153, 1985) constructed the moderately-sized cloning vector pRK404 from pRK290. In order to increase the cloning usefulness of this plasmid, the EcoRI site outside the polylinker was deleted and the polylinker, derived from pUC9, was replaced by the pUC19 polylinker (FIG. 9). The resulting construct, pRK415 (FIG. 8), permits cloning into all of the polylinker restriction sites of pRK404 as well as the additional unique EcoRI, XbaI, KpnI and SstI sites. The SphI site of the pUC19 polylinker is not generally useful because an SphI site occurs elsewhere in the plasmid. The unique DraI, ApaI, SmaI and Eco RV sites are convenient for mapping the orientation of inserted DNA fragments into the polylinker sites. Since pRK415 retains the lac promoter of pRK404, bacterial genes inserted in the proper orientation into the polylinker should be expressed in E. coli. XGal color screening can also be used for plasmid constructions in E. coli. pRK415 has proven useful for subcloning and maintaining small DNA fragments in field isolates of P. syringae pv. glycinea and other P. syringae pathovars. If fragments larger than approx. 5 kb are cloned, however, from a few to more that 50% of the P. syringae exconjugants have been observed to suffer deletions in the inserted DNA.

The restriction map for pRK415 is shown in FIG. 8. This DNA was transformed into strain JM-101, a blue colony on XGal medium was retained and the resultant plasmid designated pRK415. The deleted EcoRI site is shown in brackets. Restriction sites separated by a slash occur close together.

Media

Strain T1 and all strains derived from T1 were grown on either Brain Heart Infusion (BHI, Difco Laboratories, Detroit, Mich.) medium or a mineral salts medium (vitamins and yeast extract omitted). Unless otherwise specified, toluene (0.3-0.5 mM) or pyruvic acid (5 mM) were used as the carbon source to supplement the minimal medium. Nitrate was supplied to a concentration of 10 to 20 mM unless otherwise specified. Plates always contained 2% Agar Noble (Difco Laboratories). Liquid media was prepared and placed in serum bottles which were then tightly stoppered with teflon coated butyl rubber and aluminum crimp seals. Anaerobic conditions were generated by evacuation and subsequent filling of the bottles with argon. This process was performed a total of four times. E. coli was grown in Luria-Bertani agar or broth (LB) or on BHI agar plates.

The antibiotics kanamycin (used at 50 mg/ml) and tetracycline (used at 25 mg/ml) were supplied where indicated. A 12.5 mg/ml stock of tetracycline was made in ethanol. Upon addition to minimal media the tetracycline served to select for the cosmid while the ethanol (final concentration of approximately 17 mM) served as the carbon source for the transconjugant strains.

Mutagenesis

Mutagenesis was carried out on strain T1 under aerobic conditions. Strain T1 was grown in a rich medium (BHI+nitrate), washed, and resuspended in 100 mM sodium citrate buffer (pH 5.5) to a cell density of about 3.5×10⁸ cells/ml. The cell suspensions were treated with nitrosoguanidine (final concentration of 50 μg/ml) and aliquots were removed at various times. The mutagenized cells were harvested by centrifugation and washed with 100 mM potassium phosphate buffer (pH 7.0) to remove the nitrosoguanidine and then resuspended in the phosphate buffer. The treated cells were tittered on BHI plates to establish a killing curve. The treatment group that resulted in about 50% killing was used for the isolation of mutants. Treated cells were diluted in phosphate buffer to yield 100-200 colonies per plate and spread onto minimal medium plates supplemented with nitrate and pyruvic acid. After 5 days of incubation (30° C. anoxic) colonies were replica plated to rich medium and minimal medium with nitrate and toluene supplied in the vapor phase. The plates were placed in an anaerobic incubation jar which was then sealed and filled with hydrogen gas (to 12 psi). In the presence of a palladium catalyst oxygen is removed by reaction with the hydrogen producing water and resulting in an anoxic atmosphere. After 5 days of anaerobic incubation (30° C.) colonies that grew on the rich medium but not on the minimal medium with nitrate and toluene were picked and streaked onto rich plates. The strains were retested for the ability to grow with toluene serving as the sole carbon source in both liquid and solid media. The strains were later tested for the ability to utilize toluene and produce the dead-end products phenylitaconic acid and benzylsuccinic acid in liquid culture.

Chemicals

Tetracycline was purchased from Fluka (Ronkonkoma, N.Y.). Kanamycin and N-methyl-N′-nitro-N-nitrosoguanidine (nitrosoguanidine) were obtained from Sigma (St. Louis, Mo.).

Construction of Cosmid Library

Strain T1 was grown in 500 ml of minimal+nitrate+ethanol medium under anaerobic conditions and genomic DNA was isolated. The DNA was purified by two successive CsCl gradient centrifugations. A partial digest of the DNA with Sau3AI enzyme was carried out and fragments of 15-25 kb were isolated on a 10-40% glycerol gradient. These fragments were ligated into the BamHI site of pLAFR3. The resulting ligation mix was packaged into phage heads using a Packagene kit from Promega (Madison, Wis.). E. coli strain HB101 was infected with the phage and plated onto LB+tetracycline plates. The resulting 750 colonies were streaked on plates of the same medium and the isolates served as the genomic library for obtaining the cosmid clone.

Triparental Mating

Triparental matings were carried out. Mutants of strain T1 were grown for 3 days in minimal+nitrate+pyruvic acid media. HB101 (or XL-1 Kan Blue) carrying the donor cosmid or plasmid was grown in LB+tetracycline overnight. HB101(pRK2013) was grown in LB+kanamycin overnight. One ml of each culture was centrifuged and resuspended in an equal volume of 100 mM phosphate buffer (pH 7). Ten μl of each culture was spotted (one on top of the other) onto a BHI+nitrate plate. After a three day incubation at 30° C. in an anoxic environment, the resulting growth was scraped off the plate, resuspended in phosphate buffer, and spotted onto a minimal agar plate containing pyruvic acid, nitrate, ethanol, and tetracycline to select for transconjugants. After another three day incubation, cells from the resultant growth were streaked onto the same media and grown in a sealed jar in the absence of oxygen. After three days of incubation, single transconjugant colonies were isolated from these plates and tested for complementation.

Restriction Mapping and Subcloning

DNA manipulations were carried out as described by Maniatis et al. All enzymes were obtained from New England Biolabs (Beverely, Mass.). Cosmid 13-6-4 was the original clone isolated. Plasmid pPWC1-HSma was constructed in two steps. The first step entailed deleting the HindIII fragment of 13-6-4 (from the HindIII site internal to the insert to the HindIII site (not shown in FIG. 1) in the pLAFR vector just beyond (to the right) the BamHI site) by digestion of 13-6-4 with HindIII and subsequent religation. The resulting cosmid (13-6-4-AH) was digested with the enzymes HindIII and SmaI and the 3.8 kb DNA fragment was isolated and inserted into HindIII-SmaI digested pBluescript. The HindIII-SmaI fragment was transferred to pRK415 by cutting both plasmids with the enzymes XbaI and KpnI and then isolating and ligating the fragments. The resulting plasmid was designated pPWC2-HSma (see FIG. 1). Plasmid pPWC1-Cₛ was constructed by cutting 13-6-4 with ClaI enzyme, isolating the small (3.3 kb) DNA fragment and inserting it into ClaI digested, calf intestinal alkaline phosphatase treated pBluescript. The ClaI fragment was transferred into pRK415 by cutting pPWC1-Cₛ and the vector with XbaI and KpnI enzymes (to generate pPWC2-Cₛ) or with KpnI and EcoRI enzymes (to generate pPWC2-Cₛ′, the reverse orientation of pPWC2-Cₛ) and ligating.

Restriction mapping was carried out with fragments inserted into the pBluescript vector to facilitate identification of restriction sites and to help place the sites on a restriction map. Digests were run on varying percentages of agarose gels with size standards to estimate the size of the fragments and to locate restriction sites.

Testing for Complementation

Cosmid clones and subclones constructed in pLAFR3 or plasmid subclones constructed in pRK415 were mated into the tutB-16 mutant background via the triparental mating technique. The resultant transconjugant strain was tested to determine if the subclone complements the mutation. First, the transconjugants were streaked onto minimal+nitrate plates in which toluene was supplied in the vapor phase. After 5-7 days of anaerobic incubation (30° C.), the subclones were scored for the ability to restore growth on toluene to the mutants. The transconjugants were also grown in sealed 50 ml serum bottles of minimal+nitrate (10 mM)+pyruvic acid (1 mM)+toluene (0.4 mM) liquid media with an argon headspace. After 3-4 days of incubation (30° C.) samples were withdrawn for toluene and dead-end product analysis (see below). The clones were scored for the ability to restore toluene utilization (in the presence of pyruvate) in liquid culture and for the ability to restore production of the dead-end metabolites under the same conditions to the mutants. If the transconjugate was positive for all three of these tests, the subclone was considered to complement the mutation.

Toluene Analysis

One ml samples of the culture to be tested were withdrawn anaerobically and added to 400 ml of pentane containing 1 mM fluorobenzene as an internal standard in a sample vial. One ml of the organic phase (into which toluene had been extracted) was injected using a CTC A200S autosampler (LEAP Technologies, Chapel Hill, N.C.) into an HP5890 gas chromatograph (Hewlett Packard, Palo Alto, Calif.) equipped with a Flame Ionization Detector, a DB-WAX column (J&W Scientific, Folsom, Calif.) and helium as the carrier gas. The injector temperature was set at 250° C., the detector at 300° C., and the column at 35° C. The amount of toluene present in each sample was quantified by comparison to external standards using the Chemstation software (Hewlett Packard).

Analysis of Dead-End Products

Samples of the culture were withdrawn anaerobically with a sterile syringe flushed with argon. The samples were centrifuged (5 min., microfuge) and the supernatant was filtered through a 0.45 μm filter (Millipore, Bedford, Mass.) into a sample vial. Samples were analyzed by high pressure liquid chromatography using a Beckman System Gold HPLC (Fullerton, Calif.) equipped with a Gilson (Middleton, Wis.) autosampler and a C18 column (250 mm by 4.6 mm, particle size 5 μm, Beckman) with UV detection at 260 nm. The mobile phase was 30:68:2 methanol:water:acetic acid (vol/vol) at a flow rate of 1 ml/min. Peaks were identified by comparison to the external standards benzylmaleic acid and benzylsuccinic acid.

Plasmid DNA Preparation

In general DNA plasmid minipreps were performed. When larger scale preps were needed, Qiagen maxi-preps were carried out (Qiagen, Chatsworth, Calif.) according to the manufacturer's instructions.

DNA Sequence Analysis

DNA was sequenced (both strands) by the dideoxy method of Sanger et al. with (α-³⁵S) dATP serving as the label. Sequenase enzyme (modified T7 polymerase) and reagents were obtained in a Sequenase kit from U.S. Biochemicals (Cleveland, Ohio). The Bluescript vector and the T3, T7, −20, and M13 reverse primers used for sequence analysis were obtained from Stratagene. An Erase-a-Base System (Promega, Madison, Wis.) was used to generate deletions of the cloned DNA inserted in the Bluescript vector for sequence analysis. Synthetic oligonucleotide primers were also purchased so that sequence data could be obtained to fill in gaps not covered by the deletions. Searches for protein sequence similarity were carried out against the Swissprot data base (release 32.0) of protein sequences using the FASTA and BLAST programs in the GCG software package (version 7.2) (GCG software, Madison, Wis.). Multiple sequence alignment was performed with the Lasergene software package from DNASTAR (Madison, Wis.).

RNA Preparation

In some embodiments of the present invention, wild type T. aromatica T1 cells were grown under denitrifying conditions on a mineral salts medium (vitamins and yeast extract omitted) with either pyruvate or toluene serving as the carbon source. When the density of the culture reached about 4×10⁷ cells/ml, 35 ml of the culture was processed using the RNeasy mini kit from Qiagen according to the manufacturer's instructions. Samples were run on a gel to confirm that there was no RNA degradation.

Northern Blot Analysis

In some examples recited wherein, between 0.25 and 1 μg of total RNA was run on a agarose gel containing formaldehyde. Ethidium bromide was added to each RNA sample to a final concentration of 31 μg/ml before denaturation and loading to allow visualization of the RNA without affecting the efficiency of RNA transfer to the membrane. After electrophoresis, the gels were treated with 0.05 N NaOH for 30 min; 0.1 M Tris pH 7.5 for 30 min; and 10×SSC (1×SSC is 0.15 M NaCl and 0.015 M sodium citrate) for 30 min. RNA was transferred to a Hybond-N Membrane (Boehringer Mannheim, Indianapolis, Ind.) by capillary blotting over night. The RNA was cross-linked to the membrane by baking at 80° C. for at least 1 hr in a vacuum oven. Antisense, digoxigenen-labeled, gene specific DNA probes spanning nucleotides 97 to 398 of the predicted tutD coding region (302 nucleotides), 106 to 792 of the predicted tutE coding region (687 nucleotides), 14 to 152 of the predicted tutF coding region (139 nucleotides), 36 to 241 of the predicted tutG coding region (206 nucleotides), and 59 to 470 of the predicted tutH coding region (412 nucleotides) and 234-555 of the predicted tutI coding region (322 nucleotide) were made by PCR. Prehybridization was performed at 42° C. for at least 1 hr in DIG Easy Hyb solution (Boehringer Mannheim). The probe was heated to 95° C. and then added to the prehybridization mix at a final concentration of about 50 ng/ml. Hybridization was continued overnight at 42° C. The blots were washed twice with 2×SSC, 0.1% SDS (5 min, room temperature) and twice with 0.5×SSC, 0.1% SDS (15 min, 65° C.). The probes were visualized on BioMax ML film (Eastman Kodak, Rochester, N.Y.) using the DIG High Prime DNA Labeling and Detection Starter Kit II (Boehringer Mannheim) according to the manufacturer's instructions with the chemiluminescence substrate CSPD. Digoxigenin-labeled RNA (Boehringer Mannheim) was also loaded on the gel to serve as a size marker.

Primer Extension Analysis

The Primer Extension System-AMV Reverse Transcriptase kit (Promega, Madison, Wis.) was used according to the manufacturer's instructions. About 2.5 μg of total RNA was used for each reaction. Primers F-PE1 (CTG CTT GCA TGT GGT GGT TC) (SEQ ID NO:51) binding from 4 to 23 bp downstream of the translational start and E-PE3 (GAT CCA CCA CGA CCA TAG AAG) (SEQ ID NO:52) binding 5 bp upstream to 15 bp downstream of the translational start were labeled with T4 polynucleotide kinase (New England Biolabs, Beverly, Mass.) and (γ-³²P) ATP (New England Nuclear, Boston, Mass.). The labeled primers were used for both the primer extension reaction and for the sequencing ladder. The primer extension reaction products and the sequencing ladder were run on a standard 8M urea 5% polyacrylamide sequencing gel.

Nuclease Protection Assay

The Multi-NPA RNA/DNA/Oligo Probe Protection Assay Kit (Ambion, Austin, Tex.) was used according to the standard protocols recommended by the manufacturer. About 5 μg of total RNA was used for each reaction. Antisense gene specific DNA probes of 354 bases (for tutE) or 623 bases (for tutF) spanning both the predicted transcriptional and translational start sites were synthesized by PCR (17) and labeled with T4 polynucleotide kinase (New England Biolabs) and (g-³²P) ATP (New England Nuclear). About 3×10⁵ cpm of the probe was added to assay mix. After completion of the reaction, the products were run on a 8 M urea 5% polyacrylamide gel.

Site-Directed Mutagenesis

The QuickChange site directed mutagenesis kit (Stratagene) is used to make mutations in the tutD gene. To change the a glycine to an alanine, primers G828AF (GTGCGCGTTTCCGCCTACAGCGCTC) (SEQ ID NO: 41) and G828AR (GAGCGCTGTAGGCGGAAACGCGCAC) (SEQ ID NO: 42) are synthesized and used as directed. Plasmid pPWC3-C_{L}-SacII serve as the target for the mutagenesis. The resulting plasmids are sequenced to identify those containing the desired mutation. The 4.9 kb SacI/SacII fragment of three plasmids with the correct change are subcloned into plasmid pRK415 and used to test for complementation of the tutD17 mutation. To change the cysteine at position 492 to an alanine primers C492AF (CAACGTGCTGGCCATGTCGCCCGGCATCC) (SEQ ID NO: 53) and C492AR (GGATGCCGGGCGACATGCCCAGCACGTTG) (SEQ ID NO: 54) are synthesized and used in the same manner described above.

Construction of Chromosomal Deletions

The individual tut genes were deleted from the chromosome as follows. The pBluescript vector carrying a majority of the tutE tutFDGH gene cluster was used as starting material for the ExSite deletion kit (Stratagene). Oligonucleotide primers were designed to delete 141 bp of the tutF gene (78.3%), 454 bp of the tutD gene (17.5%) or 225 bp of the tutG gene (92.6%) and to insert a unique restriction site (see, Table 2). A Km^{R} cassette was then inserted into the engineered restriction site such that its reading frame was opposite that of the tut gene cluster. The resulting plasmids were electroporated into wild-type T. aromatica T1, selected for Km^{R} and screened for Ap^{S}.

Replacement of the wild-type gene with the deleted gene was confirmed by PCR using primers flanking the deleted region and either within the deleted region or within the kan gene, and genomic sequencing using the Thermo Sequenase radiolabeled terminator cycle sequencing kit (USB). These deletion strains were then assayed for toluene utilization as described below.

TABLE 2

Oligonucleotide primers

| | | |
|---|---|---|
| Primer | Sequence | Location |

Construction of deletions
tutF

| | | |
|---|---|---|
| D2-N | TCTAGAGTGGTTCCCATGGATGAGTC | 5′end |
| D2-C | GTGAAGCCTTTCAAACGAAGC | 3′end |
| tutD | | |
| DD-NX^{a} | TAGACTTACGATGTCGTTCATGG | 5′end |
| DD-N^{b} | GCATGCTTACGATGTCGTTCATGGC | 5′end |
| DD-C.4 | GAATACTGGAAGCCGCATAGC | internal |
| tutG | | |
| D4-N2 | CCATGTTGCTGCCCTCCATG | 5′end |
| D4-C | TCTAGAACACCGGACAGACGTGG | 3′end |

Test for recombination

| | | |
|---|---|---|
| BF1 | GAGTTGCACGAGCATCTGC | tutD (forward) |
| BF2 | CAGACTGCGTGCGGGAAAAG | tutF (forward) |
| BP2 | GCAGATGCGTGTTTCCAGCG | tutD (reverse) |
| GPE1 | GTTTGCCATTTGCAACTCCG | tutG (reverse) |
| NC1 | CTCGCCGGGAATGACGAAAC | tutH (reverse) |
| TL1 | CTCTTCCCCCAGGCCATCC | tutH (forward) |

^{a}Used to construct the in-frame deletion.
^{b}Used to construct the chromosomal deletion.

Construction of Plasmid-Borne In-Frame Deletions

The ExSite deletion kit (Stratagene) was used to construct in-frame tut deletions in a tutE tutFDGH fragment carried in the pBluescript vector essentially as described above except for tutD, in which the deleted region had to be shifted one base to keep the product in-frame. After the deletion was confirmed by sequencing, an approximately 400 bp DNA fragment carrying the absent upstream region of tutE and an engineered Pac I restriction site was added to the 5′ end of the construct. An approximately 2 kb DNA fragment containing the end of the tutH gene, additional downstream DNA, and an engineered Pac I restriction site was added to the 3′ end of the construct. The fragments carrying the entire tutE tutFDGH gene cluster with individual in-frame deletions were subcloned into an engineered Pac I site of pRK415 for subsequent conjugal transfer into various strains of T. aromatica T1. The resulting plasmids were pPWC-314 (wild-type), pPWC-314-ΔtutF (carrying the tutF deletion), pPWC-314-ΔtutD (carrying the tutD deletion) and pPWC-314-ΔtutG (carrying the tutG deletion).

Assay for Recombination

Cells grown for analysis of toluene utilization and production of metabolic intermediates were also sampled to confirm that complementation and not recombination or some other event had occurred. Two microliters of culture were added to a PCR reaction containing primers (see, Table 2) located either within the deleted regions or downstream (to serve as a control). The ThermalAc DNA polymerase kit (Invitrogen) was used to amplify the fragments in a final reaction volume of 25 ml. The products were electrophoresed through a gel containing either 1% agarose (for products greater than 1 kb) or 1% agarose and 1% MetaPhor agarose (FMC BioProducts; for products smaller than 1 kb).

### EXAMPLE 1

This example describes the isolation and characterization of tut mutants. Cells of strain TI were grown and mutagenized with nitrosoguanidine as described above. Mutants were isolated from the treatment group that resulted in about 50% killing. Cells were diluted and plated onto minimal medium supplemented with nitrate and pyruvic acid to a density of about 100-200 colonies per plate. After about 5 days of incubation at 30° C. in the absence of oxygen the colonies were replica plated to both rich medium and minimal medium with nitrate and with toluene supplied in the vapor phase. After incubation, colonies that grew on the rich medium but failed to grow on the minimal medium with nitrate and toluene were chosen for further study. Of about 10,000 colonies screened, 32 candidates were isolated in this manner. These 32 mutant candidates were again tested for their ability to grow on minimal medium supplemented with nitrate and toluene both in liquid and on plates. Retesting the candidates identified seven mutants which were truly defective for toluene utilization. These seven were designated tut mutants for their defect in toluene utilization.

The seven tut mutants were tested for their ability to grow on various carbon sources. Four of the mutants are able to use benzoic acid and phenylpropionic acid as a sole carbon source while three are not able to use either substrate. Based on this observation, the first group is predicted to be blocked early in the toluene utilization pathway and were designated tutB mutants. The second group is blocked later in the pathway, probably in benzoic acid utilization. This group was designated tutA. These designations are not meant to imply that all mutants in a particular group are defective in the same gene or in the same step of the pathway, only that they utilize the same range of substrates.

The tut mutants were also tested for their ability to metabolize toluene when provided with both toluene and pyruvic acid in liquid media. Pyruvic acid was added to insure that the transconjugants grew and that there was no selective pressure for reversion of the mutation to occur. Although the tutB-16 mutant metabolized toluene slightly, none of the tutB mutants tested were able to metabolize toluene to the same extent as the wild type control. Similarly, the tutB mutants did not produce significant amounts of the dead-end products benzylsuccinic acid and phenylitaconic acid. Members of the tutA class of mutants were able to both metabolize toluene and produce the dead-end products. This result indicates that the tutB mutants are blocked in a step (or steps) that is common to both the metabolic degradation of toluene and the side reaction that produces the dead-end compounds or in the regulation of such a step (or steps).

### EXAMPLE 2

This example describes the generation of TI DNA library and the isolation of a clone that complements the tutB-16 mutant. It has previously been shown that pLAFR3 derived cosmids can be transferred into and stably maintained in the strain T1 background. Consequently, this vector was chosen for the construction of a genomic DNA library of strain T1. Genomic DNA was isolated from strain T1 as described above. A partial digest of the genomic DNA was carried out with the restriction enzyme Sau3AI and fragments of between 15 and 25 kb were isolated. These fragments were ligated into the BamHI site of pLAFR3. The resulting ligation mix was packaged into lambda phage heads and used to infect E. coli strain HB101. About 750 tetracycline resistant E. coli colonies were picked and formed the genomic library used to isolate clones that complement the tut mutations.

The genomic T1 library constructed in pLAFR3 was introduced into a T1 derived strain carrying the tutB-16 mutation via a triparental mating. The donors for all the cosmids were E. coli strain HB101 derived strains, while E. coli HB101 carrying plasmid pRK2013 served as the helper to mobilize the cosmids. Transconjugants were selected on minimal medium supplemented with nitrate, pyruvic acid, and tetracycline and then screened for the ability to grow with toluene serving as the sole carbon source. One cosmid, designated 13-6-4, restored the ability of the tutB-16 carrying T1 strain to grow on toluene. This cosmid also restored the ability of the mutant strain to metabolize toluene in the presence of pyruvic acid in liquid culture and produce the dead-end products benzylsuccinic acid and phenylitaconic acid in this culture. This cosmid was used for further subcloning and restriction mapping to specifically identify the region containing the complementing gene.

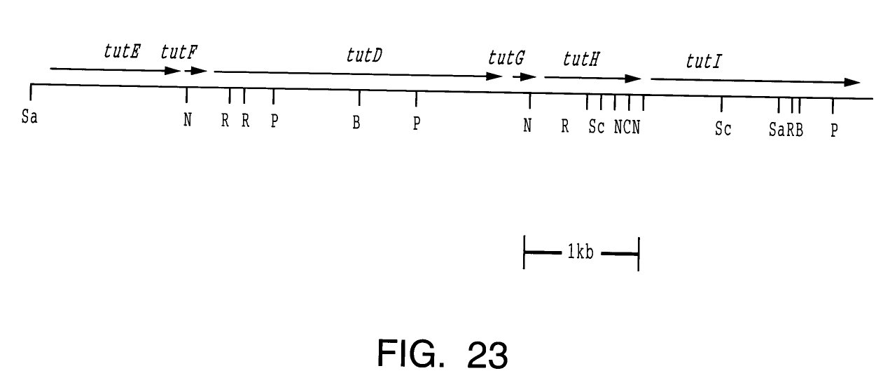

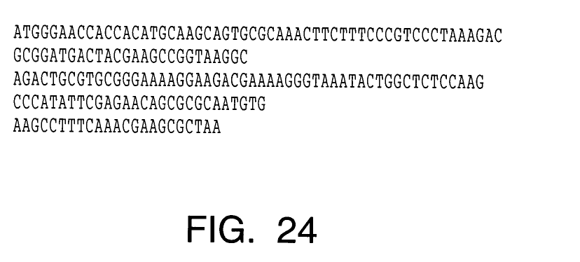

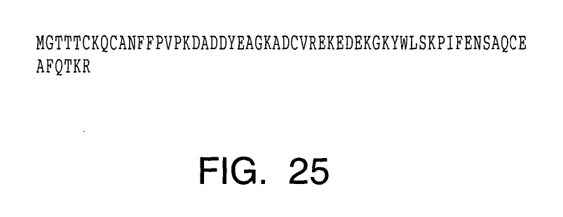

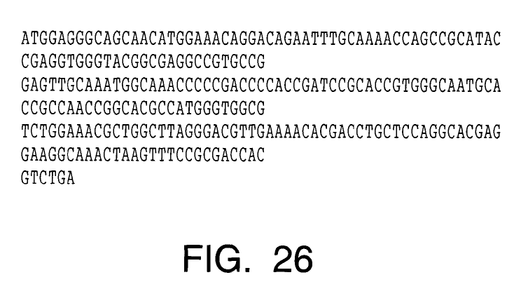

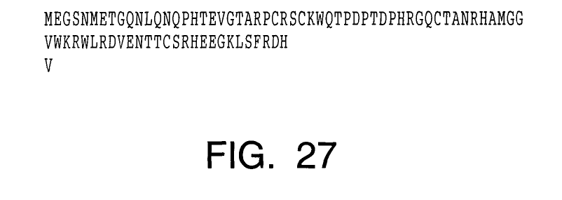

In an effort to determine where on the cosmid the fragment that complements the tutB-16 mutation lies, deletions and subclones were constructed. All subclones were made in plasmid pRK415, a broad host range tetracycline resistance vector that can be conjugatively transferred into the T1 background in the same manner as pLAFR3 and is stably maintained in this background. FIG. 1 shows a restriction map of cosmid 13-6-4. The relevant region of the cosmid is shown in more detail. The figure includes a number of subclones that were constructed in an effort to identify the region of the cosmid that contains the complementing gene. Additionally, FIG. 23 presents a restriction map of the region of cosmid clone 13-6-4 that contains the tutEtutFDGHI genes.

Complementation tests were performed for the various subclones shown in FIG. 1 when mated into a T1 strain carrying the tutB-16 mutation. Complementation was assayed in three ways: (1) the ability to grow with toluene serving as the sole carbon source on solid media, (2) the ability to metabolize toluene in the presence of pyruvic acid in liquid media, and (3) the ability to produce the dead-end products benzylsuccinic acid and phenylitaconic acid from toluene in liquid media. The original clone and all complementing subclones were positive (i.e., behaved just as the wild type strain) in all three assays.

The small 3.3 kb ClaI fragment of 13-6-4 when inserted into pRK415 in either orientation is able to complement the tutB-] 6 mutation. Subclones constructed that do not contain this entire region do not complement this mutation. These results indicate that this 3.3 kb fragment is sufficient to replace the missing activity in the tutB-16 mutant strain.

### EXAMPLE 3

This example describes the sequence analysis of the tutCB region. The complete nucleotide sequence of the 3.3 ClaI fragment of 13-6-4 (containing the tutB gene) was determined in both orientations. Analysis of this sequence revealed the presence of a second open reading frame (designated tutC) upstream of the tutB gene. As a result, the sequence was extended to a SacII site about 3 kb upstream of the ClaI site. FIG. 2 presents the complete 6393 bp nucleotide sequence of the tutCB region. The protein translation of the two genes are presented below the DNA sequence in the figure. The TutC protein is 979 amino acids long with a calculated molecular mass of 108.0 da and a calculated pI of 5.2, while the TutB protein is 218 amino acids long with a calculated molecular mass of 24.3 da and a calculated pI of 7.9.

Goldman-Engleman-Steitz hydropathicity analysis failed to detect any membrane spanning regions in either protein but Kyte-Doolittle analysis suggested two possible membrane spanning regions in the TutC protein, amino acids 367-399 and 489-508 (data not shown). The translation of the tutB gene is shown as over-lapping the sequence of the tutC gene by 13 nucleotides. This methinone was chosen as likely to be the first amino acid in the sequence based on the location of a potential Shine-Dalgarno sequence and protein similarity analysis.

The protein sequence of the tutC gene product was compared to the Swissprot protein data base in an effort to identify other proteins with homologous sequences. The results of this analysis are presented in FIG. 4. The TutC protein shows significant sequence similarity to sensor members of the two component family of signal transduction proteins, a set of bacterial regulatory proteins in which one member senses the environmental conditions of the microorganism and transmits a signal (via phosphorylation) to the other member (a DNA binding protein). The five proteins, all sensor proteins, with the greatest sequence similarity to the tutC gene product are included in FIG. 4. These proteins (and their percent identity to the tutC gene product) are the products of the nodV gene of Bradyrhizobium japonicum (36%), fixL gene of B. japonicum (33%), Azorhizobium caulinodans (30%), and Rhizobium meliloti (30%), and detS gene of Rhodobacter capsulatus (33%).

In a similar manner, the sequence of the tutB gene product was compared to the Swissprot protein data base in an effort to identify other proteins with homologous sequences. The results of this analysis are presented in FIG. 3. The TutB protein shows significant sequence similarity to DNA binding protein members of two component sensor/regulator families. These proteins (and their percent identity to the tutB gene product) are the products of the nodW gene of B. japonicum (48%), the fixJ gene of B. japonicum (38%), A. caulinodans (37%), and R. meliloti (39%), and the dctR gene of R. capsulatus (38%). Because the similarity between these proteins and TutB extends nearly to the methionine that over-laps the tutC gene product, it is believed that translation begins at this over-lapping methionine. Based on the results of the sequence similarity analysis and the previous result that the toluene utilization pathway of strain T1 is inducible, the tutB and tutC gene products are likely involved in the regulation of gene expression (specifically toluene metabolic genes) in response to toluene.

### EXAMPLE 4

This example describes the identification and cloning of the tutD and tutE genes. One class of mutants, the tutB class, are unable to grow with toluene serving as the sole carbon source but was able to grow when provided with benzoate. These mutants are also unable to metabolize (at wild type levels) toluene when provided with pyruvate and were unable to produce (at wild type levels) benzylsuccinic acid and a monounsaturated derivative from toluene in liquid media (P. J. Evans, et al., “Metabolites formed during anaerobic transformation of toluene and o-xylene and their proposed relationship to the initial steps of toluene mineralization” Appl. Environ. Microbiol. 58:496,1992). Hence, it is determined this class of mutants is blocked early in the toluene utilization pathway. A cosmid with a genomic insert of approximately 20 kb (cosmid 13-6-4) is isolated for its ability to complement the tutB16 mutation (P. W. Coschigano, et al., “Identification and sequence analysis of two regulatory genes involved in anaerobic toluene metabolism by strain T1” Appl. Environ. Microbiol. 63:652,1997). This original cosmid clone, along with a number of subclones generated in the characterization of the tutB gene, are tested for their ability to complement the mutations referred to as tutB17 and tutB21, which have phenotypes similar to the tutB16 mutation. These mutations are placed in new complementation groups and are designated tutD17 and tutE21.

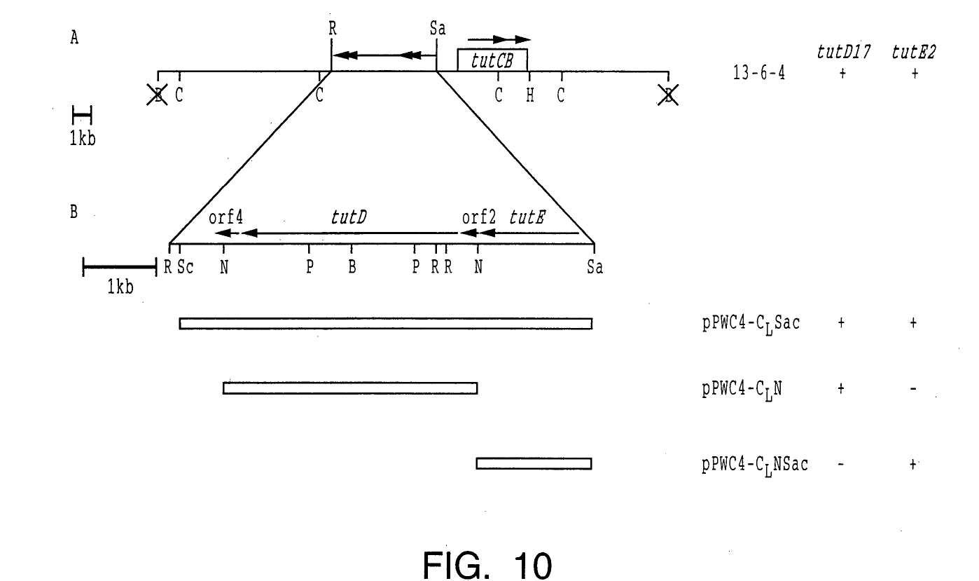

Determining where on the cosmid the fragments that complement the tutD17 and tutE21 mutations are located, a series of subclones are constructed. Subclones are made in plasmid pRK415, a broad host range tetracycline resistant vector that can be conjugatively transferred into the T1 background. FIG. 10 shows a restriction map of cosmid 13-6-4 and a schematic representation of three of the subclones. Each subclone is tested for its ability to complement the tutD17 and tutE21 mutations. Complementation was assayed in three ways: (1) the ability to grow with toluene serving as the sole carbon source on solid media, (2) the ability to metabolize toluene in the presence of pyruvic acid in liquid media, and (3) the ability to produce benzylsuccinic acid and a monounsaturated derivative from toluene in liquid media. P. J. Evans, et al. Metabolites formed during anaerobic transformation of toluene and o-xylene and their proposed relationship to the initial steps of toluene mineralization. Appl. Environ. Microbiol. 58:496(1997). Restoration of the wild type phenotype in all three assays is required in order for the subclones to be considered as complementing the mutation.

As shown in FIG. 10B, the tutD17 mutation and the tutE21 mutation are complemented by mutually exclusive subclones. The 3.0 kb NcoI fragment of 13-6-4 (pPWC4-C_{L}N) is able to complement the tutD17 mutation but not the tutE21 mutation.

Conversely, the adjacent 1.3 kb NcoI/SacII fragment (pPWC4-C_{L}NSac) is able to complement the tutE21 mutation but not the tutD17 mutation. These data suggest the 3.0 kb NcoI fragment is sufficient to replace the missing activity in the tutD17 mutant strain and the 1.3 kb NcoI/SacII fragment is sufficient to replace the missing activity in the tutE21 mutant strain; thereby confirming the mutations belong to distinct complementation groups.

### EXAMPLE 5

This example describes the complete nucleotide sequence of the 4905 bp SacII/EcoRI fragment of cosmid 13-6-4 (containing the tutD and tutE genes), as determined for both strands. This nucleotide sequence has been deposited in the GenBank (accession number AF036765). Analysis of this sequence reveals the presence of four open reading frames on the same strand of DNA. The first open reading frame, present between the SacII and NcoI sites (subclone pPWC4-C_{L}NSac) and corresponding to the tutE gene, is a sequence of 375 amino acids. The TutE protein has a calculated molecular mass of 41,300 Da and a predicted pI of 6.8.

Two open reading frames are identified on the 3.0 kb NcoI fragment immediately downstream of the tutE gene (subclone pPWC4-CAN). The first of these two open reading frames (designated open reading frame 2) consists of a 60 amino acid sequence which would code for a protein with a calculated molecular mass of 6,900 Da and a predicted pI of 5.2. The translational start begins at the NcoI restriction site and hence no upstream transcriptional regulatory sites or ribosome binding sites for this open reading frame are included on this fragment. Therefore, it is highly unlikely that this open reading frame is responsible for the complementation of the tutD17 mutation observed with this subclone. This observation, along with evidence from the site-directed mutagenesis experiments indicates that ORF2 is not the tutD gene.

The second open reading frame in this fragment is 864 amino acids in length with a calculated molecular mass of 97,600 Da. The predicted pI of this protein is 6.0. Results from the site-directed mutagenesis clearly show that this open reading frame corresponds to the tutD gene.

The fourth, open reading frame (designated open reading frame 4) identified in the SacII/EcoRI fragment consists of a sequence of 81 amino acids with a calculated molecular mass of 9,300 Da and a predicted pI of 7.8. The pPWC4-CAN subclone removes approximately 50% of the C-terminal end of this protein. This result, in conjunction with the evidence presented regarding the third open reading frame, indicates that this 81 amino acid protein is not the tutD gene product.

### EXAMPLE 6

This example describes homologies between the protein sequence of the tutD and tutE gene product and proteins in the Genbank protein database. The BLAST program identified a number of similar proteins, all of which are identified as either pyruvate formate-lyases (formate acetyl transferases) or pyruvate formate-lyase homologues. Interestingly, the sequences showing the highest degree of similarity with TutD are the E. coli proteins f810 (27% identical to TutD as calculated by the BLAST program) and PflD (26% identical to TutD), both pyruvate formate-lyase homologues (F. R. Blattner, et al., “Analysis of the Escherichia coli genome. IV. DNA sequence of the region from 89.2 to 92.8 minutes” Nucleic Acids Res. 21:5408,1993; F. Blattner, et al, “The complete genome sequence of Escherichia coli K-12” Science (Wash. D.C.) 277:1453,1997).

The sequence similarities between TutD and these two proteins plus PflB (22% identical to TutD), a pyruvate formate-lyase from E. coli, are shown in FIG. 11 (R. Rabus, et al., “Complete oxidation of toluene under strictly anoxic conditions by a new sulfate-reducing bacterium” Appl. Environ. Microbiol. 59:1444, 1993; A. F. Wagner, et al. “The free radical in pyruvate formate-lyase is located on glycine-734” Proc. Natl. Acad. Sci. USA. 89:996,1992). As can be seen in FIG. 11, the most conserved region is in the carboxyl end of these proteins. There is a highly conserved region around the glycine residue at position 828 of TutD (marked with an asterisk). In the E. coli pyruvate formate-lyase, this glycine has been shown to form a free radical which is essential for enzymatic function. Additionally, in a less conserved region there is a cysteine residue at position 492 of TutD (marked with a dagger) that has been shown to transiently form a covalent bond with the acetyl group that is being transferred, an action which is also essential to enzyme function (A. Ogiwara, et al., “Construction and analysis of a profile library characterizing groups of structurally known proteins” Protein Sci. 5:1991, 1996; W. Rodel, et al., “Primary structure of Escherichia coli pyruvate formate-lyase and pyruvate formate-lyase activating enzyme deduced from the DNA nucleotide sequences” Eur. J. Biochem. 177:153,1988). While it is not intended that the instant invention be limited to any one mechanism, the results of this protein sequence similarity analysis suggest a mechanism for TutD where glycine-828 forms a free radical which is necessary for the transient formation of a covalent bond between cysteine-492 and the compound (possibly acetate or fumarate) that is being transferred to the methyl group of toluene (or a toluene metabolite). This mechanism may involve a transient cysteine radical at an undetermined location, as proposed in the E. coli pyruvate formate-lyase system (A. F. Wagner, et al., “The free radical in pyruvate formate-lyase is located on glycine-734” Proc. Natl. Acad. Sci. USA. 89:996, 1992).

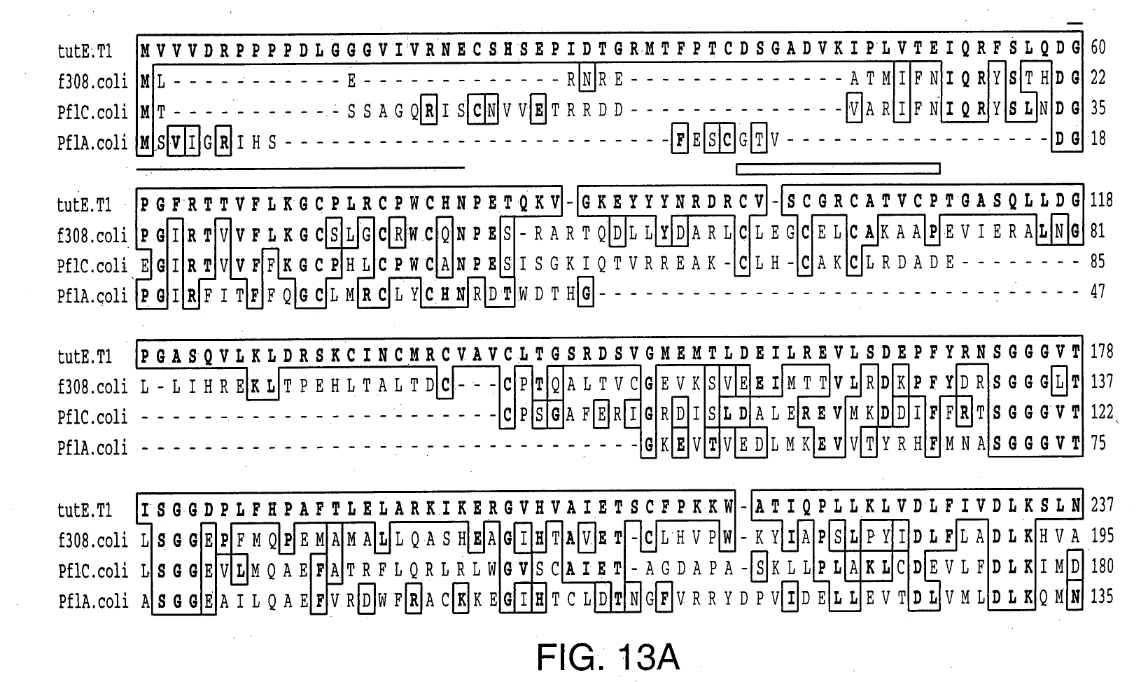

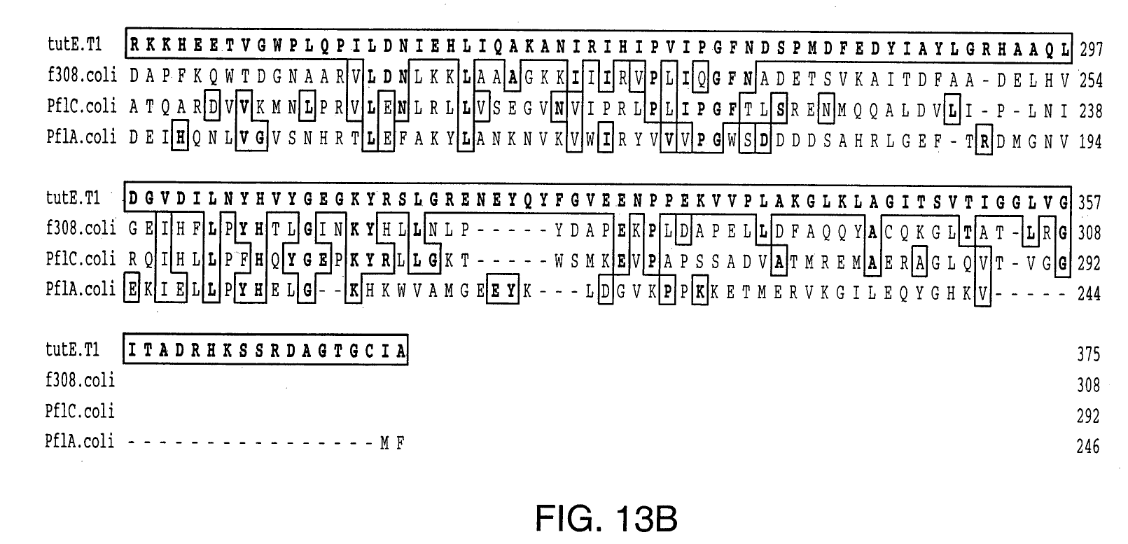

A similar search was performed with the protein sequence of the tutE gene product. The proteins with the highest homology are identified as pyruvate formate-lyase activating enzymes or pyruvate formate-lyase activating enzyme homologues. The sequence similarities between TutE and f308 (34% identical to TutE as calculated by the BLAST program), PflC (32% identical to TutE), and PflA (28% identical to TutE) (all from E. coli) are shown in FIG. 13. Subsequent subjection of the TutE protein sequence to a Motif analysis identified a radical activating region from amino acids 60 to 81 (labeled with a line over it in FIG. 13). This region which contains potential Fe binding sites (as identified by the Motif analysis) is conserved in the pyruvate formate-lyase activating enzymes. Additionally, the analysis revealed a 4Fe-4S binding domain typically found in ferredoxins (amino acids 98 to 109, labeled with a box over it in FIG. 13). This region is not very well conserved in the E. coli pyruvate formate-lyase activating enzyme and homologues. PflA is missing this region and both f308 and PflC have alterations to the spacing or sequence. The results of this protein sequence similarity analysis are consistent with the predicted role of TutE serving as the activator for TutD and suggest that the activation may involve iron and/or iron-sulfur binding.

### EXAMPLE 7

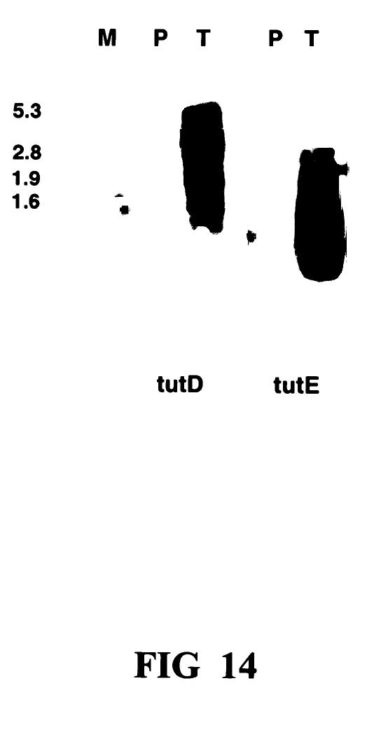

This example describes various protocols to examine the regulation of the tutD and tutE genes. To confirm that tutD and tutE genes are regulated in response to toluene, a Northern blot analysis is performed. Wild type cells of strain T1 are grown in liquid media containing either pyruvate or toluene as the carbon source. RNA is isolated from both of these cultures and subjected to Northern analysis. About 1 micro gram of total RNA from each culture is loaded in each of two lanes on a 1% gel. After electrophoresis the RNA is transferred to a nylon membrane and cut in two. One set of RNA is hybridized to a tutD probe while the other was hybridized to tutE probe. FIG. 14 shows that only cells grown with toluene as the carbon source have tutD and tutE mRNA. It can also be seen that the size of the two messages differ, indicating that the two genes are not contained in one polycistronic mRNA. The fact that both genes are regulated by toluene suggests that common regulatory protein binding sites is upstream of these and possibly other toluene metabolic genes.

### EXAMPLE 8

This example describes the site-directed mutagenesis of TutE protein. Specifically, two cysteine are individually changed to an alanine in an effort to determine if the conserved potential Fe binding site (as identified by the Motif analysis) of TutE plays a role in the enzymatic function of the protein. Three independent isolates of the resulting plasmids (pPWC-C_{L}NSac-C72A, pPWC4-C_{L}NSac-C79A, and pPWC4-C_{L}NSac-C101A) are mated into the strain carrying the tutE21 mutation and the resulting transconjugants are then tested for their ability to complement the mutation. The plasmid carrying the unaltered clone (PPWC-C_{L}NSac) fully complements the tutE21 mutation (utilizing 100% of the toluene provided in the presence in of pyruvate and produces wild type levels of benzylsuccinic acid and a monounsaturated derivative). Neither of the altered plasmids pPWC4-C_{L}NSac-C72A and pPWC4-C_{L}NSac-C79A are able to complement the tutE21 mutation (see Table 3). both of these strains utilize about the same amount of toluene as is utilized by the mutant carrying plasmid pRK415, the vector alone. Likewise, they produce significantly less benzylsuccinic acid and a monounsaturated derivative than the tutE21 mutant strain carrying the unaltered plasmid pPWC4-C_{Sac}. In fact, they produce about the same amount of these compounds as the mutant carrying plasmid pRK415. Therefore, the results in Table 3 clearly demonstrate that cysteine 72 and cysteine 79 are essential for function of the TutE protein. Thus, while it is not intended that the present invention be limited to any one mechanism, the role of iron binding appears to be a mechanistic feature of the TutE protein in its role in toluene metabolism by strain T1.

TABLE 3

| | Percent | Percent benzylsuccininic acid |
|---|---|---|
| Plasmid | toluene utilized | like compound produced^{c} |
| pPWC4-C_{L}NSac^{a} | 100 | 100 |
| pRK415^{b} | 31.3 ± 5.4 | 8.6 ± 1.2 |
| pPWC4-C_{L}NSac-C72A | 19.5 ± 7.4 | 8.3 ± 0.8 |
| pPWC4-C_{L}NSac-C79A | 31.3 ± 13.8 | 7.8 ± 1.9 |
| pPWC4-C_{L}NSac-C101A | 88.8 ± 13.8 | 55.7 ± 6.1 |

^{a}the plasmid carrying the unaltered clone, serving as a positive control.
^{b}the vector alone, serving as a negative control.
^{c}normalized to 100% for pPWC4-C_{L}NSac, the positive control.

### EXAMPLE 9

This example describes the site-directed mutagenesis of TutD protein. To determine if the conserved glycine and cysteine residues of TutD play an essential role in the enzymatic function of the protein has been shown for PflB, both amino acids are individually changed to an alanine as described in materials and methods. W. Planau, et al. Catalytic-site mapping of pyruvate formate lyase. Eur. J. Biochem. 178:445(1988), W. Rödel, et al. Primary structure of Escherichia coli pyruvate formate-lyase and pyruvate formate-lyase activating enzyme deduced from the DNA nucleotide sequences. Eur. J. Biochem. 177:153(1988). Three independent isolates of the resulting plasmids (pPWC4-C_{sac}-G828A and pPWC4-C_{sac}-C492A) are mated into the strain carrying the tutD17 mutation and the resulting transconjugants are then tested for their ability to complement the mutation. The plasmid carrying the unaltered clone (pPWC4-C_{Sac}) fully complements the tutD17 mutation (utilizes 100% of the toluene provided in the presence of pyruvate and produces wild type levels of benzylsuccinic acid and a monounsaturated derivative). Neither of the altered plasmids pPWC4-C_{sac}-G828A nor pPWC4-C_{Sac}-C492A are able to fully complement the tutD17 mutation (see Table 4).

Both of these strains utilized about the same amount of toluene as was utilized by the mutant carrying plasmid pRK415, the vector alone. Likewise, they produce significantly less benzylsuccinic acid and a monounsaturated derivative than the tutD17 mutant strain carrying the unaltered plasmid pPWC4-C_{Sac}. The mutant carrying plasmid pPWC4-C_{sac}-C492A produced about the same amount of these compounds as the mutant carrying plasmid pRK415, while the strain carrying plasmid pPWC4-C_{sac}-G828A show higher levels of these compounds than the vector alone but levels much lower than observed with the unaltered plasmid. Since the E. coli pyruvate formate-lyase is known to be a homodimer which requires the formation of only one glycine free radical, the small amount of activity observed in the mutant carrying plasmid pPWC4-C_{Sac}-G828A may be due to mixed dimers where the free radical forms on the defective chromosomally encoded TutD protein. A. F. Wagner, et al., The free radical in pyruvate formate-lyase is located on glycine-734. Proc. Natl. Acad. Sci. USA. 89:996(1992). The results in Table 4 clearly demonstrate that glycine 828 and cysteine 492 are essential for function of the TutD protein. While it is not intended the present invention be limited to any one mechanism, the role of a glycine free radical and a covalent substrate-cysteine bond appear to be important mechanistic features of the TutD protein in its role in toluene metabolism by strain T1.

From the above, it should be clear that the present invention provides genes encoding toluene degrading enzymes useful for bioremediation. The genes can be used with an expression vector to over-express the enzymes in a host. In addition, the genes can be used to confer the ability of toluene degradation in an host organism that was not otherwise able to degrade toluene. In this manner, an organism that is native to a waste source (and therefore adapted for competition in the waste source) can be modified to have toluene degrading capabilities. In addition, an organism that is adapted to the laboratory that can overexpress the enzyme in large amounts can be made and used to provide a more efficient system of bioremediation (both in situ and ex-situ).

TABLE 4

| | | Percent monounsaturated |
|---|---|---|
| | Percent | benzylsuccinic acid derived |
| Plasmid | toluene utilized | compound produced^{c} |
| pPWC4-C_{Sac}^{a} | 100 | 100 |
| pRK415^{b} | 23.5 ± 6.4 | 1.3 ± 0.1 |
| pPWC4-C_{Sac}-G828A | 34.2 ± 9.7 | 13.0 ± 3.8 |
| pPWC4-C_{Sac}-C492A | 17.7 ± 5.4 | 1.8 ± 0.1 |

^{a}The plasmid carrying the unaltered clone, serving as a positive control.
^{b}The vector alone, serving as a negative control.
^{c}Normalized to 100% for pPWC4-C_{Sac}, the positive control.

### EXAMPLE 10

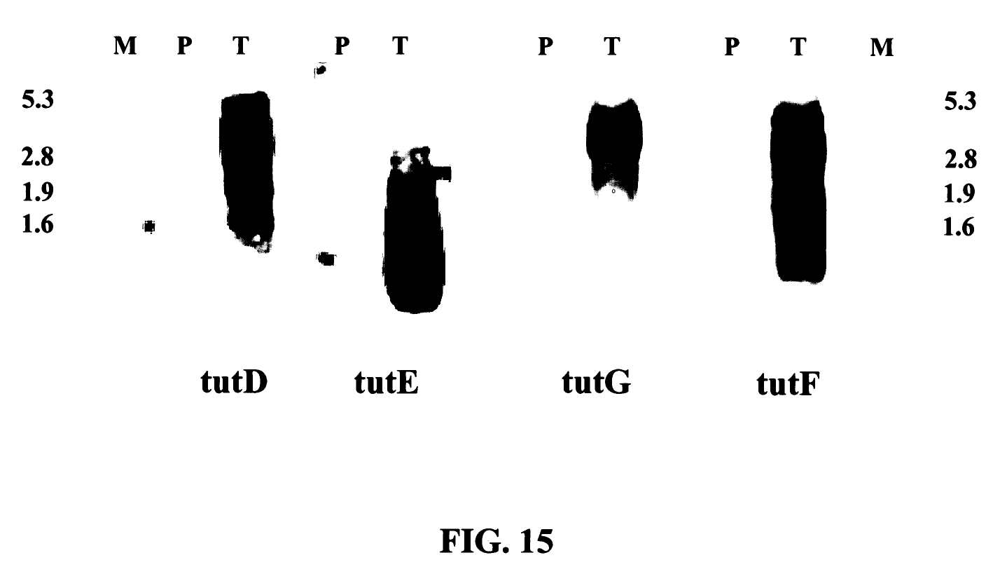

In this example, Northern analysis was used to examine the regulation of the toluene utilization genes of T. aromatica T1. Intense bands were detected when tutD, tutE, tutG and tutF gene probes were hybridized to RNA isolated from toluene grown cells (lanes marked T in FIG. 15). In contrast, no bands were detected by any of the tut gene probes using RNA isolated from pyruvate grown cells (lanes marked P in FIG. 15). These results indicate that the tut genes are induced by toluene.

It can also be seen from FIG. 15 that the banding pattern observed with the tutE probe is distinct from the patterns observed with the tutD, tutG, and tutF probes. Multiple sizes of mRNA transcripts are observed using the tutE probe, with the predominant transcripts being approximately 1.6 kb and smaller. Multiple sizes of mRNA transcripts are also observed with the other three probes, but the predominant transcripts are approximately 5.0 to 2.8 kb in size. While it is not intended that the present invention be limited by any specific mechanism or the genes and gene products claimed herein be limited by any motif of the transcriptional units, the banding patterns suggest that tutF, tutD, and tutG are part of the same transcriptional unit and that tutE is a separate transcriptional unit.

### EXAMPLE 11

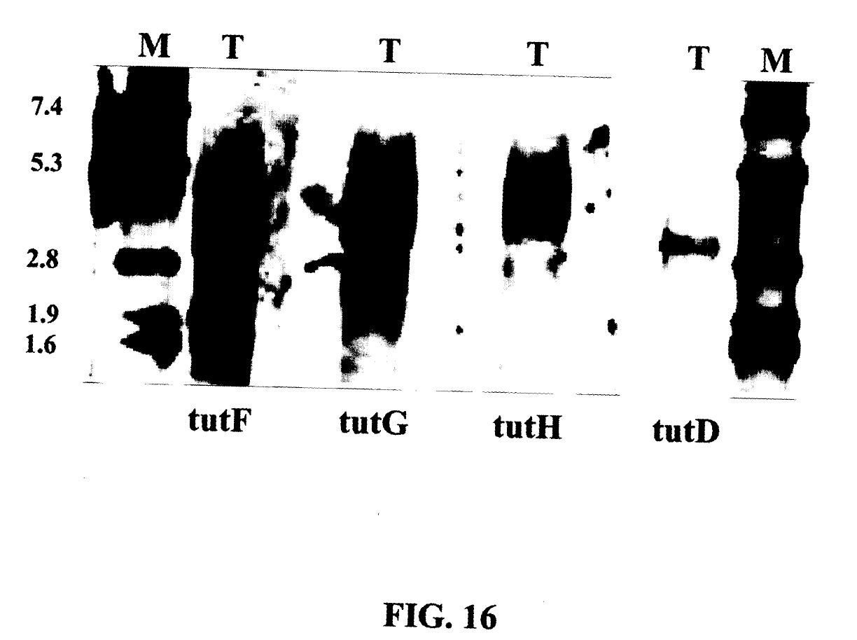

In this example, an additional open reading frame was identified and designated tutH. FIG. 16 includes the results of a Northern analysis in which tutH was used as the probe to identify transcripts from toluene grown cells. While it is not intended that genes claimed through the present invention be limited by a particular level of expression, a similar range of RNA transcript sizes that was observed with the tutF, tutD, and tutG probes was also seen with the tutH probe (FIG. 16). In addition, the tutH probe did not identify any transcripts in RNA isolated from pyruvate grown cells, indicating that it is also induced by toluene (data not shown).

### Example 12

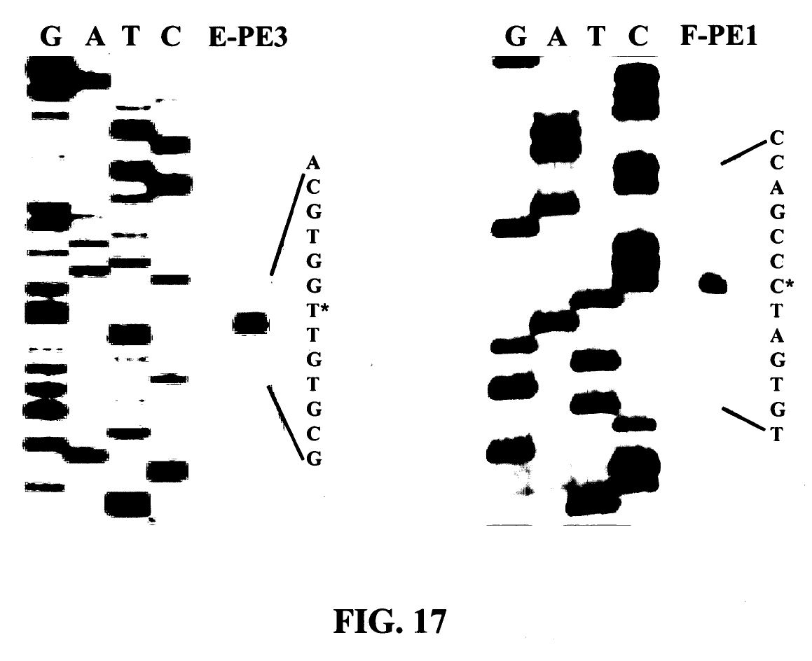

This example presents data on primer extension and nuclease protection analysis to identify the start sites(s) present in genes described in the instant application. FIG. 17 shows the results of a primer extension reaction using the E-PE3 primer which contains the predicted tutE translational start. The major transcriptional start site is located 177 bp upstream of the tutE translational start. This same start site was also observed when a nuclease protection assay was carried out with a DNA probe spanning the tutE translational start (data not shown). Minor start sites were also observed 178 bp upstream (FIG. 17) and in the region 1119-124 bp upstream of the tutE translational start (data not shown).

As can also be seen in FIG. 17, results of a primer extension reaction using the F-PE1 primer (located just downstream of the predicted tutF translational start site) identifies a major transcriptional start site 76 bp upstream of the tutF translational start. This site is located within the tutE coding region. This start site was also observed when a nuclease protection assay was carried out with a DNA probe spanning this region of the tutF translational start (data not shown). Minor transcriptional start sites were observed 75 and 77 bp upstream (FIG. 17) and in the region 125-129 bp upstream of the tutF translational start site (data not shown). These results are consistent with the results of the Northern analysis indicating that the tutE transcript is separate from the tutFDGH transcript.

A primer extension reaction carried out with a primer located downstream of the predicted tutD translational start and a nuclease protection assay carried out with a DNA probe spanning the tutD translational start did not identify a transcriptional start immediately upstream of tutD. Instead, these reactions did identify the same start site located upstream of tutF (data not shown). Primer extension reactions carried out with primers located downstream of the predicted tutG and tutH translational starts and nuclease protection assays carried out with DNA probes spanning these translational start sites failed to identify transcriptional start sites immediately upstream of these genes (data not shown). The start site identified preceding tutF could not be verified for tutG and tutH due to its considerable distance from these genes (about 2.9 kb and 3.2 kb respectively). While it is not intended that the present invention be limited by any mechanism or transcriptional motif, the RNA analyses suggest that the tutF, tutD, tutG, and tutH genes are transcribed as a single unit from one start site.

### EXAMPLE 13

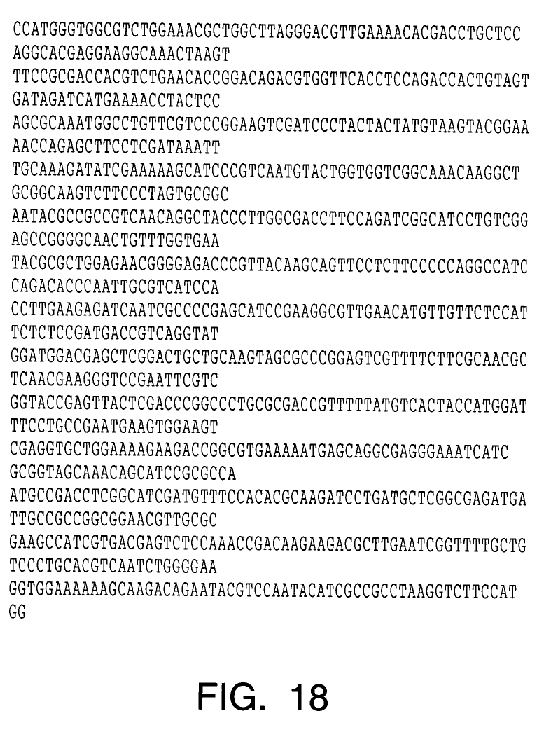

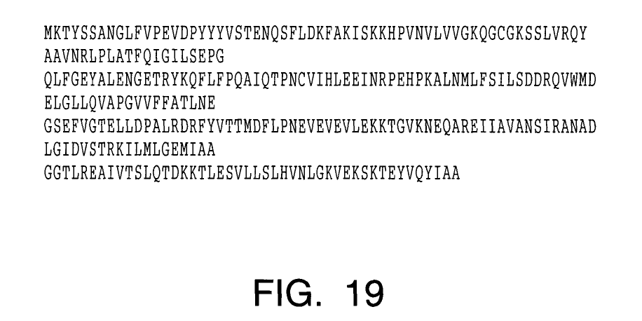

This example presents DNA and protein analysis of tutH. Specifically, given that the 4905 bp SacII/EcoRI fragment of cosmid 13-6-4 (GenBank accession number AF036765) did not contain the complete sequence of the tutH gene, an additional 381 base pair of this cosmid were sequenced on both strands. The 1018 bp NcoI fragment (part of which is contained in the SacII/EcoRI fragment previously reported) containing the tutH sequence has been deposited in GenBank (accession number AF113168). Analysis of this sequence identified the complete tutH coding region whose predicted protein product is 286 amino acids. The nucleic acid sequence corresponding to tutH is presented in FIG. 18. The TutH protein has a calculated molecular mass of about 31,800 Da and a predicted pI of 5.4. The amino acid sequence corresponding to TutH is presented in FIG. 19.

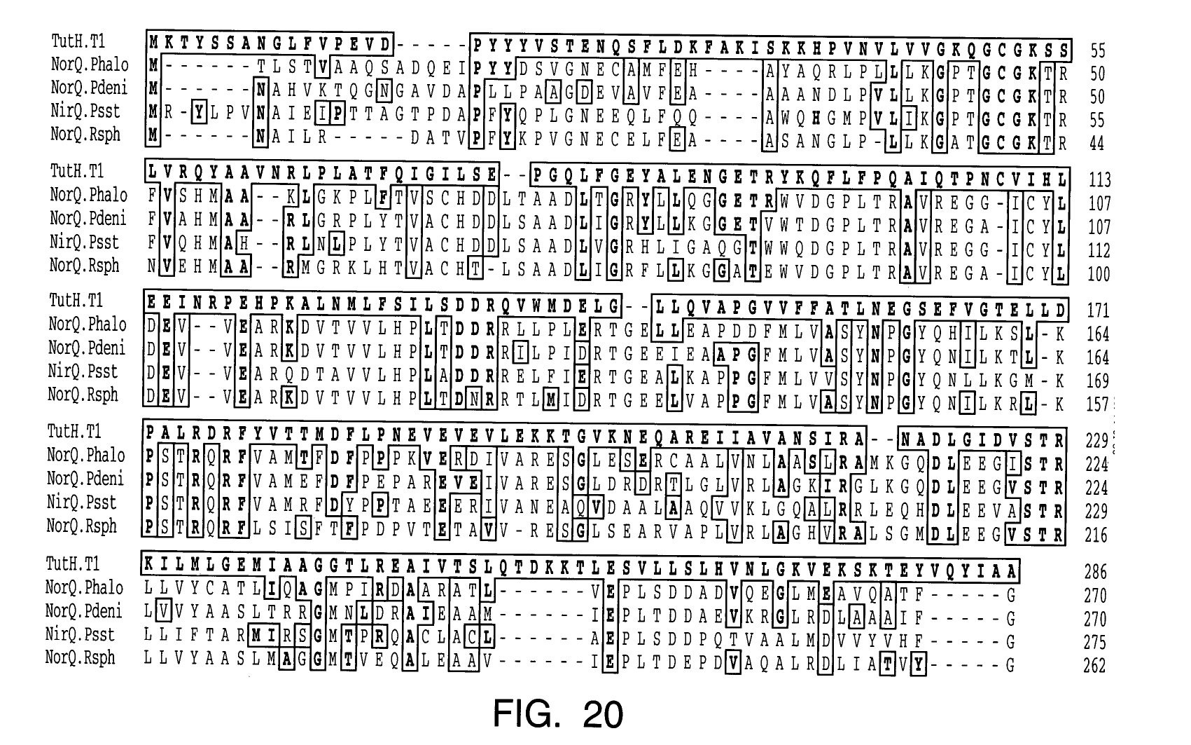

The BLAST program was used to identify proteins similar to the predicted TutH protein. The four proteins with the highest degree of similarity were N or Q from Paracoccus halodenitrificans, Paracoccus denitrificans, and Rhodobacter sphaeroides, and NirQ from Pseudomonas stutzeri. The BLAST program calculated that these proteins are 27%, 28%, 27%, and 22% identical (over nearly their entire sequence) to TutH, respectively. A protein alignment of these proteins is presented in FIG. 20.

The TutH protein sequence was also subjected to a Motif analysis. Amino acids 47 to 54 (labeled with a line in FIG. 20) were identified as a putative ATP/GTP binding domain. This region is conserved in the N or Q/NirQ proteins included in FIG. 20. While it is not intended that the present invention be limited by any specific operative mechanism, this observation suggests that the N or Q/NirQ family of proteins and the TutH protein may use a similar mechanism involving ATP/GTP binding.

### EXAMPLE 14

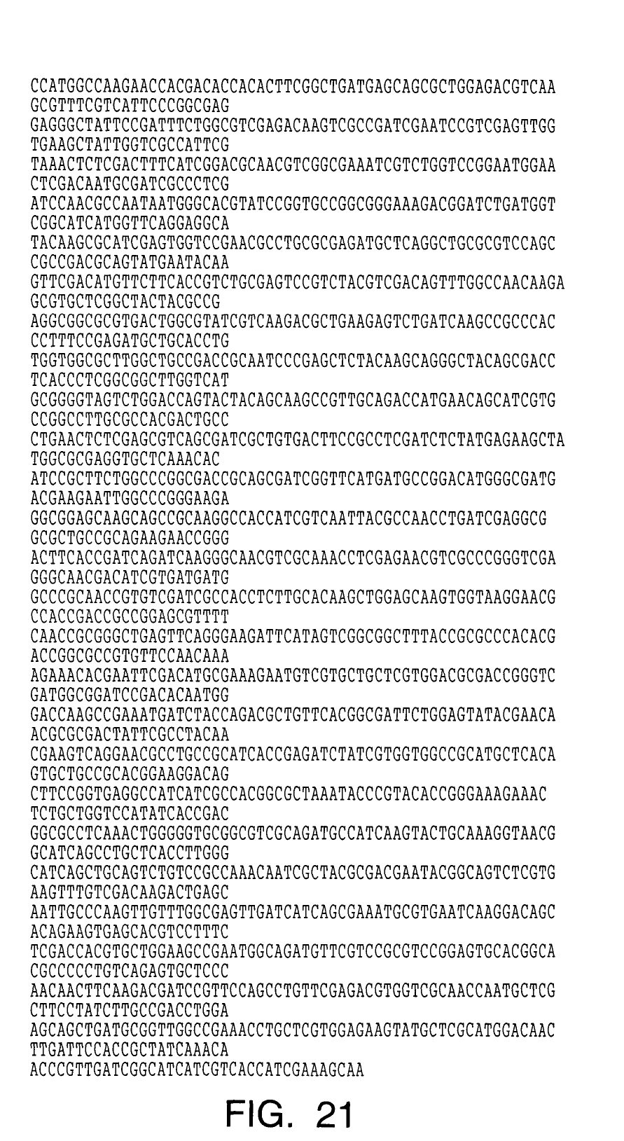

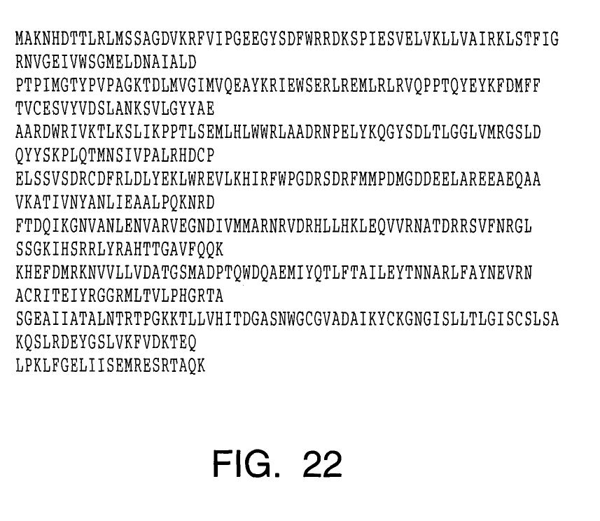

This example presents DNA and protein analysis of tutI. The DNA sequence, presented in FIG. 21, starts with an Nco site near the end of the tutH sequence. The protein sequence, presented in FIG. 22, is the translation of the open reading frame. Additionally, Northern blot data has demonstrated tutI is regulated in response to toluene (data not shown).

### EXAMPLE 15

This example describes the generation of chromosomal mutations. In order to characterize the roles of the individual tut genes, in particular the three encoding the subunits for benzylsuccinate synthase, the enzyme involved in the first step of toluene degradation, a plan was undertaken to delete fragments of single genes from the T. aromatica T1 chromosome (see, FIG. 23 for the location of the deletions). Briefly, deletions were constructed concomitant with the addition of a restriction site in pBluescript (Stratagene), an ampicillin resistant vector not stable in T. aromatica T1. A kanamycin resistant gene was then inserted into the engineered restriction site (in the opposite reading frame of the deleted gene). The resulting plasmid was purified and electroporated into wild-type T. aromatica T1 and the cells were grown with kanamycin selection. Since the kan gene must integrate into the chromosome in order to be stable in T. aromatica T1, the resulting Km^{R} colonies were screened for sensitivity to ampicillin. The colonies in which a gene replacement of the chromosomal tut gene occurred (Km^{R}, Ap^{S}) were thus distinguished from those where the entire plasmid was integrated into the chromosome (Km^{R}, Ap^{R}). The kanamycin-resistant, ampicillin-sensitive colonies were further analyzed by PCR and chromosomal sequencing to confirm that the strain carried the desired deletion.

The strains that carried the desired deletions were assayed for growth on toluene and the ability to metabolize toluene. In each case, insertion of the kan gene within the deletion of the tut gene resulted in a Tut⁻ phenotype:no growth on toluene, no metabolism of toluene and no production of metabolic intermediates derived from toluene. These insertion/deletion constructs should not only disrupt the target gene but are expected to have a polar effect on the transcription and translation of downstream genes. It was predicted that a disruption of tutF, tutD or tutG would result in a Tut⁻ phenotype since their gene products are all part of the benzylsuccinate synthase enzyme complex. However the TutF and TutG proteins are very small (about 6.9 kDa and 9.3 kDa, respectively) and might play an accessory role in the function of the enzyme. Hence, it remained to be determined if the Tut⁻ phenotype was due to the disruption of the individual gene or to the impact of the disruption on a downstream gene.

### EXAMPLE 16

This example describes the complementation with plasmids carrying in-frame deletions. To confirm that the phenotype of the strains carrying the chromosomal mutations was due to the disrupted gene and not due to polar effects on downstream genes, a series of plasmids was constructed in which a single tut gene (tutF, tutD or tutG) had an in-frame deletion. In-frame deletions should affect expression only of the gene of interest and not downstream genes. These plasmids were conjugally mobilized into strains with chromosomal deletions in the tut genes and assayed for their ability to promote growth on toluene, metabolism of toluene, and for production of the metabolic intermediate phenylitaconic acid. As can be seen in Table 5, there was no complementation when any of the strains with chromosomal deletions (designated Δname::kan) carried a plasmid with an in-frame deletion in the corresponding tut gene (derivatives of pPWC-314). Although the chromosomal mutations were expected to be polar, the plasmid mutations were not. To confirm that the downstream genes on the plasmids carrying the in-frame deletions were capable of being transcribed and translated, complementation studies were also undertaken with various combinations of chromosomal deletion strains and plasmids carrying deletions in tut genes. Table 5 shows that when a plasmid with a deletion in tutF is mated into a strain carrying a deletion in tutD, complementation occurs. Similarly, when a plasmid with a deletion in tutF or tutD is mated into a strain carrying a deletion in tutG, complementation is also observed. These results indicate that the in-frame deletion plasmids are capable of producing functional downstream proteins. Thus, the phenotypes observed support the conclusion that tutF, tutD and tutG are all required for toluene metabolism in T. aromatica T1, as would be expected for proteins that are part of an enzyme complex. These results disprove the hypothesis that the small tutF and tutG gene products serve to enhance activity but are not required for enzyme function. Strains carrying deletions of these genes plus the corresponding deleted plasmids might retain some activity if TutF and TutG served only to enhance activity. This activity might not be at the same level of the strains carrying the wild-typ plasmid, but if these gene products were required for full activity (perhaps in helping the complex function in some manner) a partial activity

TABLE 5
Complementation of tut-deleted T. aromatica
by plasmids carrying in-frame deletions of various tut genes

| | Chromosomal deletion | | |
|---|---|---|---|
| Plasmid carried | ΔtutF::kan | ΔtutD::kan | ΔtutG::kan |
| pPWC-314^{a} | +^{c} | + | + |
| pRK-415^{b} | −^{d} | − | − |
| pPWC-314-ΔtutF | − | + | + |
| pPWC-314-ΔtutD | − | − | + |
| pPWC-314-ΔtutG | ND^{e} | − | − |

^{a}The wild-type plasmid carrying the tutE tutFDGH gene cluster, serving as a positive control.
^{b}The vector alone, serving as a negative control.
^{c}+ = Able to grow with toluene as the sole carbon source, able to metabolize toluene, and able to produce phenylitaconic acid.
^{d}− = Unable to grow with toluene as the sole carbon source, unable to metabolize toluene, and unable to produce phenylitaconic acid.
^{e}ND = not determined.

might be seen. The observation that these strains had a Tut⁻ phenotype (equivalent to the control strain carrying the vector alone) indicate that each of the tutF, tutD and tutG gene products are essential for benzylsuccinate synthase activity.

### EXAMPLE 17

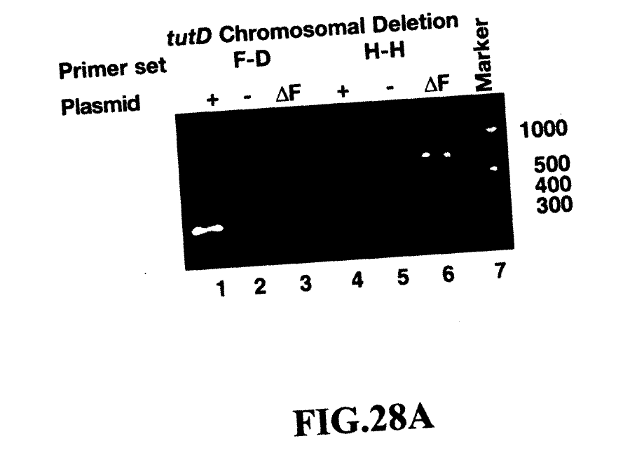

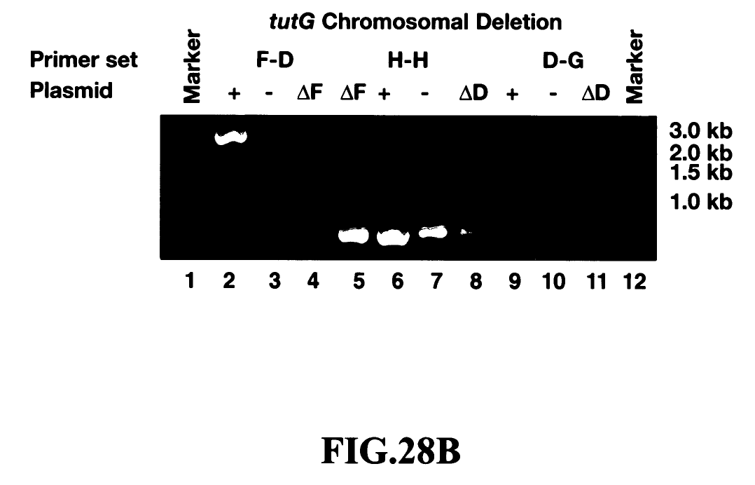

This example describes the use of PCR to confirm complementation as opposed to recombination. It remained a formal possibility that the Tut⁺ phenotype observed when the chromosomally deleted tutD strain carried the in-frame deleted tutF plasmid and the chromosomally deleted tutG strain carried either the in-frame deleted tutF or tutD plasmid was not due to complementation but was due to recombination or some other event that replaced one of the deleted copies of the gene with a wild-type copy. To eliminate this concern, PCR was performed on these strains with primers that would anneal in the different deleted regions. Amplification should only occur and a product should only be produced if recombination or some other event had occurred, placing the two wild-type copies of the genes in cis on the same DNA fragment. The results of this experiment show that a PCR product was observed only when the strains carried a wild-type plasmid (FIG. 28). Details of FIG. 28 are as follows: Confirmation of complementation by PCR. Panel A: PCR was carried out on tutD deletion strains carrying plasmid pPWC-314 (+), pRK415 Pac (−) or pPWC-314-Δ tutF (ΔF). Primers within the tutF (BF2) and tutD (BP2) deletions (giving rise to a 306-bp product) or the tutH (NC1 and TL1) gene (giving rise to a 653-bp product; as a control) were used for amplification. Panel B: PCR was carried out on tutG deletion strains carrying plasmid pPWC-314 (+), pRK415 Pac (−), pPWC-314-Δ tutF (ΔF) or pPWC-314-Δ tutD (ΔD). Primers within the tutG (GPE1) and tutF (BF2) deletions (giving rise to a 2882-bp product), tutG (GPE1) and tutD (BF1) deletions (giving rise to a 2659-bp product), or the tutH (NC1 and TL1) gene (giving rise to a 653-bp product; as a control) were used for amplification. Any apparent differences in size are due to differences in the amount of DNA loaded because of variability of amplification. Control reactions using primers located in the tutH gene were able to amplify the expected fragments. These results indicate that the observe Tut⁺ phenotype was most likely due to complementation of the chromosomal mutations by the in-frame deletion plasmids and very unlikely that recombination or another event occurred.

### EXAMPLE 18

This example describes the degradation of toluene to benzylsuccinate by the addition of the TutF, TutD, TutG and TutE proteins. Although the present invention is not limited to any particular mechanism or embodiment, it is believed that the TutF, TutD, TutG and TutE proteins are necessary and sufficient to degrade toluene to benzylsuccinate. For example, in a reaction vessel containing a solution comprising toluene, a mixture of the TutF, TutD, TutG and TutE proteins is added. Following the reaction parameters given above, a decreased amount of toluene is measured and increased amount of benzylsuccinate is measured. In one example, a trace amount of benzylsuccinate is added to the reaction mixture to activate the Tut protein complex. Although the present invention is not limited to any particular mechanism, it is believed that benzylsuccinate acts as a positive feedback mechanism on the tut gene encoding region. In embodiments wherein microorganisms transformed with tut gene encoding regions, benzylsuccinate may be added to the reaction mixture. It is also believed that TutE activates a complex comprising TutD, TutF and TutG. The present invention is not limited to any particular reaction parameters. In one embodiment, the reaction takes place at room temperature or ambient temperature. In another embodiment, the present invention takes place in a reaction vessel (e.g., a bioreactor, a holding pit, a storage tank or the like). In a preferred embodiment, the reaction takes place in a bioreactor. The present invention is not limited to any particular length of time for the reaction to take place. Any time from instantaneous (e.g., less than one second) to several weeks is contemplated. The present invention is not limited to a particular degree of completion of the reaction. In one embodiment, the reaction is from 10% to 100% completed. In a preferred embodiment, the reaction is from 50% to 99% completed.

From the foregoing it is evident that the present invention teaches novel compositions and methods for the degradation of toluene.

1. A method of degrading compounds contained in a liquid or solid waste source, comprising the steps of:
a) providing i) a waste source comprising toluene, ii) a reaction containing means, and iii) a mixture consisting essentially of the TutD, TutF, TutG and TutE proteins, and;
b) reacting said compound and said waste source in said containing means under conditions such that toluene is degraded.

2. The method of claim 1, wherein said TutD, TutF, TutG and TutE proteins are derived from an organism selected from the group consisting of Thauera aromatica, Xanthomonas maltophilia, Geobacter metallireducens, and Azoarcus tolulyticus.

3. The method of claim 1, wherein said Tut proteins have the amino acid sequences TutD (SEQ ID NO: 23), TutF (SEQ ID NO: 48), TutG (SEQ ID NO: 50) and TutE (SEQ ID NO: 33), respectively.

4. The method of claim 1, wherein said reaction containing means is a bioreactor.

5. The method of claim 1, wherein said Tut proteins are encoded in nucleic acid and said nucleic acid is transformed into microorganisms.

6. The method of claim 5, wherein benzylsuccinate is added to the reaction vessel.

7. A composition comprising the isolated TutD (SEQ ID NO: 23), TutF (SEQ ID NO: 48), TutG (SEQ ID NO: 50) and TutE (SEQ ID NO: 33) proteins.

8. An expression construct comprising nucleic acids encoding the TutD, TutF, TutG and TutE proteins.

9. The expression construct of claim 8, wherein said nucleic acids are TutD (SEQ ID NO: 21), TutF (SEQ ID NO: 47), TutG (SEQ ID NO: 49) and TutE (SEQ ID NO: 22).
